(19) United States
(12) Patent Application Publication
(10) Pub. No.: US 2004/0239668 A1
(43) Pub. Date: Dec. 2, 2004

(54) Display device and method for driving display device

(75) Inventors: Katsuhiko Morosawa, Tachikawa-shi (JP); Hiromitsu Ishii, Mitaka-shi (JP); Tomoyuki Shirasaki, Higashiyamato-shi (JP); Shinobu Sumi, Tama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/855,584

(22) Filed: May 26, 2004

(30) Foreign Application Priority Data
May 26, 2003 (JP) 2003-147397
Jun. 3, 2003 (JP) 2003-158238
Jun. 3, 2003 (JP) 2003-158394
Jun. 4, 2003 (JP) 2003-159331
Jun. 9, 2003 (JP) 2003-163411
Jun. 30, 2003 (JP) 2003-186260

(51) Int. Cl. G09G 5/00

(52) U.S. Cl. 345/212

(57) ABSTRACT

A display device for displaying images corresponding to digital signals information comprising a display panel with a plurality of display pixels arranged in matrix form near the intersecting points of a plurality of scanning lines and a plurality of signal lines which intersect perpendicularly with each other; a scanning driver circuit for sequentially applying scanning signals; a signal driver circuit comprising a plurality of gradation current generation supply circuit sections comprising a module current generation circuit which generates a plurality of module currents corresponding to each digital signal bit based on reference voltage; a gradation current generation circuit which integrates selectively each of the module currents, generates gradation currents and supplies each of a plurality of the signal lines; a reference voltage generation circuit which applies in common the reference voltage to a plurality of the gradation current generation circuits sections.

### CROSS-REFERENCE TO RELATED APPLICATIONS

This application is based upon and claims the benefit of priority from the prior Japanese Patent Application No. 2003-147397, filed May 26, 2003; 2003-158238, filed Jun. 3, 2003; 2003-158394, filed Jun. 3, 2003; 2003-159331, filed Jun. 4, 2003; 2003-163411, filed Jun. 9, 2003; and 2003-186260, filed Jun. 30, 2003, the entire contents of which is incorporated herein by reference.

### BACKGROUND OF THE INVENTION

1. Field of the Invention

The invention relates to the drive method of a driver circuit comprising a current generation supply circuit applicable to a display device for displaying desired image information on a display panel comprised with display pixels having current control type light emitting devices, and more particularly comprises a current generation supply circuit with the display device equipped with the current generation supply circuit and associated current generation supply circuits and method for driving the display device.

2. Description of the Related Art

In recent years, the increase of flat panel type display devices as monitors and displays of personal computers and video equipment has been amazing. Particularly, Liquid Crystal Displays (hereinafter denoted as “LCD”) have advanced rapidly as these devices are thin-shaped, space-saving, low-powered and the like as compared to conventional display devices. In addition, relatively small LCD's remarkably have also recently spread and are widely applied as display devices in such as cellular/mobile phones, digital cameras, Personal Digital Assistants (PDA's) and the like.

Furthermore, as the display device (display) of the next generation following such an LCD, Research and Development (R&D) of the self-luminescence type display device comprised of a display panel with optical elements arranged in a matrix form consisting of self-luminescence type light emitting devices, such as organic electroluminescent devices (hereinafter denoted as “organic EL devices”), inorganic electroluminescent devices (hereinafter denoted as “inorganic EL devices”) or Light Emitting Diodes (LEDs) and the like is being actively pursued. In comparison with former LCD's, such a self-luminescence type display has a more rapid display response speed and does not have a limited viewing angle. Additionally, as high luminosity increases contrast, higher resolution display image quality using low-power and the like are realistic. Because backlight is not needed like an LCD, this very predominant feature will lead to more thin-shaped and lightweight models and full-scale utilization of such self-luminescence type displays are expected in the near future.

A self-light generation type display device according to such an active matrix drive method, in summary, the display panel comprises a plurality of display pixels arranged in matrix form containing light emitting devices placed near the intersecting points of a plurality of data lines (signal lines) positioned in columns and a plurality of scanning lines (scan lines) positioned in rows (line writing direction); a data driver for generating gradation currents corresponding to the display data (display signals) and supplying each of the display pixels via each data line; and a scanning driver for sequentially applying the scanning signals to each scanning line at predetermined timing and sequentially setting the display pixels of each line in a selection state. The light emitting devices of the display pixels perform a light generation operation by luminosity gradation corresponding to the display data and the desired image information is displayed on the display panel by the gradation currents supplied to each display pixel. Furthermore, an example of the self-light generation type display device will be explained in detail in the embodiments of the present invention described later.

As the drive method in such a self-light generation type display device, the data driver generates the gradation currents (drive currents) having current values corresponding to the display data to a plurality of display pixels (light emitting devices) and the display pixels of the specified lines are supplied by the scanning driver contrasted with the display pixels of the current specification type drive method which successively repeats an operation to make the light emitting devices of each display pixel emit light by predetermined luminosity gradation of each line for one screen and the specified lines are selected by the scanning driver. The Pulse Width Modulation (PWM) type drive method and the like which successively repeats an operation for supplying drive currents of constant current value by individual time width (signal width) corresponding to the display data from the data driver and makes each of the light emitting elements emit light by predetermined luminosity gradation of each line for one screen is recognized.

However, in the self-light generation type display device mentioned above has a drawback as described below.

More specifically, the data driver generates the drive currents corresponding to the display data for every display pixel and the above-mentioned drive currents change relative to the display data in the current specification type drive method to each of the display pixels via each of the data lines of the display panel. Therefore, in the data driver, for example, when comprised of the scheme in which the currents that are once held by the transistors, the latch circuits, and the like are the currents supplied as the current from the predetermined source individually set by the data driver corresponding to each of the data lines and supplied to each of the data lines as drive currents, the currents supplied from that current source will change relative to the display data. Here, when the current supplied to each circuit configuration of the data driver is supplied via the signal wiring for the predetermined current supply within the data driver, since a capacitor component (wiring capacitor) resides in the signal wiring, generally the operation in which changes the current flow for use in the current supply is equivalent to the charge or discharging of the predetermined electric potential in the parasitic capacitor which resides in the signal wiring. Therefore, the charge and discharge operation of the signal wiring requires a certain amount of time. When the currents supplied via the signal wiring are reduced, in particular, this charge and discharge operation requires a relative longer period.

Conversely, in the operation in the data driver, while the number of display pixels increases in proportion to higher definition (higher resolution) of these display panels and the drive time for each of the scanning lines decreases to the extent that the number of data lines and scanning lines increases, the operational period allocated to the current holding operation corresponding to each of the data lines becomes briefer and a faster operation is needed.

However, as mentioned above, the data lines as well as the charge and discharge operation of the signal wiring requires a certain amount of time and, in particular, to the extent that the current values of the drive currents become more reduced in connection with miniaturization, high-resolution, and the like of the display panel. As a consequence, the period in which the charge and discharge operation of the signal wiring increases and creates a disadvantage in rate controlling the operational speed of the data driver that is executed.

### SUMMARY OF THE INVENTION

The present invention comprises a current generation supply circuit for supplying drive currents corresponding to digital signals to a plurality of loads and comprises a driver circuit having this current generation supply circuit set to a display device for displaying image information corresponding to display signals on a display panel having display pixels comprising current control type light emitting devices. While being able to generate the drive currents having uniform current values and being able to supply a plurality of loads, even in the case of reduced drive currents at the time of low gradation, the operating speed related to the generation of the drive currents can be raised, the appropriate drive currents for the loads can be supplied and has the advantage that favorable display properties can be acquired.

The current generation supply circuit in the present invention for acquiring the above-mentioned advantage comprises at least a plurality of current generation circuit sections comprising at least a module current generation circuit which generates a plurality of module currents corresponding to each digital signal bit and corresponding to each of a plurality of loads based on predetermined reference voltage; and a drive current generation circuit which selectively integrates each of the module currents, generates drive currents and supplies a plurality of loads corresponding to the digital signal bit value; and a reference voltage generation circuit which applies in common the predetermined reference voltage to a plurality of current generation circuit sections.

Here, a plurality of the current generation circuit sections set the signal polarity of the drive currents so that the drive currents flow in the direction drawn from the load side or so that the drive currents flow in the direction flowed into the load side.

Additionally, each of a plurality of the module currents has a different current value ratio with each other defined by 2ⁿ. A signal holding circuit having a plurality of latch circuits which individually hold each digital signal bit. The drive current generation circuit comprises selection switching circuits which select a plurality of module currents generated by the module current generation circuits and the drive currents are generated.

The latch circuits in the signal holding circuit, for example, comprise a single input control circuit which takes in the digital signals; a charge storage circuit which stores the electrical charge based on the signal levels of the digital signals; an output level setting circuit which sets the signal levels of the output signals outputted from the latch circuits based on the amount of electrical charge stored in the charge storage circuit.

A plurality of the current generation circuit sections are set to correspond to each of a plurality of the loads and generates in parallel the drive currents relative to a plurality of loads or set corresponding to every load for some predetermined number of a plurality of the loads and the drive currents corresponding to the predetermined number of loads are sequentially generated. In the latter configuration, the drive current generation supply circuit, further comprises a plurality of current latch circuits in which the drive currents generated by the current generation circuits corresponding to each of a plurality of the loads are sequentially taken in and held in parallel, and the held drive currents are simultaneously output to a plurality of loads; an input side switching circuit which sequentially selects a plurality of the latch circuits in the signal holding circuit and supplies the digital signals held in the latch circuits to each of a plurality of the current generation circuits; an output side switching circuit which sequentially selects a plurality of the current latch circuits and sequentially supplies to the current latch circuits the selected drive currents generated by a plurality of current generation circuits; and an operation for selecting a plurality of the latch circuits of the signal holding circuit in the input side switching circuit and an operation for selecting a plurality of the current latch circuits in the output side switching circuit are synchronously performed.

The reference voltage generation circuit, for example, comprises a reference current transistor which outputs the voltage generated for the control terminals having constant current value and outputs the voltage generated for the control terminals when the reference current flows; and a charge storage circuit which stores electrical charges corresponding to the current component of the reference current. The charge storage circuit comprises a refresh circuit in which the electrical charges corresponding to the current component of the reference current is stored at predetermined timing. Alternatively, the reference voltage generation circuit is constituted comprising a constant voltage source which regularly outputs voltage having constant voltage value as the reference voltage.

The module current generation circuit comprises a plurality of module current transistors in which the transistor size of each other differs and the channel width of each other of the module current transistors is set at a different ratio defined by 2ⁿ and the reference current transistor and a plurality of the module current transistors constitute a current mirror circuit. Additionally, the reference current transistor and a plurality of the module current transistors, at least, configuration has a body terminal structure; a configuration which connects a plurality of Field-Effect Transistors in series or a plurality of standard transistors having standard transistor sizes with a plurality connected in parallel; a configuration arranged in a position which become symmetrical with each other in a one-dimensional or two-dimensional direction of centered on a predetermined reference position having the formation of either; a configuration in which a plurality of the module current transistors constitute a plurality of standard transistors and the sum total of the channel width of the standard transistors connected in parallel is set at a different ratio with each other defined by 2ⁿ.

The current generation supply circuit in the present invention further comprises a constant current generation source which generates the reference current. For example, the current generation circuit and the constant current generation source are built on the same substrate and the constant current generation source comprises a means for randomly adjusting the setting for the current value of the reference current corresponding to control voltage.

The display device in the present invention for acquiring the above-mentioned advantage comprises a display panel comprising a plurality of scanning lines and a plurality of signal lines which intersect at perpendicularly with each other, and a plurality of display pixels arranged in matrix form near the intersecting points of the scanning lines and the signal lines;

a scanning driver circuit which applies sequentially scanning signals for setting the selective state of each line of a plurality of the scanning lines; a signal driver circuit comprising a plurality of gradation current generation supply circuit sections comprising at least a module current generation circuit which generates a plurality of module currents corresponding to each digital signal bit of the display signals based on predetermined reference voltage, and a gradation current generation circuit which integrates selectively each of the module currents, generates gradation currents, and supplies each of a plurality of the signal lines corresponding to the digital signal bit value of the display signals; and a reference voltage generation circuit which applies in common the predetermined reference voltage to a plurality of gradation current generation circuits sections.

A plurality of the gradation current generation supply circuit sections set the signal polarity of the gradation currents so that the gradation currents flow in the direction drawn from the display pixel side via the signal lines and so that the gradation currents flow in the direction flowed into the display pixel side via the signal lines.

Furthermore, a plurality of module currents each has a different ratio with each other defined by 2ⁿ. Each of a plurality of gradation current generation circuit sections comprise a signal holding circuit having a plurality of latch circuits which individually hold each digital signal bit of the display signals. The gradation current generation circuit in each of a plurality of gradation current generation circuit sections comprises a selection switching circuit which selects a plurality of module currents generated by the module current generation circuit and generates the gradation currents.

The latch circuits in the signal holding circuit comprise a signal input control circuit which takes in the digital signals of the display signals; a charge storage circuit which stores electrical charges based on the signal levels of the digital signals of the display signals; and an output level setting circuit which sets the signal levels outputted from the latch circuits stored in the charge storage circuit.

A plurality of gradation current generation supply circuit sections are set corresponding to each of a plurality of the signal lines and generate simultaneously in parallel the gradation currents for a plurality of signal lines or set to correspond to every signal line; and the gradation current generation supply circuit sections are constituted so that the gradation current circuit sections sequentially generate the gradation currents corresponding to the number of signal lines.

In the previous configuration, further, a pair of two gradation current generation supply circuit sections are arranged in parallel set to correspond to each of a plurality of signal lines in which each other comprises at least a module current generation circuit, a gradation current generation circuit and a signal holding circuit; and the reference voltage generation circuit applies in common the reference voltage to each pair of the gradation current generation supply circuit sections, as well as an operation for supplying a plurality of signal lines with gradation currents based on the digital signals of the display signals held in the signal holding circuits in one of a pair of the gradation current generation supply circuit sections; and an operation for holding the successive digital signals of the display signals in the signal holding circuit in the current generation circuit of the current generation supply circuit sections of the other side.

In the latter configuration, the signal driver circuit further comprises a plurality of the current latch circuits which take in sequentially and hold in parallel the gradation currents generated by the gradation current generation supply circuit sections set to corresponding to each of a plurality of signals and output the held gradation currents simultaneously to a plurality of signal lines; an input side switching circuit which selects sequentially a plurality of the latch circuits in the signal holding circuit and supplies the digital signals of the display signals held in the latch circuits to each of a plurality of gradation current generation supply circuit sections; and an output side switching circuit which selects sequentially a plurality of current latch circuits and supplies sequentially to the current latch circuits the selected gradation currents generated by a plurality of the gradation current generation circuits; as well as an operation for selecting a plurality of the latch circuits of the signal holding circuit in the input side switching circuit and an operation for selecting a plurality of the current latch circuits in the output side switching circuit are performed synchronously.

The reference voltage generation circuit comprises, for example, comprises a means for generating the reference voltage based on the reference current having constant current value and comprises a reference current transistor which outputs the voltage generated for the control terminals as the reference voltage when the reference current having constant current value flows; a charge storage circuit which stores electrical charges corresponding to the current component of the reference current; and further comprises a refresh circuit which accumulates the electrical charges corresponding to the current component of the reference current in the charge storage circuit at predetermined timing intervals. Alternatively, the reference voltage generation circuit is constituted comprising a constant voltage source which outputs regularly voltage having constant voltage value as the reference voltage.

The module current generation circuit comprises a plurality of module current transistors in which the transistor size of each differs and each control terminal is connected in common to the reference current transistor control terminal of the reference voltage generation circuit; the channel width is set at a different ratio with each other defined by 2ⁿ (n=0, 1, 2 and 3, . . . ); and the reference current transistor and a plurality of module current transistors constitute a current mirror circuit. Furthermore, at least some of the reference current transistor and the module current transistors has a body terminal structure and constituted with a plurality of Field-Effect Transistors connected in series; a configuration which connects a plurality of Field-Effect Transistors in series or a plurality of standard transistors having standard transistor sizes with a plurality connected in parallel; a configuration arranged in a position which become symmetrical with each other in a one-dimensional or two-dimensional direction of centered on a predetermined reference position having the formation of either; a configuration in which a plurality of the module current transistors constitute a plurality of standard transistors and the sum total of the channel width of the standard transistors connected in parallel is set at a different ratio with each other defined by 2ⁿ.

Additionally, the signal driver circuit comprises a constant current generation source with generates the reference current. For example, the current generation circuit and the constant current generation source are built on the same substrate and the constant current generation source comprises a means for performing random alteration settings of the current value of the reference current corresponding to the control voltage.

Finally, each of a plurality of display pixels comprise current control type light emitting devices which perform a light generation operation by predetermined luminosity gradation corresponding to the current value of the gradation currents supplied from the current generation circuit; and a light generation driver circuit which generates light generation drive currents based on the current write-in holding circuit which holds these gradation currents and the held gradation currents are supplied to the light emitting devices; and the light emitting devices, for example, are organic electroluminescent devices.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIGS. 1A and 1B are outline configuration diagrams showing the first embodiment of the current generation supply circuit related to this embodiment;

FIG. 2 is a circuit configuration diagram showing the first embodiment of reference voltage generation circuit and the current generation circuits applicable to the current generation supply circuit related to this embodiment;

FIGS. 3A and 3B are outline configuration diagrams showing the second embodiment of the current generation supply circuit related to this embodiment;

FIG. 4 is a circuit configuration diagram showing the second embodiment of the reference voltage generation circuit and the current generation circuits applicable to the current generation supply circuit related to this embodiment;

FIG. 5 is a circuit configuration diagram showing the third embodiment of the reference voltage generation circuit and the current generation circuits applicable to the current generation supply circuit related to this embodiment;

FIG. 6 is a circuit configuration diagram showing the fourth embodiment of the reference voltage generation circuit and the current generation circuits applicable to the current generation supply circuit related to this embodiment;

FIGS. 7A, 7B and 7C are diagrams showing the voltage-current characteristic of a p-channel type Field-Effect Transistor applied to the current generation supply circuit related to this embodiments;

FIG. 8 is a circuit configuration diagram showing the fifth embodiment of the reference voltage generation circuit and the current generation circuits applicable to the current generation supply circuit related to this embodiment;

FIG. 9 is a circuit configuration diagram showing the sixth embodiment of the reference voltage generation circuit and the current generation circuits applicable to the current generation supply circuit related to this embodiment;

FIG. 10 is a circuit configuration diagram showing the seventh embodiment of the reference voltage generation circuit and the current generation circuits applicable to the current generation supply circuit related to this embodiment;

FIG. 11 is a circuit configuration diagram showing the eighth embodiment of the reference voltage generation circuit and the current generation circuits applicable to the current generation supply circuit related to this embodiment;

FIG. 12 is a circuit configuration diagram showing the first embodiment applicable to the constant current generation source of the current generation supply circuit related to this embodiment;

FIG. 13 is a circuit configuration diagram showing the second embodiment applicable constant current generation source of the current generation supply circuit related to this embodiment;

FIGS. 14A and 14B are the circuit configuration diagrams showing other embodiments applicable to the constant current generation source of the current generation supply circuit related to this embodiment;

FIG. 15 is a representative diagram showing an example of the current characteristic of the drive currents in the current generation supply circuit related to this embodiment;

FIG. 16 is a circuit configuration diagram showing one embodiment applicable signal holding circuits of the current generation supply circuit related to this embodiment;

FIGS. 17A and 17B are circuit configuration diagrams showing other embodiments applicable to the signal holding circuits of the current generation supply circuit related to this embodiment;

FIG. 18 is an outline block diagram showing the first embodiment of the display device applicable to the current generation supply circuit related to this embodiment;

FIG. 19 is an outline configuration diagram showing an example configuration applicable to the display panel in the display device related to this embodiment;

FIG. 20 is a circuit configuration diagram showing one embodiment applicable to the pixel driver circuit of the display pixels in the display device related to the embodiments;

FIG. 21 is a timing chart showing an example of the control operations in the pixel driver circuits related to the embodiments;

FIG. 22 is an outline configuration diagram showing the first embodiment of the data driver applicable to the display device related to this embodiment;

FIG. 23 is a configuration diagram showing a detailed configuration example of the gradation current generation circuit sections applicable to the first embodiment of the data driver related to this embodiment;

FIG. 24 is a timing chart showing an example of the control operations in the first embodiment of the data driver related to this embodiment;

FIG. 25 is an outline block diagram showing the second embodiment of the display device applicable to the current generation supply circuit related to this embodiment;

FIG. 26 is an outline configuration diagram showing an example configuration of the display panel applicable to the display device related to the embodiments;

FIG. 27 is a circuit configuration diagram showing one embodiment applicable to the pixel driver circuits of the display pixels in the display device related to the embodiments;

FIG. 28 is a timing chart showing an example of the control operations in the pixel driver circuits related to the embodiments;

FIG. 29 is an outline configuration diagram showing the second embodiment of the data driver applicable to the display device related to this embodiment;

FIG. 30 is a configuration diagram showing a detailed configuration example of the gradation current generation circuit sections applicable to the second embodiment of the data driver related to this embodiment;

FIG. 31 is an outline configuration diagram showing the third embodiment of the data driver applicable to the display device related to this embodiment;

FIG. 32 is a timing chart showing an example of the control operations in the third data driver related to this embodiment;

FIG. 33 is an outline configuration diagram showing the fourth embodiment of the data driver applicable to the display device related to this embodiment;

FIG. 34 is an outline configuration diagram showing the fifth embodiment of the data driver applicable to the display device related to this embodiment;

FIG. 35 is a configuration concept diagram showing the relationship of the data driver and the display panel in the sixth embodiment of the data driver applicable to the display device related to this embodiment;

FIG. 36 is a block diagram showing the relevant sectional configuration in the sixth embodiment data driver related to this embodiment;

FIGS. 37A and 37B are outline configuration diagrams showing an example configuration of a data latch circuits applicable to the sixth embodiment of the data driver related to this embodiment;

FIGS. 38A and 38B are outline configuration diagrams showing an example configuration of the switching circuits applicable to the data driver related to the embodiment;

FIG. 39 is an outline configuration diagram showing the first embodiment of the current latch circuits applicable to the data driver related to this embodiment;

FIGS. 40A and 40B are circuit configuration diagrams showing an example of the current storage sections applicable to the current latch circuits related to this embodiment;

FIG. 41 is an outline configuration diagram showing the second embodiment of the current latch circuits applicable to the data driver related to this embodiment;

FIG. 42 is a timing chart showing an example of the control operations in the sixth embodiment of the data driver related to this embodiment;

FIG. 43 is a conceptual diagram showing the effect of the dimensional variation differences in the manufacturing process of Field-Effect Transistors;

FIG. 44 is a conceptual diagram showing the first layout embodiment method of the standard transistors which constitute the current mirror circuits in the current generation supply circuit related to the embodiments;

FIG. 45 is a circuit configuration diagram showing the first embodiment arrangement and connection pattern of the standard transistors which constitute the current mirror circuits in the current generation supply circuit related to the embodiments;

FIG. 46 is a circuit configuration diagram showing the second embodiment arrangement and connection pattern of the standard transistors which constitute the current mirror circuits in the current generation supply circuit related to the embodiments;

FIG. 47 is a conceptual diagram showing the third embodiment layout method of the standard transistors which constitute the current mirror circuits in the current generation supply circuit related to the embodiments; and

FIG. 48 is a circuit configuration diagram showing the third embodiment arrangement and connection pattern of the standard transistors which constitute the current mirror circuits in the current generation supply circuit related to the embodiments.

### DETAILED DESCRIPTION OF THE INVENTION

Hereinafter, a display device comprised with a current generation supply circuit related to the present invention, and particularly relating to a current generation supply circuit and the method for driving the display device will be explained in detail.

<The First Embodiment of the Current Generation Supply Circuit>

Initially, the first embodiment of the current generation values and are set up corresponding to each load in order to make them operate in the desired drive state of a plurality of loads (for example, the display pixels described later), and the signal holding circuits DLA-1, DLA-2, . . . (hereinafter denoted as the “signal holding circuits DLA”) for taking in and holding the load control signals (plurality bits of the digital signals) which control the drive state of the above-mentioned loads and are set up corresponding to the current generation circuits ILA.

The current generation supply circuit 100A according to this embodiment comprises a configuration which flows in the drive currents IA from the current generation supply circuit side toward the loads (hereinafter denoted as the “current application method.”

Additionally, in each embodiment explained below, although explained in the situation whereby 4-bit digital signals d0, d1, d2 and d3 (hereinafter denoted as the “digital signals d0˜d3 are applied as the load control signals for generating the drive currents IA, it is emphasized that the present invention is not limited to only 4-bit digital signals.

Hereinafter, each of the above-mentioned configurations will be explained in detail.

(Signal Holding Circuits)

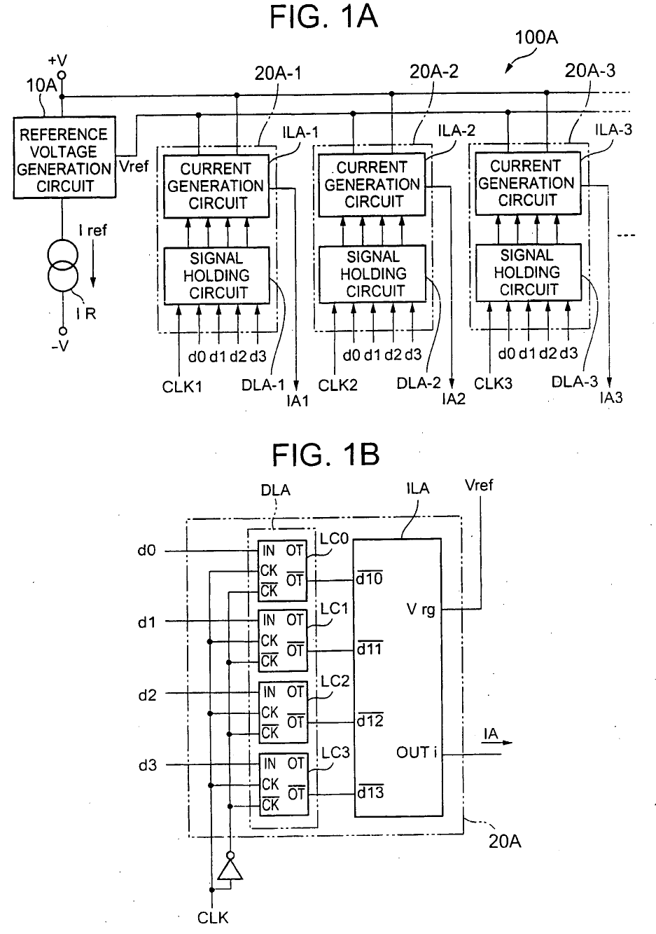

The signal holding circuits DLA, as shown in FIG. 1B, have a configuration consisting of a number of latch circuits LC0, LC1, LC2, LC3 (hereinafter denoted as the “latch circuits supply circuit related to the embodiment will be explained with reference to the drawings.

FIGS. 1A and 1B are outline configuration diagrams showing the first embodiment of the current generation supply circuit related to this embodiment.

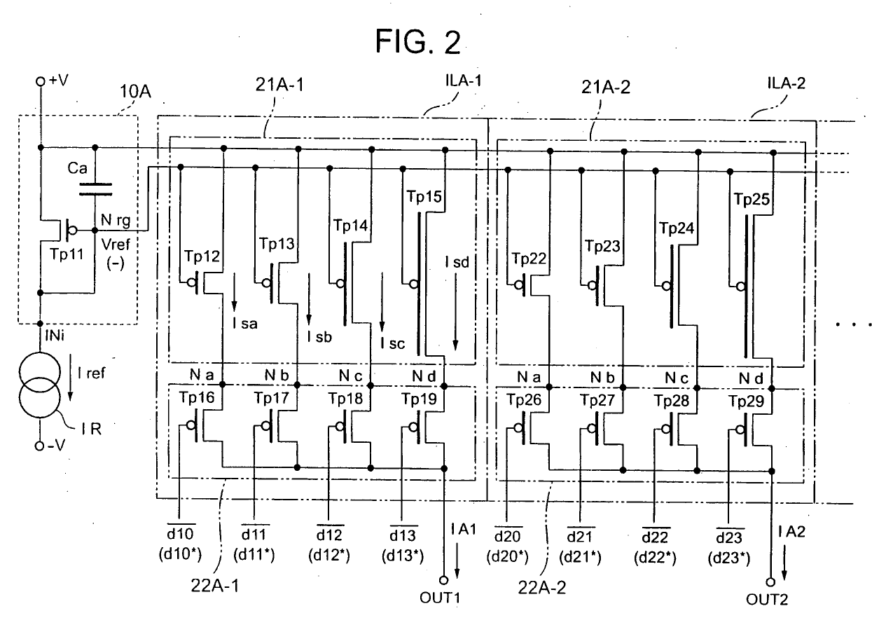

FIG. 2 is a circuit configuration diagram showing the first embodiment of the reference voltage generation circuit and the current generation circuits applicable to the current generation supply circuit related to this embodiment.

As shown in FIG. 1, the current generation supply circuit 100A according to this embodiment is divided roughly into a configuration comprising a constant current generation source IR for supplying the reference current Iref which has a predetermined constant current value between the voltage contact +V (hereinafter denoted as the “high electric potential +V) connected to the high electric potential and the voltage contact −V (hereinafter denoted as the “low electric potential −V) connected to the low electric potential; a reference voltage generation circuit 10A connected in series to the constant current generation source IR; and a plurality of current generation circuit sections 20A-1, 20A-2, . . . (hereinafter denoted as the “current generation circuit sections 20A”) comprising the current generation circuits ILA-1, ILA-2, . . . (hereinafter denoted as the “current generation circuits ILA) for generating and supplying the drive currents IA-1, IA-2, . . . (hereinafter denoted as the “drive currents IA”) which have a predetermined current LC0˜LC3) set up in parallel and correspond to the digital signals d0˜d3 number of the bits (4-bits) for controlling the drive state of the above-mentioned loads. According to the timing control signals CLK1, CLK2, CLK3, . . . (hereinafter denoted as the “timing control signals CLK”) outputted from an external timing generator, external shift register or the like, as the latch circuits LC0˜LC3 take in and hold simultaneously the digital signals d0˜d3 supplied each other individually via each of the input terminals IN, an operation is executed which outputs the signal levels via each of the inverted output terminals OT* (In the specification, “OT” denotes the non-inverted output terminals and “OT*” denotes the inverted output terminals) based on the appropriate digital signals d0˜d3. The specific configuration applicable to the signal holding circuits DLA will be described later.

(Reference Voltage Generation Circuit/Current Generation Circuits)

Next, the specific configuration applicable to the reference voltage generation circuit and the current generation circuits in the first embodiment of the current generation supply circuit will be explained.

The reference voltage generation circuit 10A configuration, in this embodiment, for example as shown in FIG. 2, comprises a reference current transistor Tp11.

Furthermore, the current generation circuits ILA, for example as shown in FIG. 2, are configured with a plurality of current generation circuits ILA-1, ILA-2, . . . connected in parallel to the reference voltage generation circuit 10A. Each of the current generation circuits ILA-1, ILA-2, . . . comprise a plurality of module current transistors Tp12˜Tp15, Tp22˜Tp25, . . . . Here, the gate terminal (control terminal) of the reference current transistor Tp11 and the gate terminal (control terminal) of each of the module current transistors are connected in common to the contact Nrg and constitute a current mirror circuit.

Also, by applying the voltage component Vref (gate voltage; reference voltage) generated based on the reference current Iref supplied to the reference current transistor Tp11 in common to the gate terminal of the module current transistors Tp12˜Tp15, Tp22˜Tp25, . . . of each of the current generation circuits ILA-1, ILA-2, . . . , a plurality of module currents Isa, Isb, Isc, Isd (here four varieties of module currents) are generated simultaneously which have a different current value ratio in each of the current generation circuit sections 20A-1, 20A-2, . . . . Among these module currents Isa˜Isd, each module current is selected and integrated based on the inverted output signals d10*˜d13* outputted from the above-mentioned signal holding circuits DLA (each of the inverted output terminals OT* of the latch circuits LC0˜LC3) and each load is supplied as the drive currents IA1, IA2, . . . via each of the current output terminals OUT1, OUT2, . . . (hereinafter denoted as the “current output terminals OUTi”).

More specifically, as shown in FIG. 2, the current mirror circuit arrangement applicable to the reference voltage generation circuit 10A and the current generation circuits ILA has a configuration comprising a p-channel type Field-Effect Transistor Tp11 (reference current transistor) by which the gate terminal is connected to the contact Nrg along with the current path (source-drain terminals) of the reference voltage generation circuit 10A connected between the current input contact INi and the high electric potential +V to which the reference current Iref is supplied by the constant current generation source IR; and a plurality of (four corresponding to the latch circuits LC0˜LC3) p-channel type Field-Effect Transistors Tp12˜Tp15, Tp22˜Tp25, . . . (module current transistors) by which the gate terminals are connected in common to the above-mentioned contact Nrg along with the current path connected respectively between each of the contacts Na, Nb, Nc, Nd in the module current generation circuits 21A-1, 21A-2, . . . (hereinafter denoted as the “module current generation circuits 21A”) which constitute each of the current generation circuits ILA-1, ILA-2, . . . and the high electric potential +V. Here, with the contact Nrg directly connected to the current input contact INi, a parasitic capacitor Ca is arranged between the gate-source of the reference current transistor Tp11 and connected between the high electric potential +V.

Additionally, each of the current generation circuits ILA comprise the selection switching circuits 22A-1, 22A-2, . . . (drive current generation circuits) (hereinafter denoted as the “selection switching circuits 22A”) which are applied in parallel to a plurality (four devices) of the selection transistors Tp16˜Tp19, Tp26˜Tp29, . . . composed of p-channel type Field-Effect Transistors to which the inverted output signals d10*˜d13* are individually outputted from each of the above-mentioned latch circuits LC0˜LC3 to the gate terminals. The current path is connected respectively between each of the contacts Na, Nb, Nc, Nd and the current output terminal OUTi connected to the loads.

Here, the current generation circuits ILA according to this embodiment, in particular, each of the module currents Isa˜Isd which flow in the module current transistors Tp12˜Tp15, Tp22˜Tp25 that constitute the current mirror circuit is set so that the current values of each other have a different predetermined ratio relative to the reference current Iref which flows into the reference current transistor Tp11.

Specifically, in the current module generation circuit 21A-1, the transistor size of each of the module current transistors Tp12˜Tp15 is set so that each other has a different ratio. For example, while assuming constant channel length in each of the module current transistors Tp12˜Tp15, each channel width ratio (W2:W3:W4:W5) is designed to be set to 1:2:4:8. Besides, the additional module current generation circuits 21A-2, . . are designed so that the channel widths have the same ratios.

Accordingly, with the channel width of the reference current transistor Tp11 set to W1, the current values of the module currents Isa˜Isd which flow in each of the module current transistors Tp12˜Tp15, Tp22˜Tp25, . . . each other is set as Isa=(W2/W1)×Iref, Isb=(W3/W1)×Iref, Isc=(W4/W1)×Iref and Isd=(W5/W1)×Iref. In other words, the channel widths (W2, W3, W4, W5) of the module current transistors Tp12˜Tp15, Tp22˜Tp25, . . . , for example, are based on the channel width (W1) of the reference current transistor Tp11. Thus, the current values between the module currents Isa˜Isd relative to the reference current Iref can be set to a ratio specified as 2ⁿ by setting each one as 2ⁿ (n=0, 1, 2, 3, . . . ; 2ⁿ=1, 2, 4, 8, . . . ).

In this manner the current values are set from each of the module currents Isa˜Isd and the drive currents IA (gradation currents) which have current values of 2ⁿ step are generated by selecting and integrating random module currents based on plurality bits of the digital signals d0˜d3 (inverted output signals d10*˜d13*). Accordingly, as shown in FIG. 1 and FIG. 2, when the 4-bit digital signals d0˜d3 are applied, corresponding to the “ON/OFF” state of the selection transistors Tp16˜Tp19 connected to each of the module current transistors Tp12˜Tp15, the drive currents IA having different current values of 2⁴=16 steps are generated.

Therefore, in the current generation circuits ILA (for example, the current generation circuit ILA-1) which have such a configuration, the specified selection transistors of the selection switching circuit 22A-1 perform an “ON” operation (The case where any one or more of the selection transistors Tp16˜Tp19 perform an “ON” operation, except for when some of the selection transistors Tp16˜Tp19 perform an “OFF” operation is included.) corresponding to the signal levels of the inverted output signals d10*˜d13* outputted from the above-mentioned signal holding circuits DLA (latch circuits LC0˜LC3). The module currents Isa˜Isd having predetermined current value ratios (a×2ⁿ gradation; a is the constant specified by the channel width W1 of the reference current transistor Tp11) flow relative to the reference current Iref of constant current value which flows to the reference current transistor Tp11 to the module current transistors (any one or more of Tp12˜Tp15) of the module current generation circuit 21A-1 connected to the selection transistors Tp16˜Tp19 that perform an “ON” operation to the current output terminal OUTi. The drive currents IA having current values representing the composite value of these module currents flow to the load side from the high electric potential +V via the module current generation circuit 21A-1 (any of the module current transistors Tp12˜Tp15), the selection switching circuit 22A-1 (any of the selection transistors Tp16˜Tp19 in an “ON” state) and the current output terminal OUTi.

Accordingly, in each of the current generation circuits ILA according to this embodiment, the drive currents IA composed of analog currents having predetermined current values are generated and supplied to the loads based on the constant current value of the reference current Iref and the constant high electric potential +V using the timing specified by the timing control signals CLK corresponding to plurality bits of the digital signals d0˜d3 inputted to the signal holding circuits DLA. Even if the current values of the drive currents are low or the supply time period of the drive currents to the loads is set briefly, the operating speed of the current generation circuits cannot be influenced by the current flow from the current source or the voltage source or by the effect of voltage supply delays. Therefore, the appropriate drive currents for the loads can be supplied.

Furthermore, in the current generation supply circuit according to this embodiment, because the reference voltage generation circuit which supplies the reference current has a shared configuration with a plurality of current generation circuits set up corresponding to each of the loads, augmentation of the circuit configuration relative to increasing the number of loads can be controlled, enlargement of the circuit area of the current generation supply circuit can be controlled and cost reduction can be promoted.

In addition, in the configuration in which the reference voltage generation circuit is shared with a plurality of current generation circuits and the same reference voltage is supplied to a plurality of current generation circuits, it is possible to control drive current variations generated and outputted in each of the current generation circuits by generating and supplying drive currents having uniform current values.

<The Second Embodiment of the Current Generation Supply Circuit>

Next, the second embodiment of the current generation supply circuit related to this embodiment will be explained with reference to the drawings.

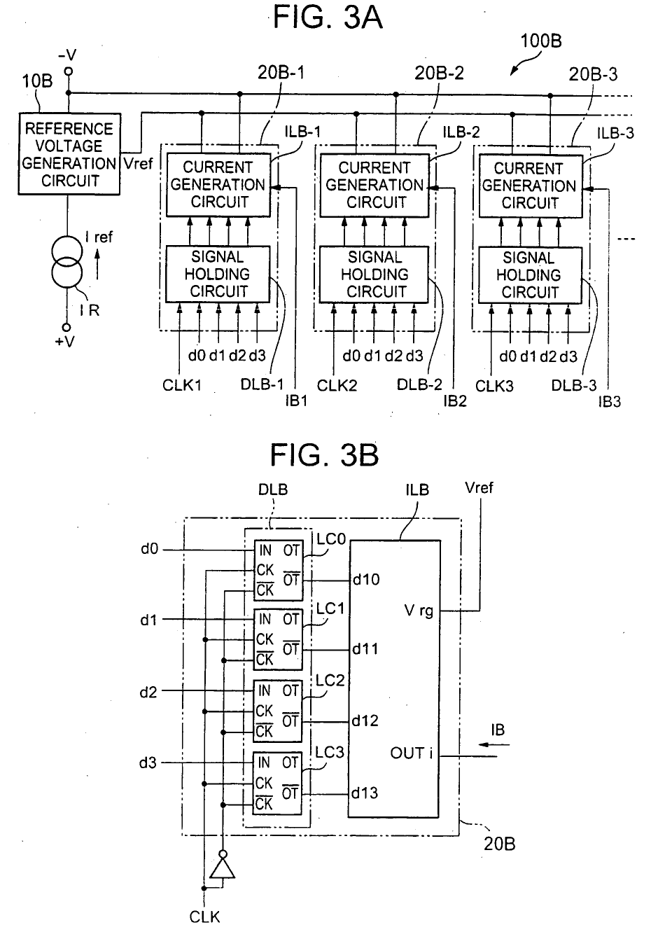

FIGS. 3A and 3B are outline configuration diagrams showing the second embodiment of the current generation supply circuit related to this embodiment.

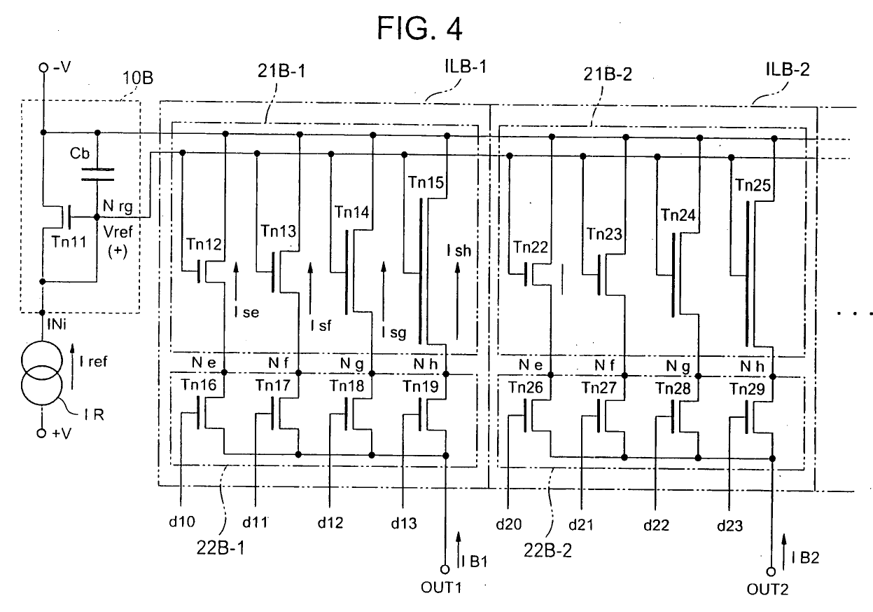

FIG. 4 is a circuit configuration diagram showing the second embodiment of the reference voltage generation circuit and the current generation circuits applicable to the current generation supply circuit related to this embodiment.

Here, concerning any configuration equivalent in the embodiment mentioned above, the same or equivalent nomenclature is appended and the explanation is simplified or omitted from the description.

Additionally, in the first embodiment of the current generation supply circuit mentioned above, although the case of the current generation supply circuit comprising the current application method is indicated, the current generation supply circuit in the second embodiment comprises a configuration which the drive currents are flowed in the direction of the current generation supply circuit from the loads side (hereinafter denoted as the “current sinking method”).

As shown in FIG. 3A, the current generation supply circuit 100B according to this embodiment is divided roughly into a configuration comprising a reference voltage generation circuit 10B having the equivalent composition of the first embodiment mentioned above; and a plurality of current generation circuit sections 20B-1, 20B-2, 20B-3, . . . (hereinafter denoted as the “current generation circuit sections 20B”) comprising the current generation circuits ILB-1, ILB-2, ILB-3, . . . (hereinafter denoted as the “current generation circuits ILB”) and the signal holding circuits DLB-1, DLB-2, DLB-3, . . . (hereinafter denoted as the “signal holding circuits DLB”). Here, as for the reference voltage generation circuit 10B, the high electric potential +V is connected to the constant current generation source IR side and the low electric potential −V is connected to the reference voltage generation circuit 10B side so that the reference current Iref flows in the direction of the reference voltage generation circuit 10B from the constant current generation source IR.

The signal holding circuits DLB related to this embodiment are connected so that the non-inverted output signals d10˜d13 are outputted to the current generation circuits ILB via the non-inverted output terminals OT of each of the latch circuits LC0˜LC3.

As shown in FIG. 4, the reference voltage generation circuit 10B configuration comprises a reference current transistor Tn11. The current generation circuits ILB are connected in parallel to a plurality of the current generation circuits ILB-1, ILB-2, . . . to the reference voltage generation circuit 10B. Each of the current generation circuits ILB-1, ILB-2, . . . comprise a plurality of module current transistors Tn12˜Tn15, Tn22˜Tn25, . . . whereby the gate terminal of the reference current transistor Tn11 and the gate terminal each of the module current transistors are connected in common at contact Nrg and constitute the current mirror circuit.

The module current generation circuits 21B-1, 21B-2, . . . (hereinafter denoted as the “module current generation circuits 21B”) have an equivalent configuration to the above-mentioned first embodiment. The gate terminal of the reference current transistor Tn11 is composed of an n-channel type Field-Effect Transistor which constitutes the reference voltage generation circuit 10B. The gate terminals of a plurality of the module current transistors Tn12˜Tn15, Tn22˜Tn25, . . . are composed of n-channel type Transistors and each other is set to a plurality of the current generation circuits ILB-1, ILB-2, . . . (module current generation circuits 21B) connected in parallel to the reference voltage generation circuit 10B which constitute the current mirror circuit connected in common with each other at the contact Nrg. Here, with the contact Nrg connected to the constant current generation source IR via the current input contact INi, a parasitic capacitor Cb is arranged between the gate-source of the reference current transistor Tn11 and connected between the low electric potential −V.

Also equivalent to the case of the first embodiment mentioned above, each of the module current transistors Tn12˜Tn15, Tn22˜Tn25, . . . which constitute the module current generation circuits 21B-1, 21B2, . . . are designed so that each other has a different ratio based on the transistor size (That is, the channel widths while assuming constant channel length) of the reference current transistor Tn11. The module currents Ise, Isf, Isg and Ish which flow in each current path are set so that the current values of each other have a different predetermined ratio relative to the reference current Iref.

Moreover, each of the current generation circuits ILB comprise the selection switching circuits 22B-1, 22B-2, . . . (hereinafter denoted as the “selection switching circuits 22B”) connected in parallel with each other to a plurality (four devices) of the selection transistors Tn16˜Tn19, Tn26˜Tn29, . . . composed of n-channel type Field-Effect Transistors connected between each of the contacts Ne, Nf, Ng, Nh on one end of the above-mentioned module current transistors Tn12˜Tn15, Tn22˜Tn25, . . . and the current output terminal OUTi connected to the loads. Their “ON/OFF” operations are controlled based on the non-inverted output signals d10˜d13 individually outputted from each of the above-mentioned latch circuits LC0˜LC3.

Accordingly, by applying the voltage component Vref (reference voltage) generated to the gate terminals based on the reference current Iref which flows to the reference current transistor Tn11 in common to the gate terminals of the module current transistors Tn12˜Tn15, Tn22˜Tn25, . . . of each of current generation circuits ILB-1, ILB-2, . . . , a plurality of module currents Ise˜Ish are generated simultaneously which have a mutually different current value ratio in each of the current generation circuit sections 20B-1, 20B-2, . . . . By controlling the “ON/OFF” operations of the selection transistors Tn16˜Tn19, Tn-26˜Tn29 based on the non-inverted output signals d10˜d13 outputted from the signal holding circuits DLB (latch circuits LC0˜LC3), specified module currents are selected and integrated from among the module currents Ise˜Ish and the drive currents IB1, IB2, . . . (hereinafter denoted as the “drive currents IB”) are generated. The drive currents IB1, IB2, . . . are supplied so as to draw the low electric potential −V via each of the current output terminals OUT1, OUT2, . . . , the selection switching circuits 22B-1, 22B-2, . . . and the module current generation circuits 21B-1, 21B-2 from the loads side.

<The Third Embodiment of the Reference Voltage Generation Circuit and the Current Generation Circuits>

Next, the third embodiment of the specific configuration applicable to the reference voltage generation circuit and current generation circuits of the current generation supply circuit in this embodiment will be explained with reference to the drawings.

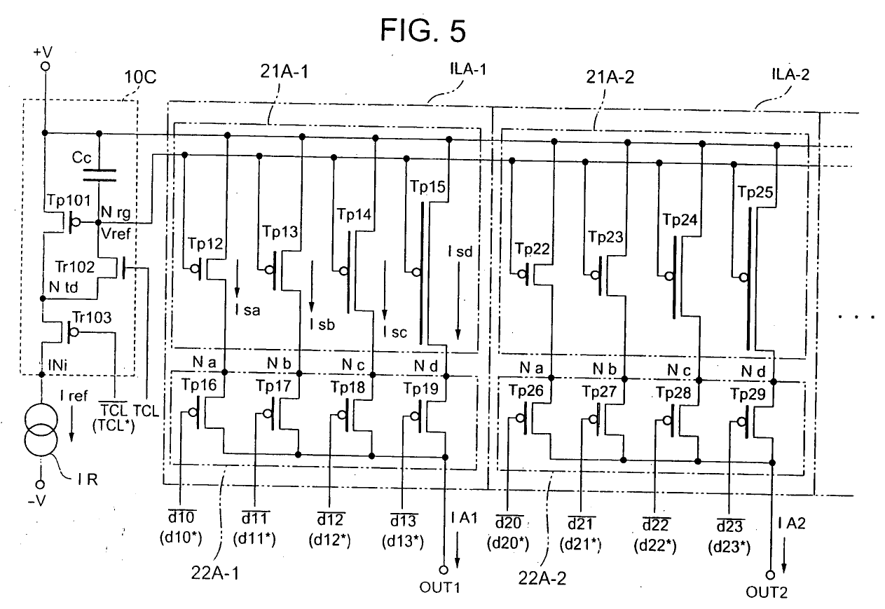

FIG. 5 is a circuit configuration diagram showing third the third embodiment of the reference voltage generation circuit and the current generation circuits applicable to the current generation supply circuit related to this embodiment.

Here, concerning any configuration equivalent in the embodiments mentioned above, the same or equivalent nomenclature is appended and the explanation is simplified or omitted from the description.

Additionally, in this embodiment, although the circuit configuration corresponds to the current application method of the first embodiment of the current generation supply circuit mentioned above, the circuit configuration can also be made to correspond to the current sink method in the second embodiment of the current generation supply circuit mentioned above.

Furthermore, in this embodiment, the current generation circuits ILA-1, ILA-2, . . . are composed of the module current generation circuits 21A-1, 21A-2, . . . and the selection switching circuits 22A-1, 22A-2, . . . which comprise the equivalent configuration to the structure of the first embodiment current generation circuits ILA shown in FIG. 2.

The reference voltage generation circuit and the current generation circuits in the current generation supply circuit related to this embodiment are constituted so that the reference voltage Vref generated is equivalent to the first embodiment mentioned above by flowing the reference current Iref into the reference voltage generation circuit from the current source is applied to the current generation circuits.

The reference voltage generation circuit 10C applicable to the current generation supply circuit in this embodiment, as shown in FIG. 5, has a configuration comprising a reference current transistor Tp101, are fresh control transistor Tr102, a condenser Cc (capacitor) and a current supply source control transistor Tr13. The reference current transistor Tp101 composed of a p-channel type transistor has a current path between the high electric potential +V and the constant current generation source IR with the gate terminal connected to the contact Nrg. The refresh control transistor Tr12 composed of an n-channel type transistor has a current path between the gate terminal (contact Nrg) and the drain terminal (contact Ntd) of the reference current transistor Tp101 along with the non-inverted control signals TCL applied to the gate terminal at predetermined timing. The condenser Cc (capacitor) having predetermined capacity is connected between the gate terminal (contact Nrg) of the reference current transistor Tp101 and the source terminal (high electric potential +V). The current supply source control transistor Tr13 composed of a p-channel type transistor has a current path between the drain terminal (contact Ntd) of the reference current transistor Tp101 and the constant current generation source IR along with the inverted control signals TCL* applied to the gate terminal at predetermined timing.

Accordingly, as for the reference voltage generation circuit 10C in this embodiment, by controlling the “ON/OFF” operations (continuity condition) of the refresh control transistor Tr12 and the current supply source control transistor Tr13 based on the signal levels of the non-inverted control signals TCL and the inverted control signals TCL*, the supply of the reference current Iref to the reference current transistor Tp101 and generation of the module currents in each of the current generation circuits ILA-1, ILA-2, . . . is controlled.

Here, the gate terminal of the reference current transistor Tp101 in the reference voltage generation circuit 10C and each of the module current transistors Tp12˜Tp15, Tp22˜Tp25, . . . of each of the current generation circuits ILA-1, ILA-2, . . . are connected in common at the contact Nrg which constitute the current mirror circuit. By controlling the “ON/OFF” state of each of the selection transistors Tp16˜Tp19, Tp26˜Tp29, . . . which constitute the selection switching circuits 22A based on the inverted output signals d10*˜d13* from the signal holding circuits DLA, the module currents Isa˜Isd having a current value of predetermined ratio relative to the reference current Iref that flows to the reference voltage generation circuit 10C is selected and integrated, and the drive currents IA1, IA2, . . . are generated.

Additionally, in this embodiment, by synchronously applying the non-inverted control signals TCL which control the operating state of the refresh control transistor Tr12 and the inverted control signals TCL* which control the operating state of the current supply source control transistor Tr13 which constitute the reference voltage generation circuit 10C, both of these control transistors Tr12, Tr13 are controlled so as to perform an “ON” operation or an “OFF” operation simultaneously. Therefore, the state where the reference current Iref is supplied to the reference current transistor Tp101 in which the predetermined voltage component is applied (electrical charge) to the gate terminal (contact Nrg) and the state when the supply of this reference current Iref is blocked are set selectively.

Especially, in the case (signal holding operation period) of taking in and holding the load control signals to the current generation supply circuit to be described later, the above-stated control signals TCL, TCL* are set so that the above-mentioned refresh control transistor Tr12 and the current supply source control transistor Tr13 perform an “ON” operation, based on the load control signals which perform the above-described taking in and holding functions. Conversely, in the case (current generation supply operation) of generating and outputting the drive currents for the operating loads in the predetermined drive state, the above-mentioned control signals TCL, TCL* are set so that the refresh control transistor Tr12 and the current supply source control transistor Tr13 perform an “OFF” operation.

In addition, in this embodiment, an n-channel type transistor is applied as the refresh control transistor Tr12 and a p-channel type transistor is applied as the current supply source control transistor Tr13. Even though the configuration which controls the operating state of both control transistors Tr12, Tr13 is explained using the control signals TCL, TCL* having inverted relationship in regard to the signal polarity with each other, the present invention is not restricted to this. The refresh control transistor and the current supply source control transistor only have to perform approximate synchronization and be set to the same operating state. For example, the transistors have the same channel polarity set in both sides and the operating state can be controlled by a single control signal.

In the signal holding operation period which takes in and holds the load control signals in the signal holding circuits of the current generation circuit sections in the current generation supply circuit having such a configuration, by performing an “ON” operation to both the refresh control transistor Tr12 and the current supply source control transistor Tr13 of the reference voltage generation circuit 10C, while the reference current Iref which has a constant current value flows in the current path of the reference current transistor Tp101, the gate voltage of this reference current transistor Tp101 is applied to the current generation circuits ILA-1, ILA-2, . . . (module current generation circuits 21A-1, 21A-2, . . . ) of each of the current generation circuit sections as the reference voltage Vref.

Accordingly, by performing an “ON” operation or an “OFF” operation to each of the selection transistors Tp16˜Tp19, Tp26˜Tp29, . . . in the selection switching circuits 22A-1, 22A-2, . . . based on the inverted output signals d10*˜d13* from the signal holding circuits, each of the module current transistors Tp12˜Tp15, Tp22˜Tp25, . . . in the module current generation circuits 21A-1, 21A-2 connected to the selection transistors perform an “ON” operation based on the reference voltage Vref applied to the above-mentioned reference voltage generation circuit 10C. Since the “ON” operation is performed by the predetermined continuity condition and predetermined module currents flow, the module currents corresponding to the signal levels of the inverted output signals d10*˜d13* are integrated and the drive currents IA1, IA2, . . . corresponding to the desired loads of the drive state are generated. At this point in the reference voltage generation circuit 10C, the refresh control transistor Tr12 and the current supply source control transistor Tr13 perform an “ON” operation. The electrical charge supplied to the gate terminal (contact Nrg) of the reference current transistor Tp101 from the constant current generation source IR is stored (charge) in condenser Cc as the voltage component and the reference voltage Vref is regulated (refresh operation) to almost predetermined constant voltage.

Furthermore, in the current generation supply circuit according to this embodiment, in the current generation supply operation which generates and supplies the drive currents in each of the current generation circuit sections based on the above-mentioned taking in and holding of the load control signals, by performing an “OFF” operation of both the refresh control transistor Tr12 and the current supply source control transistor Tr13 of the reference voltage generation circuit 1C, the supply of the electrical charge to the gate terminal (contact Nrg) of the reference current transistor Tp101 is blocked out. At this point, the electric potential (reference voltage) at the gate terminal of the reference current transistor Tp101 from the voltage component charged to the condenser Cc and since it is held almost constant in each of the current generation circuit sections, the module currents flow only to the specified module current transistors based on the above-described load control signals, and the drive currents IA1, IA2, . . . having the desired current values are generated by integrating these module currents. Accordingly, the drive currents IA1, IA2, . . . have current values corresponding to the load control signals (inverted output signals d10*˜d13*) from each of the current generation circuits 21A-1, 21-2, . . . supplied continuously to each of the loads, and the loads operate at the desired drive state.

Therefore, by repeating successively such a signal holding operation and the current generation supply operation along with executing them at predetermined periods, since the electric potential (reference voltage) of the gate terminal (contact Nrg) of each of the module current transistors which constitute each of the current generation circuit sections (module current generation circuits) can be recharged (refreshed) to predetermined voltage values periodically, a decline in the reference voltage resulting from a current leak and the like in the module current transistors can be controlled through variation of the current continuity condition of each of the module current transistors. Thus, the phenomenon which causes fluctuation of the drive currents (That is, the drive state of the loads) can be controlled and the loads operated under an appropriate steady-state.

<The Fourth Embodiment of the Reference Voltage Generation Circuit and the Current Generation Circuits>

Next, the fourth embodiment of the specific configuration applicable to the reference voltage generation circuit and current generation circuits of the current generation supply circuit in this embodiment will be explained with reference to the drawings.

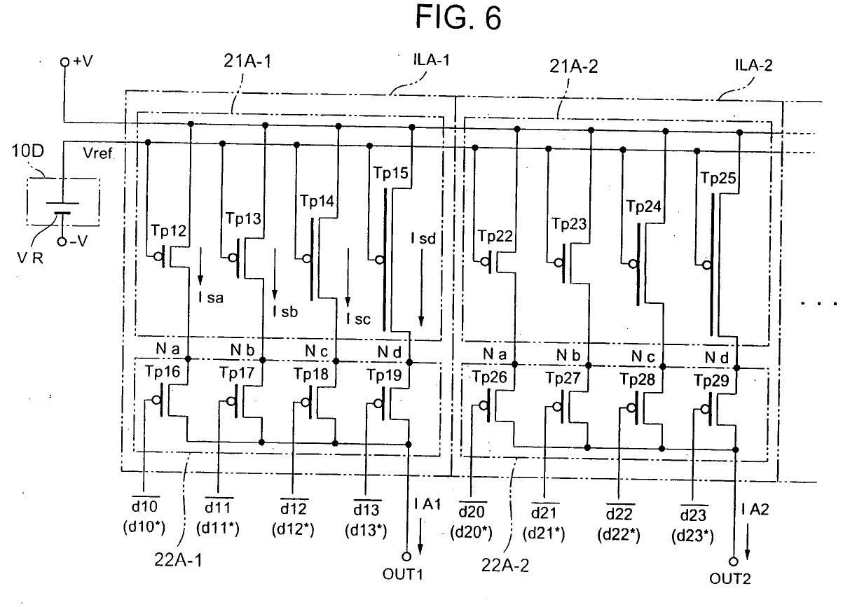

FIG. 6 is a circuit configuration diagram showing the fourth embodiment of the reference voltage generation circuit and the current generation circuits applicable to the current generation supply circuit related to this embodiment.

Here, concerning any configuration equivalent mentioned in the embodiments above, the same or equivalent nomenclature is appended and the explanation is simplified or omitted from the description.

Additionally, although the circuit configuration corresponds to the current application method of the first embodiment of the current generation supply circuit mentioned above, the circuit configuration can also correspond to the current sink method in the second embodiment of the current generation supply circuit mentioned above.

Furthermore, in this embodiment, the current generation circuits ILA-1, ILA-2, . . . composed of the module current generation circuits 21A-1, 21A-2, . . . and the selection switching circuits 22A-1, 22A-2, . . . comprise the equivalent configuration to the structure in the first embodiment of the current generation circuits ILA shown in FIG. 2.

The reference voltage generation circuit 10D related to this embodiment, as shown in FIG. 6, has a configuration comprising a constant voltage source VR for applying the constant reference voltage Vref regularly to the gate terminals of each of the module current transistors Tp12˜Tp15, Tp22˜Tp25, . . . which constitute each of the module current generation circuits 21A-1, 21A-2, . . . set in each of the current generation circuits ILA-1, ILA-2, . . . .

Accordingly, the first and third embodiments of the current generation supply circuits mentioned above have the current mirror circuit configuration in which the gate terminal of the reference current transistor which constitutes the reference voltage generation circuit and the gate terminals of a plurality of module current transistors that constitute the module current generation circuits are connected in common. When the reference current flows to the reference current transistor, it is constituted so that a plurality of module currents can be generated with the previous current values regulated in each of the module current transistors based on the reference voltage generated in the gate terminal of that reference current transistor. Therefore, the current-voltage conversion which generates the reference voltage from the reference current with the reference current transistor is performed and the configuration which applies the reference voltage to the module current generation circuits is applicable.

Then, in this embodiment, the reference voltage generation circuit 10D based on this perspective comprises the constant voltage source VR for generating the constant voltage without using the reference current transistor as shown in each embodiment mentioned above, and has a configuration made to apply this constant voltage directly as the reference voltage Vref to the module current generation circuits 21A-1, 21A-2, . . . of each of the current generation circuits ILA-1, ILA-2, . . . . According to such a configuration, the circuit structure can be simplified as it can be comprised of only the constant voltage source VR as the reference voltage generation circuit 10D.

<The Fifth Embodiment of the Reference Voltage Generation Circuit and the Current Generation Circuits>

Next, the fifth embodiment specific configuration applicable to the reference voltage generation circuit and current generation circuits of the current generation supply circuit in this embodiment will be explained with reference to the drawings.

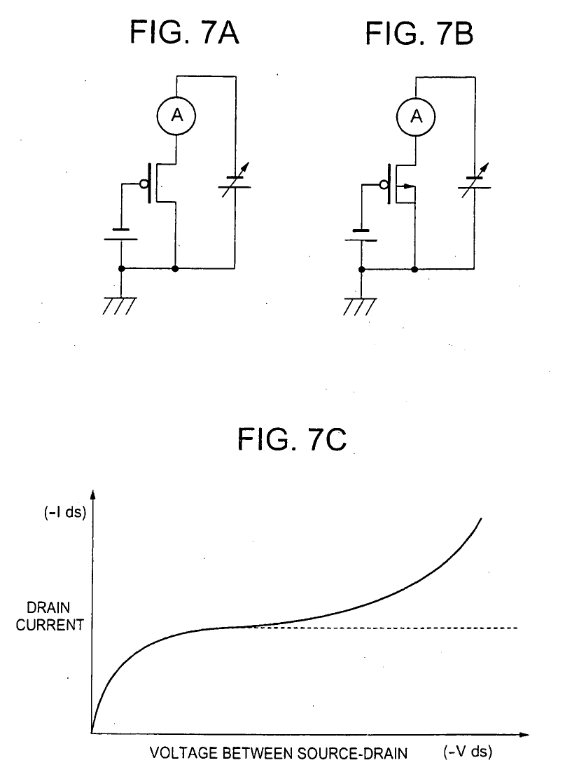

FIGS. 7A, 7B and 7C are diagrams showing the voltage-current characteristic of a p-channel type Field-Effect Transistor applied to the current generation supply circuit related to this embodiment.

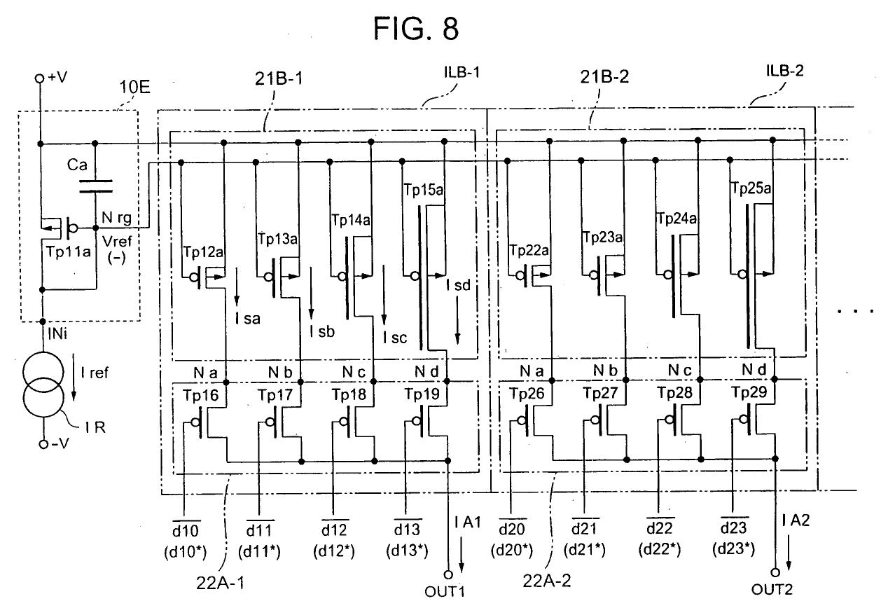

FIG. 8 is a circuit configuration diagram showing the fifth embodiment of the reference voltage generation circuit and the current generation circuits applicable to the current generation supply circuit related to this embodiment.

Here, concerning any configuration equivalent in the embodiments mentioned above, the same or equivalent nomenclature is appended and the explanation is simplified or omitted from the description.

Additionally, in this embodiment, although the circuit configuration corresponds to the current application method of the first embodiment of the current generation supply circuit mentioned above, the circuit configuration can also correspond to the current sink method in the second embodiment of the current generation supply circuit mentioned above.

Furthermore, in this embodiment, the selection switching circuits 22A-1, 22A-2, . . . in the current generation circuits ILB-1, ILB-2, . . . comprise the equivalent configuration as the first embodiment.

First, the Thin-Film type Field-Effect Transistor characteristic applicable to the current generation supply circuit of this embodiment will be explained. Even though the following description describes only the Thin-Film p-channel type Field-Effect Transistor, it is emphasized that the Thin-Film n-channel type Field-Effect Transistor is similarly applicable.

Accordingly, to substantiate the voltage-current characteristic of the widely known Thin-Film p-channel type Field-Effect Transistor, the circuit shown in FIG. 7A is used. Also, as shown by the dashed line in FIG. 7C, although the voltage between source-drain (−Vds) is within the specified voltage region, the drain current (current between source-drain; −Ids) shows saturation inclination. The ideal characteristic is that the drain current characteristic be assumed as an almost constant current value. Actually, as shown in FIG. 7C, the continuous line reflects the inclination of the absolute value of the drain current once showing the saturation inclination that accompanies increases in the absolute value of the applied voltage (voltage between source-drain; −Vds). This type of phenomenon in Field-Effect Transistors and the like which have a Silicon-On-Insulator (SOI) semiconductor layer structure is a result of inducing impact ionization (collision with atoms) near the isolation region. Accordingly, a carrier (p-channel type transistor electrons) is generated which flows in and stores (the floating substrate effect) in the channel region (body region). Consequently, the threshold voltage decreases and the drain current increases which is thought to be based on the “Kink effect” phenomenon (a parasitic phenomenon referred to as the “Kink effect” consisting of a threshold voltage shift). Corresponding to the Kink effect phenomenon when the absolute value of the drain current increases, the current value ratios of the module currents relative to the reference current in the current mirror circuit are no longer set according to the desired design values. Furthermore, the current values of the drive currents generated by the current generation supply circuit do not constitute the values corresponding to the load control signals and becomes impossible to operate the loads in the appropriate drive state. When such a current generation supply circuit is applied to the driver circuits of the display device, degradation of the display image quality will be incurred.

Therefore, the fifth embodiment of the specific configuration applicable to the reference voltage generation circuit and the current generation circuits in this embodiment comprises the same configuration as the current generation supply circuit in the above-mentioned first embodiment. In order to suppress the Kink effect mentioned above to the reference current transistor in the reference voltage generation circuit and the current generation circuits, as shown in FIG. 7B, transistors are applied having the so-called body terminal structure which are electrically connected to the channel region (body region) and the source region of the Field-Effect Transistors.

Accordingly, in this embodiment as shown in FIG. 8, a reference current transistor Tp11a which constitutes the reference voltage generation circuit 10E and the module current transistors Trl2a˜Trl5a, Tr22a˜Tr25a which constitute the module current generation circuits 21B in the current generation circuits ILB are composed of Thin-Filmp-channel type Field-Effect Transistors having the above-mentioned body terminal structure.

Based on the Thin-Film type Field-Effect Transistors having this body terminal structure, generation of the Kink effect phenomenon is suppressed. As shown by the dashed line in FIG. 7C, the voltage between source-drain in the specified voltage region reflects the saturation inclination with favorable drain currents acquired. The generation of the Kink effect phenomenon is suppressed because storage to the channel region is controlled and the decline in the threshold voltage of the Field-Effect Transistors is mitigated when the minority carrier (the Thin-Film type Field-Effect Transistor electrons) flows to the source region via the body terminal electrode and among the electron-hole pairs (known as exciton) generated near the boundary of the channel region and the drain region of Thin-Film Field-Effect Transistors which have a body terminal structure. When the Thin-Film type Field-Effect Transistors having such a body terminal structure are applied to reference current transistor and module current transistors of the current generation supply circuit, the drive currents IA having the appropriate current values corresponding to the load control signals are generable and each of the loads can be operated in the appropriate drive state. In the present invention current generation supply circuit, as for application with the driver circuits of the display device, enhancement in the display image quality can be promoted.

In this embodiment, even though the case where Thin-Film Field-Effect Transistors having a body terminal structure is applied to the reference current transistor and the module current transistors is explained, it is emphasized that this embodiment can be similarly applicable to other transistors which constitute the current generation supply circuit.

<The Sixth Embodiment of the Reference Voltage Generation Circuit and the Current Generation Circuits>

Next, the sixth embodiment of the specific configuration applicable to the reference voltage generation circuit and current generation circuits of the current generation supply circuit in this embodiment will be explained with reference to the drawings.

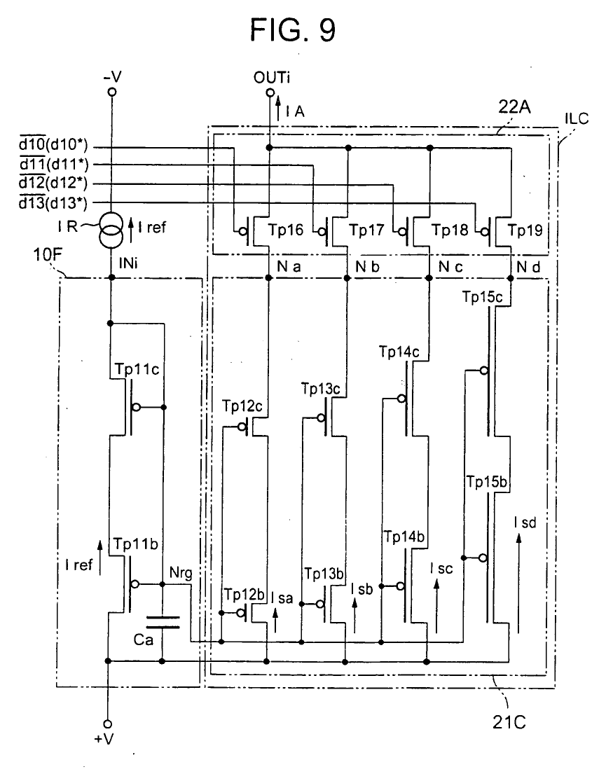

FIG. 9 is a circuit configuration diagram showing the sixth embodiment of the reference voltage generation circuit and the current generation circuits applicable to the current generation supply circuit related to this embodiment.

Here, concerning any configuration equivalent in the embodiments mentioned above, the same or equivalent nomenclature is appended and the explanation is simplified or omitted from the description.

Additionally, this embodiment has a circuit configuration corresponding to the current application method of the first embodiment of the current generation supply circuit mentioned above.

Furthermore, the selection switching circuits 22A in the current generation circuits ILC of this embodiment comprise the equivalent configuration as the first embodiment.

In the fifth embodiment mentioned above to suppress the influence of the Kink effect phenomenon, Thin-Film type Field-Effect Transistors are applied using transistors with a body terminal structure in the reference current transistor and each of the module current transistors. Also, the configuration in this sixth embodiment is similarly aimed at suppressing the influence of the Kink effect in the Thin-Film type Field-Effect Transistors. For that purpose, the reference current transistor which constitutes the reference voltage generation circuit and each of the module current transistors which constitute the module current generation circuits are made with a multi-gate structure (multi-gate transistors).

Specifically, as shown in FIG. 9, the reference current transistors which constitute the reference voltage generation circuit 10F in this embodiment comprise two p-channel type Field-Effect Transistors Tp11b and Tp11c by which each of the gate terminals are connected in common to contact Nrg along with the current path connected in series. Additionally, each of the module current transistors which constitute the module current generation circuits 21C in the current generation circuits ILC each comprise two p-channel type Field-Effect Transistors Tp12b and Tp12c, Tp13b and Tp13c, Tp14b and Tp14c, Tp15b and Tp15c by which the gate terminals are connected to in common to contact Nrg along with the current path connected in series.

Here, the sum total of the channel width of each of the module current transistors Tp12b and Tp12c, Tp13b and Tp13c, Tp14b and Tp14c, Tp15b and Tp15c is designed so that each other has a different ratio. For example, while assuming constant channel length in each of the module current transistors Tp12b and Tp12c, Tp13b and Tp13c, Tp14b and Tp14c, Tp15b and Tp15c, the sum total of each channel width ratio is designed to be set to W12:W13:W14:W15=1:2:4:8. Here, W12 shows the sum total of the channel width of the module current transistors Tp12b and Tp12c, W13 shows the sum total of the channel width of the module current transistors Tp13b and Tp13c, W14 shows the sum total of the channel width of the module current transistors Tp14b and Tp14c, and W15 shows the sum total of the channel width of the module current transistors Tp15b and Tp15c.

Accordingly, the current values of the module currents Isa˜Isd which flow in each of the module current transistors Tp12b and Tp12c, Tp13b and Tp13c, Tp14b and Tp14c, Tp15b and Tp15c, when the sum total of the channel widths of the reference current transistors Tp11a and Tp11b is set to W11, each other is set as Isa=(W12/W11)×Iref, Isb=(W13/W11)×Iref, Isc=(W14/W11)×Iref, Isd=(W15/W11)×Iref. That is, the current values between the module currents can be set as the ratios defined by 2ⁿ in the same manner as each of the module currents Isa˜Isd in the above-mentioned first embodiment in FIG. 2. Additionally, as in the case of the above-mentioned first embodiment, by selecting and integrating random module currents with the selection transistors Tp16˜Tp19 of the selection switching circuits 22A from each of the module currents Isa˜Isd, the drive currents IA having current values of 2ⁿ step are generated and the loads are supplied.

Here, this sixth embodiment applies the so-called multi-gate structure (The dual gate structure of two p-channel type Field-Effect Transistors in series connection like the circuit configuration shown in FIG. 9) where the channel structure is essentially divided by making a series connection with two Field-Effect Transistors in each other of the reference current transistors and the module current transistors. Accordingly, the voltage applied between the source-drain of each of the Field-Effect Transistors can be reduced from the case where such a multi-gate structure is not used, since the drive currents can be made to diminish the influence of the Kink effect phenomenon having the appropriate current values corresponding to the load control signals are generable. When applied to the driver circuits of the display device, each of the loads can be operated in the appropriate drive state and enhancement in the display image quality can be promoted.

In addition, as shown in FIG. 9, although a circuit constituted by a series connection of two p-channel type Field-Effect Transistors in each other of the reference current transistors and the module current transistors is explained, a series connection of two or more Field-Effect Transistors may also be employed.

Furthermore, in this embodiment, even though the circuit configuration which applies Field-Effect Transistors having a multi-gate structure in both the reference current transistors and the module current transistors is explained, the present invention is not limited to this. For example, the multi-gate structure mentioned above may be applied only to the side of the reference current transistors or the side of the module current transistors side corresponding to the current ratio rates of the module currents which flow in each of the module current transistors relative to the reference currents which flow in the reference current transistors. In summary, it is possible to apply a multi-gate structure only to the transistors which require high resistive pressure against the currents (reference currents, module currents) flowing in the current path. Also, depending on the required resistive pressure, the number of transistors in the series connection can be set according to the circumstances.

Further, in this embodiment, even though the case where the Field-Effect Transistors having a multi-gate structure is applied to the reference current transistors and the module current transistors is explained, it is emphasized that this embodiment can be similarly applicable to other transistors which constitute the current generation supply circuit.

<The Seventh Embodiment of the Reference Voltage Generation Circuit and the Current Generation Circuits>

Next, the seventh embodiment of the specific configuration applicable to the reference voltage generation circuit and current generation circuits of the current generation supply circuit in this embodiment will be explained with reference to the drawings.

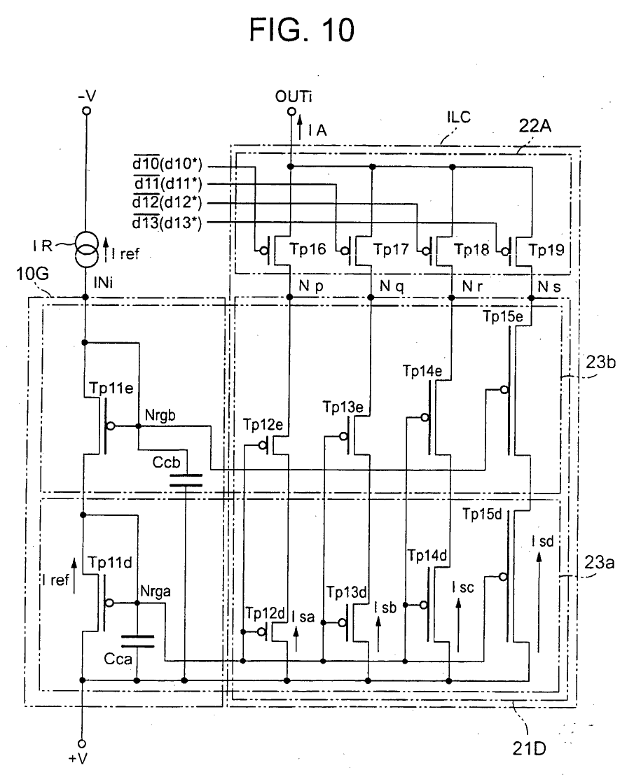

FIG. 10 is a circuit configuration diagram showing the seventh embodiment of the reference voltage generation circuit and the current generation circuits applicable to the current generation supply circuit related to this embodiment.

Here, concerning any configuration equivalent in the embodiments mentioned above, the same or equivalent nomenclature is appended and the explanation is simplified or omitted from the description.

Additionally, in this embodiment, although the circuit configuration corresponds to the current application method of the first embodiment of the current generation supply circuit mentioned above, the circuit configuration can also correspond to the current sink method in the second embodiment of the current generation supply circuit mentioned above.

Furthermore, the selection switching circuits 22A in the current generation circuits ILD of this embodiment comprise the equivalent configuration as the first embodiment.

Although the configuration in the seventh embodiment is equivalent to the case of the sixth embodiment mentioned above aimed at suppressing the influence of the Kink effect phenomenon in the Thin-Film type Field-Effect Transistors as well as employing a multi-gate structure in each of the reference current transistors which constitute the reference voltage generation circuit and the module current transistors which constitute the module current generation circuits, this embodiment is made having a cascade connection structure.

Specifically, the reference current transistors which constitute the reference voltage generation circuit 10G in this embodiment, as shown in FIG. 10, comprise an p-channel type Field-Effect Transistor Tp11d by which the gate terminal is connected to the contact Nrga and an p-channel type Field-Effect Transistor Tp11e by which the gate terminal is connected to the contact Nrgb along with the current path connected in series. A capacitor Cca is connected to connected to the contact Nrga between the high electric potential +V as well as a capacitor Ccb is connected to the contact Nrgb between the high electric potential +V. Furthermore, each of the module current transistors which constitute the module current generation circuits 21D each comprise two p-channel Field-Effect Transistors Tp12d and Tp12e, Tp13d and Tp13e, Tp14d and Tp14e, Tp15d and Tp15e by which the gate terminals are connected each other individually to the contacts Nrga, Nrgb along with the current path connected in series and have a multi-gate structure.

Further, in this embodiment, one of the p-channel Field-Effect Transistors Tp11d of the reference current transistors along with one of the p-channel Field-Effect Transistors Tp12d, Tp13d, Tp14d, Tp15d of the module current transistors constitute the first in a set of current mirror circuits 23a; and one of the p-channel Field-Effect Transistors Tp11e of the reference current transistors along with one of the p-channel Field-Effect Transistors Tp12e, Tp13e, Tp14e, Tp15e of the module current transistors constitute the second in a set of a current mirror circuits 23b. This set of current mirror circuits 23a, 23b is constructed in a cascade arrangement (cascade connection).

Also in this seventh embodiment and equivalent to the case of the sixth embodiment shown in the above-mentioned FIG. 9, the sum total of the channel width of each of the module current transistors Tp12d and Tp12e, Tp13d and Tp13e, Tp14d and Tp14e, Tp15d and Tp15e which constitute the module current generation circuits 21D is designed so that each other has a different ratio. The module currents Isa˜Isd which flow in the current path of each of the module current transistors Tp12d and Tp12e, Tp13d and Tp13e, Tp14d and Tp14e, Tp15d and Tp15e are set so that each other has a different current value ratio relative to the reference current Iref. Moreover, equivalent to the first case embodiment mentioned above, by selecting and integrating random module currents with the selection transistors Tp16˜Tp19 of the selection switching circuits 22A from each of the module currents Isa˜Isd, the drive currents IA (gradation currents) which have current values of 2ⁿ step are generated and constituted so that the loads can be supplied.

Accordingly, also in the configuration of this seventh embodiment equivalent to the sixth embodiment mentioned above, the voltage applied between the source-drain of each of the Field-Effect Transistors is diminished and the influence of the Kink effect phenomenon can be suppressed. Thus, the drive currents having the appropriate current values corresponding to the load control signals are generable and each of the loads can be operated in the appropriate drive state. When applied to the driver circuits of the display device, enhancement of the display image quality can be promoted.

In addition, although in this embodiment the configuration is designed with a set of the current mirror circuits 23a, 23b in a cascade arrangement, this invention is not restricted to this and may be constructed with a cascade arrangement of more than one sets of a plurality of current mirror circuits.

<The Eighth Embodiment Reference Voltage Generation Circuit and the Current Generation Circuits>

Next, the eighth embodiment of the specific configuration applicable to the reference voltage generation circuit and current generation circuits of the current generation supply circuit in this embodiment will be explained with reference to the drawings.

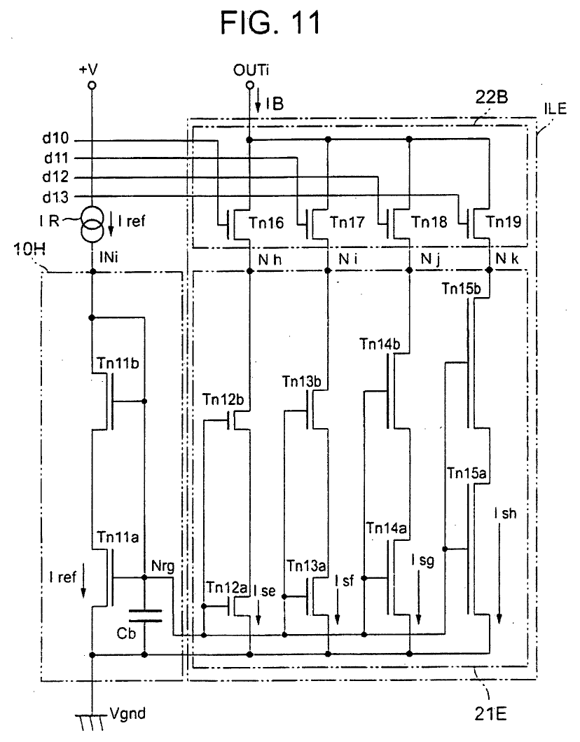

FIG. 11 is a circuit configuration diagram showing the eighth embodiment of the reference voltage generation circuit and the current generation circuits applicable to the current generation supply circuit related to this embodiment.

Here, concerning any configuration equivalent in the embodiments mentioned above, the same or equivalent nomenclature is appended and the explanation is simplified or omitted from the description.

This eighth embodiment has a circuit configuration corresponding to the current application method in the second embodiment of the current generation supply circuit mentioned above.

Furthermore, the selection switching circuits 22B in the current generation circuits ILE of this embodiment comprise the equivalent configuration as the second embodiment.

Specifically, the reference current transistors which constitute the reference voltage generation circuit 10G in this embodiment, as shown in FIG. 11, comprise two n-channel type Field-Effect Transistors Tn11a and Tn11b by which the gate terminals are connected to the contact Nrg in common along with the current path connected in series. Furthermore, the module current transistors which constitute the module current generation circuits 21E in the current generation circuits ILE each comprise two n-channel type Field-Effect Transistors Tn12a and Tn12b, Tn13a and Tn13b, Tn14a and Tn14b, Tn15a and Tn15b by which the gate terminals are connected each other to the contact Nrg along with the current patch connected in series.

Here, also in this eighth embodiment and equivalent to the configuration the above-mentioned FIG. 9, the sum total of the channel width of each of the module current transistors Tn12a and Tn12b, Tn13a and Tn13b, Tn14a and Tn14b, Tn15a and Tn15b which constitute the module current generation circuits 21E is designed so that each other has a different ratio. The module currents Ise˜Ish which flow in the current path of each of the module current transistors Tn12a and Tn12b, Tn13a and Tn13b, Tn14a and Tn14b, Tn15a and Tn15b are set so that each other has a different current value ratio relative to the reference current Iref. Moreover, equivalent to the first case mentioned above, by selecting and integrating random module currents with the selection transistors Tn16˜Tn19 of the selection switching circuits 22B from each of the module currents Ise˜Ish, the drive currents IB (gradation currents) which have current values of 2ⁿ step are generated and constituted so that the loads are supplied.

In this eighth embodiment, when each of the reference current transistors and the module current transistors has a configuration which applies a multi-gate structure like the configuration in the above-mentioned FIG. 9, the voltage applied between the source-drain of each of the Field-Effect Transistors is diminished and the influence of the Kink effect phenomenon can be suppressed. Thus, the drive currents having the appropriate current values corresponding to the load control signals are generable and each of the loads can be operated in the appropriate drive state. When applied to the driver circuits of the display device, enhancement of the display image quality can be promoted.

(Example Configuration of the Constant Current Generation Source)

Next, the first embodiment of the specific configuration applicable to the constant current generation source of the current generation supply circuit will be explained with reference to the drawings.

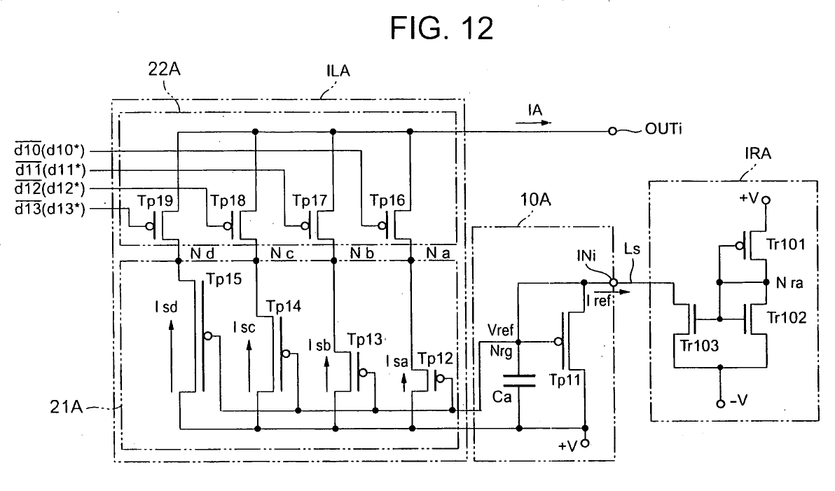

FIG. 12 is a circuit configuration diagram showing the first embodiment applicable to the constant current generation source of the current generation supply circuit related to this embodiment.

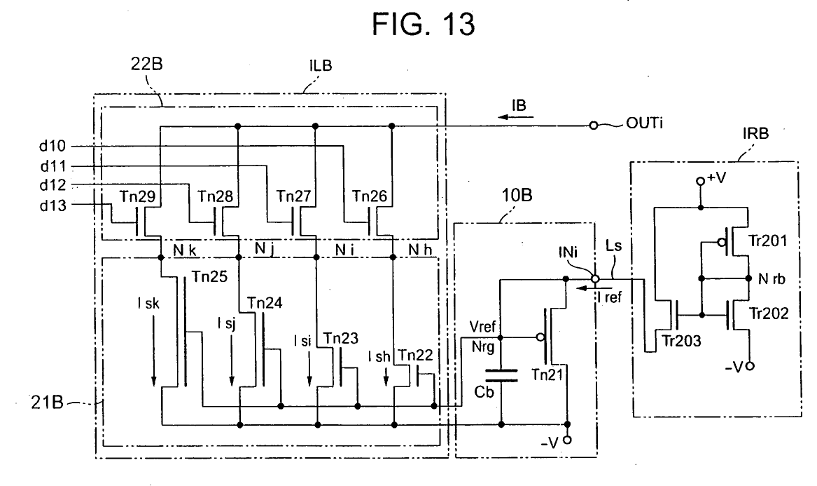

FIG. 13 is a circuit configuration diagram showing a second embodiment applicable to the constant current generation source of the current generation supply circuit related to this embodiment.

Here, the constant current generation source IRA shown in FIG. 12 corresponds to the configuration of the first embodiment of the above-mentioned current generation supply circuit and the constant current generation source IRB shown in FIG. 13 corresponds to the configuration of the second embodiment of the above-mentioned current generation supply circuit. Accordingly, the reference voltage generation circuit 10A and the current generation circuits ILA which are shown in FIG. 12, for example, comprise the configuration equivalent to the structure in the first embodiment of the reference voltage generation circuit and current generation circuits shown in the above-mentioned FIG. 2. The current generation circuits ILA comprise the current application method in which the current polarity is set so that the drive currents IA generated will flow to the loads side in relation to the loads connected to the current output terminal OUTi. Furthermore, the reference voltage generation circuit 10B and the current generation circuits ILB which are shown in FIG. 13, for example, comprise the configuration equivalent of the second embodiment reference voltage generation circuit and current generation circuits shown in the above-mentioned FIG. 4. The current generation circuits ILB comprise the current sink method in which the current polarity is set so that the drive currents IB generated will be drawn in the current output terminal OUTi from the loads side in relation to the loads connected to the current output terminal OUTi.

In addition, the configuration of the reference voltage generation circuit and the current generation circuits as shown in FIG. 12 and FIG. 13 only illustrate one example. For example, the reference current in the reference voltage generation circuit in each embodiment of the above-mentioned current generation supply circuits can be applied.

Also, the configuration of the constant current generation source IRA shown in FIG. 12 is the reference current Iref to the reference voltage generation circuit 10A as shown in FIG. 12 which comprises a configuration which flows in the direction drawn to the constant current generation source IRA side from the reference voltage generation circuit 10A. Further, the configuration of the constant current generation source IRB shown in FIG. 13 is the reference current Iref to the reference voltage generation circuit 10B as shown in FIG. 13 which comprises a configuration which flows in the direction passed to the reference current Iref to the reference voltage generation circuit 10B. This embodiment has the configuration in which the constant current generation sources IRA and IRB that generate the reference current are made into one unit on the same substrate as the current generation supply circuits ILA and ILB.

Accordingly, the constant current generation source IRA as shown in FIG. 12, specifically has a configuration comprising a p-channel type transistor Tr101, an n-channel type transistor Tr12 and an n-channel type transistor Tr13. The p-channel type transistor Tr101 gate terminal is connected to the contact Nra along with the current path (source-drain terminals) connected between the high electric potential +V. The n-channel type transistor Tr12 gate terminal is connected to Nra along with the current path connected between contact Nra and the low electric potential −V. The n-channel type transistor Tr13 gate terminal is connected to the gate terminal (contact Nra) of the n-channel type transistor Tr12 along with the current path connected between the current input contact INi and the low electric potential −V which supplies the reference current Iref to the reference voltage generation circuit 10A via the reference current supply line Ls. In the constant current generation source IRA which has such a configuration, the current which has a current value of a predetermined current ratio flows in the current path of the n-channel type transistor Tr13 by means of the current mirror circuit comprised of the n-channel type transistors Tr12 and Tr13, based on the current which regularly flows through the current path of the p-channel type transistor Tr101 and the n-channel transistor type Tr12 directly connected in between the predetermined high electric potential +V and the low electric potential −V. The reference voltage generation circuit 10A is supplied as the reference current Iref via the reference current supply line Ls and the current input contact INi. Here, the reference current Iref flows in the direction toward the constant current generation source IRA from the voltage reference generation circuit 10A side.

Additionally, the constant current generation source IRB as shown in FIG. 13, specifically has a configuration comprising a p-channel type transistor Tr201, an n-channel type transistor Tr202 and an n-channel type transistor Tr203. The p-channel type Tr201 gate terminal is connected to the contact Nrb along with the current path (source-drain terminals) connected between the high electric potential +V and the contact Nrb. The n-channel type transistor Tr202 gate terminal is connected to the contact Nrb along with the current path connected between the contract Nrb and the low electric potential −V. The n-channel type transistor Tr203 gate terminal is connected to the gate terminal (contact Nrb) of the n-channel type transistor Tr202 along with the current path connected between the current input contact INi and the high electric potential +V which supplies the reference current Iref to the reference voltage generation circuit 10B via the reference current supply line Ls. In the constant current generation source IRB which has such a configuration, the current which has a current value of a predetermined current ratio flows in the current path of the n-channel type transistor Tr203 by means of the current mirror circuit comprised of the n-channel type transistors Tr202 and Tr203, based on the current which regularly flows through the current path of the p-channel type transistor Tr201 and the n-channel type transistor Tr202 as the first embodiment mentioned above. The reference voltage generation circuit 10B is supplied as the reference current Iref via the reference current supply line Ls and the current input contact INi. Here, the reference current Iref flows in the direction toward the reference voltage generation circuit 10B from the constant current generation source IRB side.

Therefore, in the configurations of the embodiments mentioned above, the constant current generation sources IRA, IRB for generating and supplying the reference current Iref have a configuration made into one unit on the same substrate as the current generation supply circuit. Therefore, as the current generation supply circuit and the constant current generation source are arranged separately but on the same substrate, it is not necessary to connect each other of these circuits with hardwiring and the like. Thus, the manufacturing process can be simplified; the circuit dimensions scaled down and product cost reduction can be promoted. Additionally, as hardwiring is not needed for each other circuit, there will be negligible interfusion of noise to the reference current via the reference current supply line and the like. Consequently, the influence of noise to the drive currents supplied to the loads can be suppressed and the drive state of the loads can be maintained stable.

Furthermore, the other embodiments of specific configurations applicable to the constant current generation source of the current generation supply circuit in this embodiment will be explained.

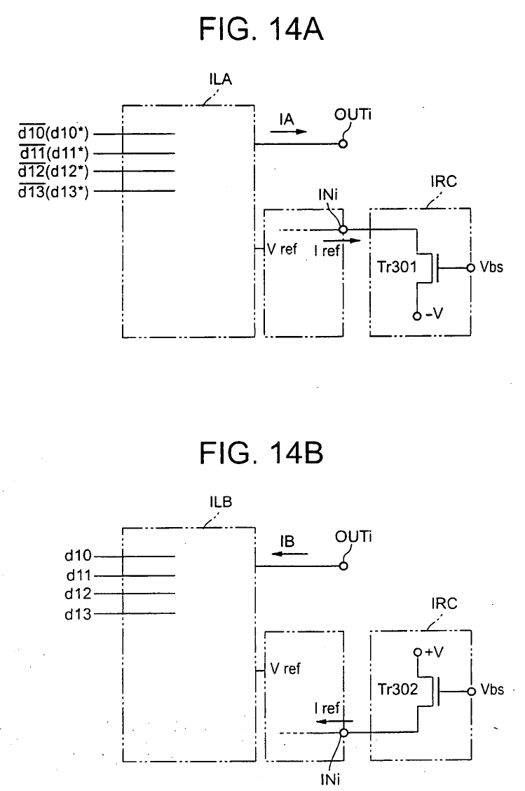

FIGS. 14A and 14B are the circuit configuration diagrams showing other embodiments applicable to the constant current generation source of the current generation supply circuit related to this embodiment.

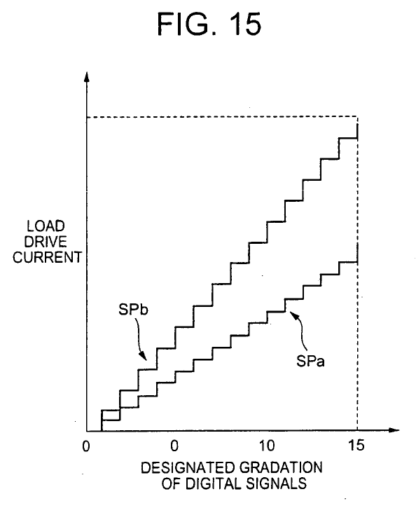

FIG. 15 is a representative diagram showing an example of the current characteristic of the drive currents in the current generation supply circuit related to this embodiment.

Here, since this configuration except for the constant current generation source IRC in FIGS. 14A and 14B has the configuration equivalent to the relationship in each embodiment of the current generation supply circuit mentioned above, these references are omitted from the description.

The configuration of the constant current generation source IRC as shown in FIG. 14A, which corresponds to the current application method in the first embodiment of the above-mentioned current generation supply circuit has a configuration comprising an n-channel type transistor Tr301. The n-channel type transistor Tr301 in which the predetermined control voltage Vbs (bias voltage; control signals) is applied to the gate terminal along with the current path connected between the current input contact INi and the low electric potential −V for supplying reference current to the reference voltage generation circuit 10A.

Furthermore, the configuration of the constant current generation source IRC shown in FIG. 14B, which corresponds to the current sink method in the second embodiment of the above-mentioned current generation supply circuit has a configuration comprising an n-channel type transistor Tr302 in which the predetermined voltage Vbs is applied to the gate terminal along with the current path connected between the high electric potential +V and the current input contact INi for supplying the reference current Iref to the reference voltage generation circuit 10B.

According to the constant current generation source IRC which has such a configuration by applying the control voltage Vbs which has random voltage value to the gate terminals of the n-channel type transistors Tr301, Tr302, the continuity condition (switch “ON/OFF” operations) of the n-channel type transistors Tr301, Tr302 is controlled; alteration control of the current value that flows through the current path of the n-channel type transistors Tr301, Tr302 is executed; and the reference current Iref is set as the random current value.

Therefore, in the current generation supply circuit comprising the constant current generation source IRC in this embodiment, for example, corresponding to the voltage value of the control voltage Vbs by means of the control signals supplied to the constant current generation source IRC from an external control section (controller) and the like, the alteration setting of the current value of the reference current Iref generated by the constant current source IRC can be performed with ease and the alteration setting of the voltage value of the reference voltage Vref generated by the reference voltage generation circuit can be accomplished with a lack of difficulty. In view of that, corresponding to the voltage value of the control voltage Vbs, the continuity condition (switch “ON/OFF” operations) of each of the module current transistors is controlled and the alteration control of the current value relationship of the drive currents IA, IB (drive currents) responsive to the inputted load control signals (digital signals d0˜d3) can be performed relatively easily.

Therefore, for example as shown as SPa and SPb in FIG. 15, by performing the suitable alteration setting of the voltage value of the control voltage Vbs responsive to the control signals, the alteration setting of the current characteristic of the drive currents relative to the designated gradation by means of the load control signals can be randomly performed and be made to operate in the desired drive characteristic of the loads. When such a current generation supply circuit is applied to the driver circuits of the display device, for example, the control for performing alteration control of the display luminosity characteristic can be accomplished relative easily corresponding to the status of use.

In addition, as shown in FIG. 15, although the current characteristic SPa and SPb are described when the voltage value of the control voltage Vbs is changed in two steps (two varieties), the present invention is not limited to this. For example, by altering continuously the voltage value of the control voltage Vbs, random setting changes (alterations) of the current characteristic in the current generation supply circuit can be accomplished single step and the loads can be operated in an random drive characteristic.

(Example Configuration of the Signal Holding Circuits)

Next, one embodiment of the specific configuration applicable to the signal holding circuits of the current generation supply circuit in this embodiment will be explained with reference to the drawings.

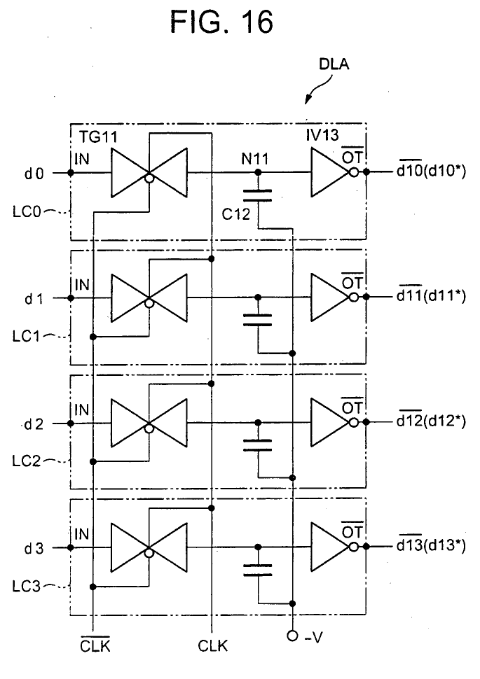

FIG. 16 is a circuit configuration diagram showing one embodiment applicable to the signal holding circuits of the current generation supply circuit related to this embodiment.

Each of the latch circuits LC0˜LC3 in the signal holding circuits DLA in this embodiment, as shown in FIG. 16, has a configuration comprising a transfer gate TG11, a condenser C12 and an inverter IV13. The transfer gate TG11 (signal input control circuit) is for taking in each of the digital signals d0˜d3 inputted via the input contact IN at predetermined timing based on the timing control signals CLK, CLK*. The condenser C12 (charge storage circuit) is for storing electrical charges based on each of the signal levels of the digital signals d0˜d3 taken in by the transfer gate TG11 and holding the electric potential at the output contact (contact N11) of the transfer gate TG11. The inverter IV13 (output level setting circuit) is for setting a high-level or a low-level of the inverted signal levels which are outputted as the output signals d10*˜d13* (inverted output signals) via the inverted output terminals OT*. Additionally, the nearside of the condenser C12 provided in each of the latch circuits LC0˜LC3 is connected to the low electric potential −V. Also, the electric potential of the voltage connected to the opposite end side of the condenser C12 is negative potential. Accordingly, it is only necessary to have an random constant voltage. For example, correct electric potential having random constant voltage is sufficient.

In the latch circuits LC0˜LC3 which have such a configuration, each of the digital signals having the high-level or the low-level are taken in via the transfer gate TG11 and held as the voltage component at the condenser C12. Here, as for the electrical charge generally stored in the condenser C12, the electric potential decreases and discharges as leakage current with the passage of time. Also, the inverter IV13 is established in the latter stage (output stage) at the contact N11 where the electric potential is generated based on the voltage component held in the condenser C12. If the electric potential of the contact N11 relative to the predetermined threshold of the inverter IV13 has the high-level exceeding the threshold or the signal levels defined as the low-level are less than the threshold in the reversal processing of that inverter, the output signals d10*˜d13* as the high-level or the low-level are outputted to the current generation circuits ILA having predetermined signal levels by the inverter IV13.

Therefore, for example, after the signal levels of the voltage component held in the condenser are set to the high-level, if it is when performing drive control in which the signal levels of the voltage component are updated and subsequent digital signals are inputted in the period until the signal levels threshold declines, since the output signals outputted to the current generation circuits from the data latch sections according to this embodiment are outputted as high-level or low-level digital signals having predetermined signal levels, the current generation circuits can be operated favorably with these digital signals (output signals). Thus, the latch circuits related to this embodiment have a dynamic type circuit configuration and can be constituted with a relatively small number of elements. Specifically, in that case, even though a static type circuit configuration combined with a plurality of the transfer gates and inverters as other circuits applicable to such latch circuits is known, at least ten transistors per latch circuit are needed. As compared with this, the latch circuits LC0˜LC3 shown in FIG. 16, can be constructed with only four transistors and the one condenser which constitute one transfer gate and the inverter. Therefore, enlargement of the circuit area of the signal holding circuits can be controlled so that the number of digital signal bits inputted increases.

As shown in FIG. 16, although an example of the circuit configuration in the case of outputting the output signals d10*˜d13* which have signal levels of reversed signal polarity relative to the digital signals d0˜d3 by means of the latch circuits LC0˜LC3 is explained, if in the case when the output signals d10˜d13 being output have the same polarity as the digital signals d0˜d3 via the non-inverted output terminals OT as shown in FIG. 1, an additional inverter can be further connected to the latter stage of the inverter IV13 shown in FIG. 16. Thus, a circuit configuration in which the signal polarity is reversed twice and outputs can be applied.

Next, other embodiments of the specific configuration applicable to the signal holding circuits of the current generation supply circuit in this embodiment will be explained.

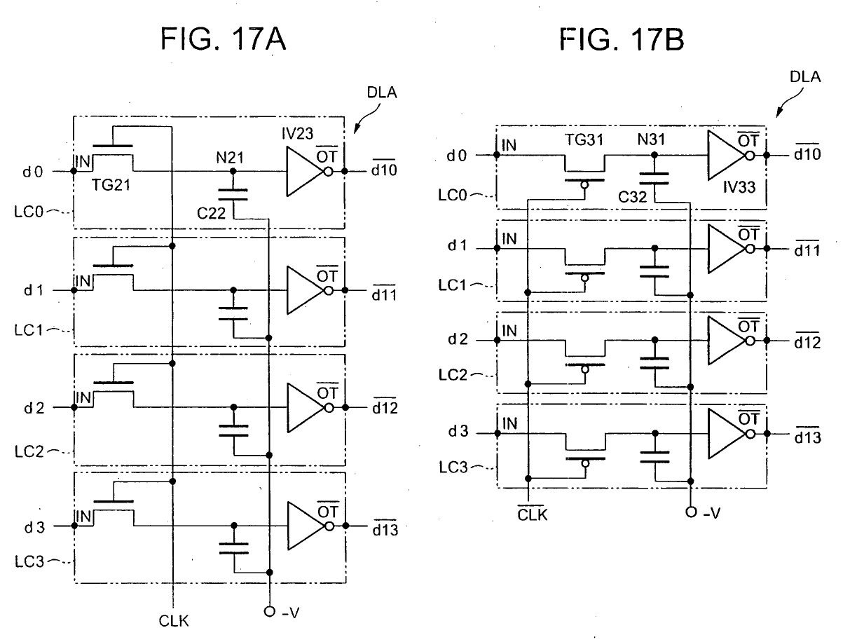

FIGS. 17A and 17B are circuit configuration diagrams showing other embodiments applicable to the signal holding circuits of the current generation supply circuit related to this embodiment.

Here, concerning any configuration equivalent in the embodiments mentioned above, the same or equivalent nomenclature is appended and the explanation is simplified or omitted from the description.

Referring to FIG. 17A, each of the latch circuits LC0˜LC3 of the signal holding circuits DLA in this embodiment are substituted for the transfer gate TG11 in the latch circuits shown in FIG. 16 and have a configuration in which each comprises a single n-channel type Field-Effect Transistor TG21 with the timing control signals CLK (non-inverted clock signals) applied to the gate terminals.

Additionally, as shown in FIG. 17B, in substituting the transfer gate TG11, it is also possible to make a configuration in which each comprises a single p-channel type Field-Effect Transistor TG31 with the timing control signals CLK* (inverted clock signals) applied to the gate terminals. The condenser C22, C32 and the inverter IV23, IV33 and the like are constituted equivalent to the configuration shown in FIG. 16.

According to these configurations, a still small number of elements can constitute the signal holding circuits DLA from the example configuration shown in FIG. 16.

<The First Embodiment of the Display Device>

Next, the first embodiment of the display device which can be applied to the current generation supply circuit of the above-mentioned embodiments to the driver circuits (data drivers) will be explained.

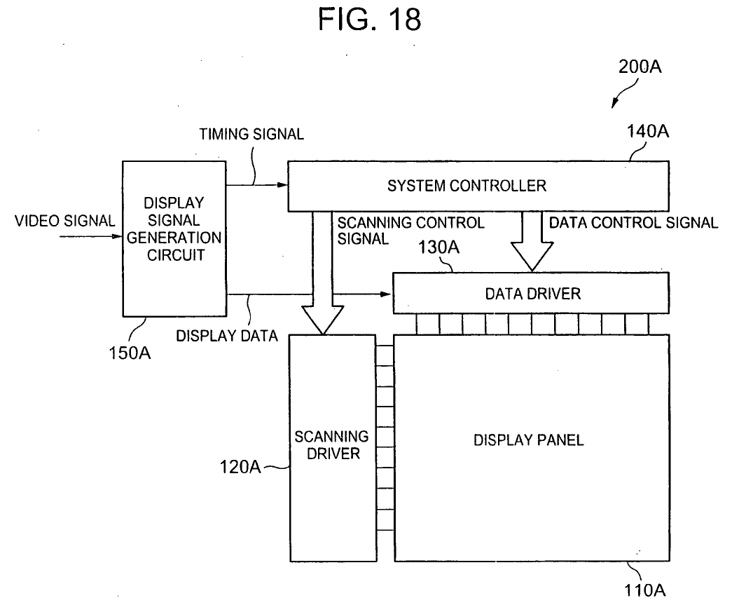

FIG. 18 is an outline block diagram showing the first embodiment of the display device applicable to the current generation supply circuit related to this embodiment.

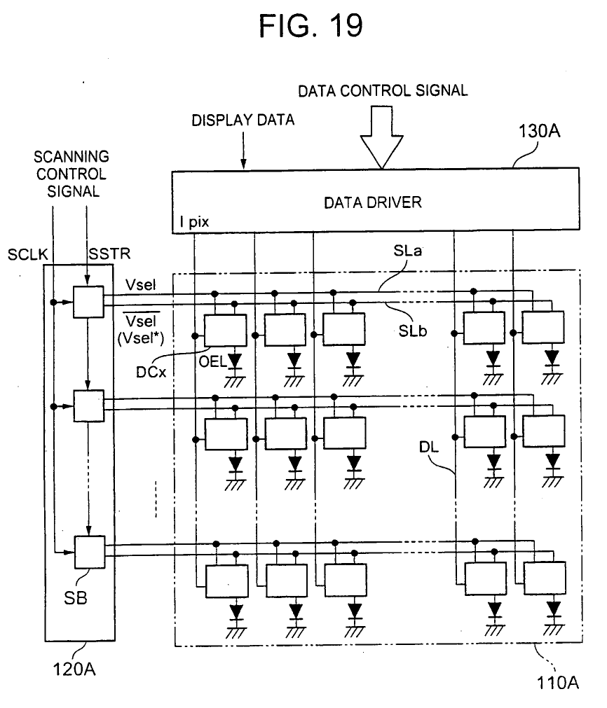

FIG. 19 is an outline configuration diagram showing an example configuration applicable to the display panel in the display device related to this embodiment.

Here, the configuration comprising display pixels related to an active matrix display panel. Also, the driver circuits (data drivers) in this embodiment and the pixel driver circuits in the display pixels comprise a configuration corresponding to the current application method in the first embodiment of the current generation supply circuit mentioned above.

Referring to FIG. 18 and FIG. 19, the display device 200A related to this embodiment, briefly, comprises a display panel 110A, a scanning driver 120A (scanning driver circuit), a data driver 130A (signal driver circuit), a system controller 140A and a display signal generation circuit 150A. The display panel 110A is configured with a plurality of display pixels (loads) arranged in a matrix form. The scanning driver 120A (scanning driver circuit) is connected in common to the scanning lines (scan lines) for every display pixel group arranged in the line writing direction (rows) of the display panel 110A. The data driver (signal driver circuit) is connected in common to the data lines DL (signal lines) for every display pixel group in column order of the display panel 110A. The system controller 140A generates and outputs the various control signals which control the operating state of the scanning driver 120A and the data driver 130A. The display signal generation circuit 150A generates the display data, the timing signals and the like based on the video signals supplied from the exterior of the display device 200A.

Hereinafter, each of the above-mentioned configurations will be explain in detail.

(Display Panel)

The display panel 110A, as specifically shown in FIG. 19, has a configuration comprising the data lines DL arranged to intersect at perpendicularly with the scanning lines SLa and SLb and a plurality of display pixels arranged near the intersecting points of each of these lines that intersect perpendicularly.

The display pixels, for example, comprise the pixel driver circuits DCx and the light emitting devices OEL. The pixel driver circuits DCx control the write-in operation of the gradation currents Ipix and the light generation operation in each of the display pixels based on the scanning signals Vsel applied via the scanning lines SLa and the scanning signals Vsel* (The polarity reversal signals of the scanning signals Vsel which are applied to the scanning lines SLa, and denoted as “Vsel*” in the description.) applied via the scanning lines SLb from the scanning driver 120A, as well as the gradation currents Ipix (equivalent to the drive currents IA mentioned above) supplied via the data lines DL from the data driver 130A. The light emitting devices OEL, for example, are composed from organic EL devices by which the light generation luminosity (also known as brightness or intensity) is controlled corresponding to the current values of the light generation luminosity drive currents supplied from the pixel driver circuits DCx. In this embodiment, although the case where the organic EL devices OEL are applied as the current control type light emitting devices, supplementary light emitting elements such as light emitting diodes and the like may be applied.

Here, the pixel driver circuits DCx have the functions for taking in the gradation currents Ipix corresponding to the display data in a selection state and holding them as the voltage level; for supplying the light generation drive currents to the organic EL devices OEL based on the above-mention voltage level held in a non-selection state; and for maintaining operation to emit light by predetermined luminosity gradation. Further explanation of a possible example circuit arrangement applicable to the pixel driver circuits DCx will be described later.

(Scanning Driver)

The scanning driver 120A sets the selection state for every line of the display pixel groups by sequentially applying the selection levels of the scanning signals Vsel (for example, high-level) and Vsel* (for example, low-level) to each of the scanning lines SLa and SLb at predetermined timing based on the scanning control signals supplied from the system controller 140A; supplies the gradation currents Ipix to each of the data lines DL based on the display data from the data driver 130A; and controls the write-in in each of the display pixels.

Specifically, the scanning driver 120A shown in FIG. 19 comprises a shift block SB composed of a shift register and a buffer with a plurality of steps corresponding to every scanning line SLa, SLb of each line based on scanning control signals (scanning start signals SSTR, scanning clock signals SLCK, and the like) supplied from the system controller 140A. The shift signals are sequentially outputted while shifting from the upper part to the lower part of the display panel 110A by the shift register and applied to each of the scanning lines SLa as the scanning signals Vsel having predetermined voltage levels (selection level) via the buffer, the voltage levels of the scanning signals Vsel are inverted and applied to each of the scanning lines SLb as the scanning signals Vsel*.

(Data Driver)

The data driver 130A takes in and holds the display data comprising a plurality of digital signal bits supplied from the display signal generation circuit 150A based on data control signals (sampling start signals STR, shift clock signals SFC, and the like described later) supplied from the system controller 140A; generates the gradation currents Ipix having current values corresponding to the display data; and controls the supply of the gradation currents Ipix to each of the data lines DL in parallel simultaneously.

Thus, in the data driver 130A according to this embodiment, the configuration and functions of each embodiment of the first embodiment of the current generation supply circuit mentioned above are favorably applicable. A detailed circuit arrangement example of the data driver 130A and its drive control operations will be described later.

(System Controller)

The system controller 140A at least interacts with to each of the scanning driver 120A and the data driver 130A based on timing signals supplied from the display signal generation circuit 150A described later. By generating and outputting scanning control signals (the scanning start signals SSTR, the scanning clock signals SLCK, and the like mentioned above) and data control signals (the sampling start signals STR, the shift clock signals SFC, and the like mentioned above), each driver operates at predetermined timing. The scanning signals Vsel, Vsel* and the gradation currents Ipix are made to output to the display panel 110A; execute continuously predetermined drive control operations in the pixel driver circuits DCx; and implement control to display predetermined image information to the display panel 110A based on the video signals.

(Display Signal Generation Circuit)

The display signal generation circuit 150A, for example, extracts the luminosity gradation signal component from the video signals supplied from the exterior of the display device 200A; and supplies the luminosity gradation signal component for every one line period of the display panel 110A as display data comprising a plurality of digital signal bits.

Here, when the above-mentioned video signals contain the timing component which specifies the display timing of the image information, such as a television broadcasting signal (composite video signal), the display signal generation circuit 150A has a function which extracts the timing signal component supplied to the system controller 140A and another function which extracts the above-mentioned luminosity gradation signal component. In this case, the above-mentioned system controller 140A generates the above-mentioned scanning control signals and data control signals which are respectively supplied to the scanning driver 120A or data driver 130A based on timing signals supplied from the display signal generation circuit 150A.

In addition, although this embodiment has a mounted structure with periphery circuits, such as the driver, controller and the like, attached to the periphery of the display panel 110A, the present invention is not limited to this. For example, at least the display panel 110A, the scanning driver 120A and the data driver 130A may be formed on a single substrate. The scanning driver 120A and the data driver 130A or only the data driver 130A as described later may be set separately from the display panel 110A and connected electrically.

(Configuration of the Display Pixels)

Next, one embodiment of the pixel driver circuits applicable to each of the display pixels in the display device mentioned above will be explained.

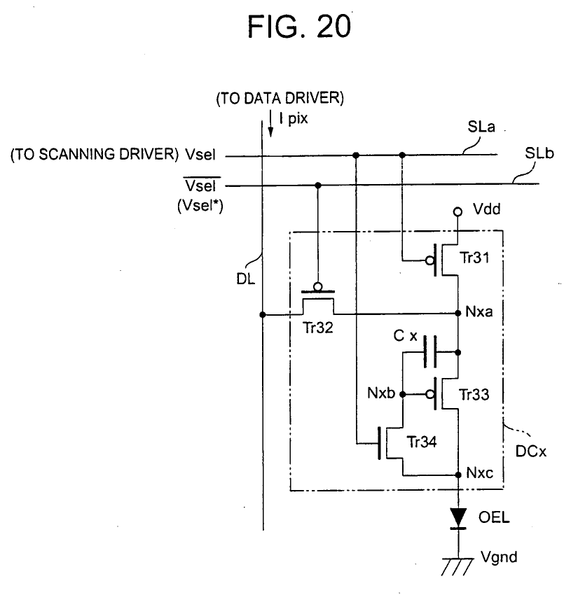

FIG. 20 is a circuit configuration diagram showing one embodiment applicable to the pixel driver circuits of the display pixels in the display device related to the embodiments.

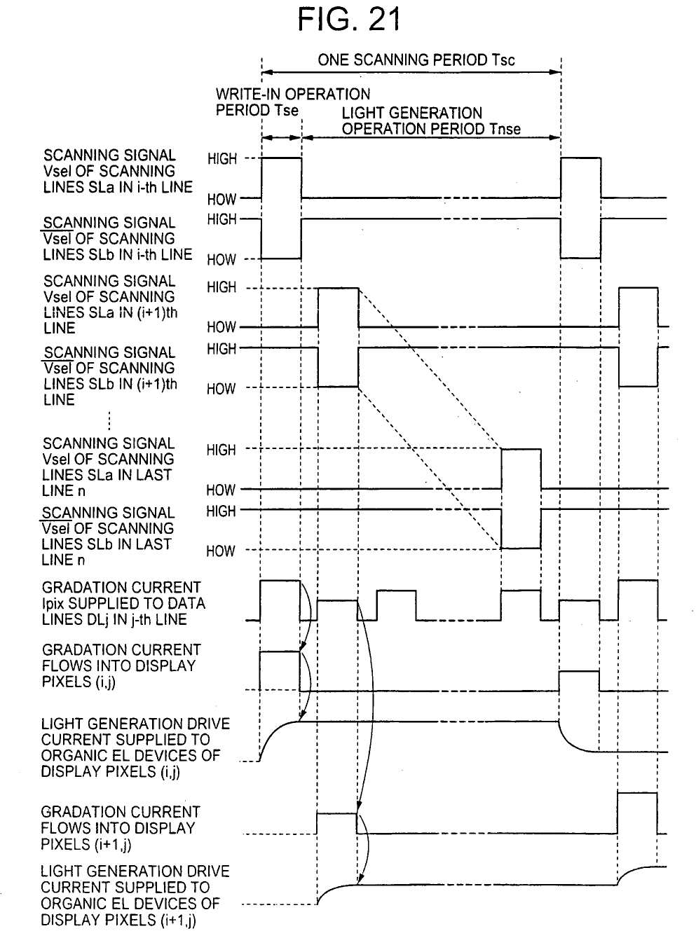

FIG. 21 is a timing chart showing an example of the control operations in the pixel driver circuits related to the embodiments.

In addition, the pixel driver circuits shown here represent only one example applicable of the display device according to the present invention. It is emphasized that other circuit configurations having equivalent operational functions may be applied.

Referring to FIG. 20, the structure of the pixel driver circuit DCx in this embodiment comprises a configuration corresponding to the current application method comprising a p-channel type transistor Tr31, a p-channel type transistor Tr32, a p-channel type transistor Tr33, an n-channel type transistor Tr34, and a condenser Cx. The p-channel type transistor Tr31 source-drain terminals are connected each other to the voltage contact Nxa and the contact Vdd along with the gate terminal connected to the scanning lines SLa near the intersecting points of the scanning lines SLa, SLb and the data lines DL. The p-channel type transistor Tr32 source-drain terminals are connected each other to contact Nxa and the data lines DL along with the gate terminal connected to the scanning lines SLb. The p-channel type transistor Tr33 source-drain terminals are connected each other to the contact Nxc and the contact Nxa along with the gate terminal connected the contact Nxb. The n-channel type transistor Tr34 source-drain terminals are connected each other to the contact Nxc and contact Nxb along with the gate terminal connected to the scanning lines SLa. The condenser Cx is connected between the contact Nxa and the contact Nxb. Here, the voltage contact Vdd, for example, is connected to the high electric potential via the voltage lines (not shown) and constant high potential voltage is applied continually or at predetermined timing.

Furthermore, the light emitting devices OEL (organic EL devices), by which the light generation luminosity is controlled by the light generation drive currents supplied from the pixel driver circuits DCx, have a configuration in which the anode terminal is connected to the contact Nxc of the above-mentioned pixel driver circuits DCx and the cathode terminal is connected to the low electric potential Vgnd (for example, ground potential).

Also, the condenser Cx is a parasitic capacitor arranged between the gate-source of the transistor Tr33 and a second capacitative element can be added separately further between the gate-source in addition to the parasitic capacitor.

The drive control operations of the pixel driver circuits DCx which have such a configuration as shown in FIG. 21, first, while applying the high-level (selection level) scanning signals Vsel to the scanning lines SLa, performs one cycle of one scanning period Tsc which displays the desired image information for one screen of the display panel 110A in a write-in operation period Tse within that one scanning period Tsc. While applying the low-level scanning signals Vsel* to the scanning lines SLb, the display pixel groups connected to the scanning lines SLa are selected and the gradation currents Ipix corresponding to the display data d0˜d3 supplied from the data driver 130A are supplied to the data lines DL. Here, as the gradation currents Ipix, the current of positive polarity is supplied and set so that the current will flow properly in direction of the pixel driver circuits DCx via the data lines DL from the data driver 130A side.

Accordingly, as the transistors Tr32 and Tr34 which constitute the pixel driver circuits DCx perform an “ON” operation, the transistor Tr31 performs an “OFF” operation and positive electric potential corresponding to the gradation currents Ipix supplied to the data lines DL is applied to the contact Nxa. Also, between the contacts Nxb and the contact Nxc connect and between the gate-drain of the transistor Tr33 is controlled by the electric potential. Hereby, as the transistor Tr33 operating in the saturation region performs an “ON” operation, an electric potential difference occurs on both sides (between contact Nxa and contact Nxb) of the condenser Cx corresponding to the gradation currents Ipix. While the electrical charge corresponding to this electric potential difference is stored (charge) and held as the voltage component, the light generation drive currents corresponding to the gradations currents Ipix flow into the light emitting devices OEL (organic EL devices) and the light generation operation of the organic EL devices OEL commences.

Next, in the light generation operation period Tnse as the low-level (non-selection level) scanning signals Vsel are applied to the scanning lines SLa and the high level scanning signals Vsel* are applied to the scanning lines SLb, supply of the gradation currents Ipix are block out. Accordingly, the condenser Cx holds the electrical charge stored in the write-in operation mentioned above by the transistors Tr32 and Tr34 which perform an “OFF” operation and electrically block out between the data lines DL and the contact Nxa together with between the contact Nxb and the contact Nxc.

Here, the write-in operation period Tse established for every line is set so that a time overlap does not occur with each other. The combined period of the write-in operation period Tse and the light generation operation period Tnse is equivalent to the scanning period Tsc (Tsc=Tse+Tnse).

Thus, when the condenser Cx holds the charge voltage at the time of the write-in operation, the electric potential difference between the contact Nxa and the contact Nxb (between the gate-source of the transistor Tr33) will be held and the transistor Tr33 maintains an “ON” operation. Consequently, by applying the above-mentioned scanning signals Vsel (low-level) and as the transistor Tr31 performs an “ON” operation simultaneously, the light generation drive currents corresponding to the gradation currents Ipix (In detail, the electrical charge held in the condenser Cx) flows into the light emitting devices OEL (organic EL devices) via the transistors Tr31 and Tr33 from the voltage contact +V (high electric potential) and the organic EL devices OEL perform light generation by predetermined luminosity gradation. Namely, in the pixel driver circuits according to this embodiment, the p-channel type transistor Tr33 has the function as the transistor for the light generation drive.

Referring to FIG. 21, by executing such a series of drive control operations sequentially in repetition to the display pixel groups of all the lines that constitute the display panel 110A, the display data for one screen is written in, each of the display pixels emit light by predetermined luminosity gradation and the desired image information is displayed.

<The First Embodiment of the Data Driver>

Next, the first embodiment of the data driver applicable to the display device in the embodiment mentioned above will be explained.

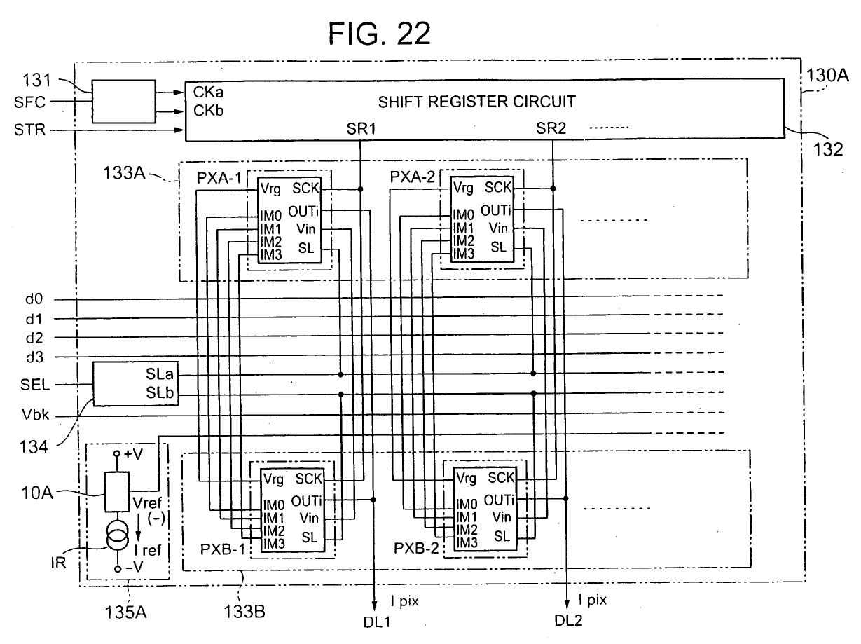

FIG. 22 is an outline configuration diagram showing the first embodiment of the data driver applicable to the display device related to this embodiment.

Here, the data driver in this embodiment comprises the configuration corresponding to the current application method and applies the configuration in the first embodiment of the current generation supply circuit.

Here, concerning explanation matching the configuration in the first embodiment of the current generation supply circuit, the same or equivalent nomenclature is appended and the explanation is simplified or omitted from the description.

The configuration in the first embodiment of the data driver 130A applicable to the display device 200A according to this embodiment, briefly, the current generation supply circuit 100A as shown in FIG. 1 as the basic configuration. The current output terminal (equivalent to the current output terminal OUTi of the current generation circuits of each of the current generation circuit sections are connected to the data lines DL of each line arranged in the display panel 110A.

Also by supplying the reference current Iref, having constant current value from the constant current generation source IR relative to the reference voltage generation circuit 10A, so that the voltage component (reference voltage Vref) generated at the contact in common (equivalent to contact Nrg) which constitutes the current mirror circuit will be applied to each of the current generation circuit sections.

Moreover, in the data driver 130A according to the embodiment, for example, two current generation circuit sections are established as a set to correspond to each of the data lines DL so that each other current generation circuit section can execute taking in and holding of the display data continuously and complementarily, generation of the gradation currents Ipix and the supply operation at predetermined timing.

In view of that, the data driver 130A according to this embodiment, specifically as shown in FIG. 22, for example, comprises an inverted latch circuit 131 and a shift register circuit 132. The inverted latch circuit 131 generates the non-inverted clock signals CKa and the inverted clock signals CKb based on the shift clock signals SFC supplied as data control signals from the system controller 140A. The shift register circuit 132 sequentially outputs the shift signals SR1, SR2, . . . (equivalent to the timing control signals CLK mentioned above) at predetermined timing during the shift sampling start signals STR based on the non-inverted clock signals CKa and the inverted clock signals CKb. Based on the input timing of the shift signals SR1, SR2, . . . from the shift register circuit 132, the display data d0˜dp (Here, denoted as p=3 and equivalent to the digital signals d0˜d3 mentioned above) in one line periods are sequentially taken in from the display signal generation circuit 150A; the gradation currents Ipix are generated corresponding to the light generation luminosity in each of the display pixels and a plurality of the gradation current generation supply circuit sections PXA-1, PXA2, . . . (equivalent to the current generation circuit sections 20A mentioned above) and PXB1, PXB2, . . . (hereinafter denoted as the “gradation current generation supply circuit sections PXA and PXB”) supply each of the data lines DL1, DL2, . . . . The two gradation current generation supply circuit sections (for example, PXA-1 and PXB-1) are constituted as one set (one pair) to each of the data lines DL1, DL2, . . . .

Furthermore, a plurality of the gradation current generation supply circuit sections PXA-1, PXA-2, . . . in one side and a plurality of gradation current generation supply circuit sections PXB-1, PXB-2, . . . in the other side function as sets (pairs) of gradation current circuit sections and each side respectively constitutes the gradation current generation supply circuit clusters 133A and 133B comprising a selection setting circuit 134 and a reference voltage generation circuit section 135A. The selection setting circuit 134 outputs selection setting signals (non-inverted signals of the scanning lines SLa and inverted signals of the scanning lines SLb of the switching control signal SEL) which operate selectively either of the above-mentioned current generation supply circuit clusters 133A and 133B based on the switching control signals SEL supplied as data control signals from the system controller 140A. The reference voltage generation circuit section 135A applies in common the constant reference voltage Vref to each of the gradation current generation supply circuit sections PXA and PXB.

Hereinafter, each configuration will be explained in detail.

(Reference Voltage Generation Circuit)

The reference voltage generation circuit section 135A, for example, equivalent to (FIG. 2) the configuration in the first embodiment of the first embodiment of the current generation supply circuit mentioned above, the constant current generation source IR supplies the reference current Iref having constant current value between the high electric potential +V and the low electric potential −V. The reference voltage generation circuit 10A comprises the reference current transistor Tp11 which flows the reference current Iref in the current path which has a series connection configuration. Based on this reference current Iref which flows in the current path of the reference voltage generation circuit 10A (reference current transistor Tp11), the electric potential in the gate terminal (contact Nrg) is generated as the reference voltage Vref and regularly applied to each of the gradation current generation supply circuit sections PXA and PXB that constitute the sets of the gradation current generation supply circuit clusters 133A and 133B.

(Gradation Current Generation Circuit Sections)

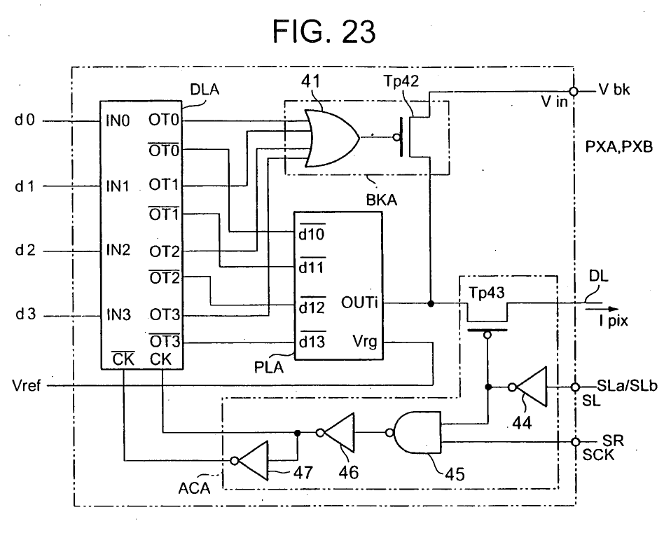

FIG. 23 is a configuration diagram showing a detailed configuration example of the gradation current generation circuit sections applicable to the first embodiment of the data driver according to this embodiment.

Each of the gradation current generation supply circuit sections PXA and PXB which constitute the gradation current generation supply circuit clusters 133A and 133B, for example as shown in FIG. 23, has a configuration comprising at least the signal holding circuits DLA, the gradation current generation circuits PLA (equivalent to the current generation circuits ILA of the current generation supply circuit mentioned above), an operation setting section ACA and a specified state setting section BKA. The operation setting section ACA selectively sets the operating state of each of the gradation current generation supply circuit sections PXA and PXB based on selection setting signals (non-inverted signals of the scanning lines SLa and the inverted signals of the scanning lines SLb) outputted from the selection setting circuit 134. The specified state setting section BKA applies specified voltage to the display pixels (data lines DL) when operating the display pixels in a specified drive state, such as a black display operation and the like, based on the non-inverted output signals d10˜d13 from the signal holding circuits DLA.

Here, as this configuration is composed of the signal holding circuits DLA and the gradation current generation circuits PLA corresponding to the signal holding circuits DLA and the current generation circuits ILA in the current generation circuit sections 20A shown in FIG. 1 for example which have the equivalent functions and configuration, the detailed description is omitted.

The operation setting section ACA, as shown in FIG. 23, has a configuration comprising an inverter 44, a p-channel type transistor Tp43, a NAND circuit 45 (commonly defined as a Not-AND logic gate for producing inverse output of an AND gate), an inverter 46 and an inverter 47. The inverter 44 performs reversal processing of selection setting signals (non-inverted signals of the scanning lines SLa and the inverted signals of the scanning lines SLb) outputted from the selection setting circuit 134. The p-channel type transistor Tp43 by which the inverted signal output signal of the above-mentioned selection setting signals (inverter 44 output signal) is applied to the gate terminal and the current path is established in the data lines DL. The NAND circuit 45 inputs the inverted signals of the selection setting signals (non-inverted signals of the scanning lines SLa and the inverted signals of the scanning lines SLb) and the shift signals SR from the shift register circuit 132. The inverter 46 performs reversal processing of the fan out of the NAND circuit 45. The inverter 47 performs further reversal processing of the inverted output of the inverter 46.

The specified state setting section BKA, as shown in FIG. 23, has a configuration comprising an OR operation circuit 41 (hereinafter denoted as the “OR circuit”) and a specified voltage application transistor Tp42. The OR circuit 41 processes the input signals of the non-inverted output signals d10˜d13 outputted from the signal holding circuits DLA (non-inverted output terminals OT0˜OT3 of each of the latch circuits LC0˜LC3) The specified voltage application transistor Tp42 (p-channel type Field-Effect transistor) applies the specified voltage Vbk to the current output terminal OUTi of the gradation current generation circuits PLA based on the output level of the OR circuit 41. Accordingly, the specified state setting section BKA distinguishes the specified state where all of the signal levels of the non-inverted output signals d10˜d13 outputted from the signal holding circuits are set as “0 (zero) and applies the specified voltage Vbk to the display pixels via the data lines DL.

In the gradation current generation supply circuit sections PXA and PXB which have such a configuration, when selection setting signals (non-inverted signals of the scanning lines SLa and the inverted signals of the scanning lines SLb) of the selection level (high-level) are inputted into the operation setting section ACA from the selection setting circuit 134 and by applying the reversal processing of the signal polarity by the inverter 44, the p-channel type transistor Tp43 performs an “ON” operation and the current output terminal OUTi of the gradation current generation supply circuit sections PXA are connected to the data lines DL via the p-channel type transistor Tp43. At this time simultaneously, regardless of the output timing of the shift signals SR by the NAND circuit 45 and the inverters 46, 47, the low-level timing control signals to the non-inverted input contact CK and the high-level timing control signals to the inverted input contact CK* of the signal holding circuits DLA are regularly inputted. Thus, the inverted output signals d10*˜d13* relative to the display data d0˜d3 held in the signal holding circuits DLA (each of the latch circuits LC0˜LC3) are supplied to the gradation current generation circuits PLA via the inverted output terminals OT0*˜OT3* and the gradation currents Ipix corresponding to the display data d0˜d3 are generated equivalent to the current generation circuit of the embodiment mentioned above.

Conversely, when the selection setting signals (non-inverted signals of the scanning lines SLa and the inverted signals of the scanning lines SLb) of the non-selection level (low-level) are inputted from the selection setting circuit 134, by applying the reversal processing of the signal polarity by the inverter 44, the p-channel type transistor Tp43 will perform an “OFF” operation and the current output terminal OUTi of the gradation current generation circuits will be disconnected from the data lines DL. Also, at that time simultaneously, corresponding to the output timing of the shift signals SR by the NAND circuit 45 and the inverters 46, 47, the high-level timing control signals to the non-inverted input contact CK and the low-level timing control signals to the inverted input contact CK* of the signal holding circuits DLA are inputted. Thus, the display data d0˜d3 are taken in and held in the signal holding circuits DLA.

As a result, even though the inverted output signals d10*˜d13* are outputted to the gradation current generation circuits PLA from the signal holding circuits DLA based on the display data d0˜d3, the gradation current Ipix will be in the state where it is not generated and the gradation current generation supply circuit sections PXA and PXB will be essentially set as the non-selection state. More specifically, either set in the gradation current generation supply circuit clusters 133A and 133B can be switched into the selection state and the other set placed in the non-selection state by accordingly setting the signal levels of the selection setting signals (non-inverted signals of the scanning lines SLa and the inverted signals of the scanning lines SLb from the switching control signals SEL) inputted into one set (one pair) of the gradation current generation supply circuit clusters 133A and 133B by means of the selection setting circuit 134 described later.

(Drive Control Method of the Display Device)

Next, the drive control method of the display device which has the data driver of the configuration mentioned above will be explained with reference to the drawings.

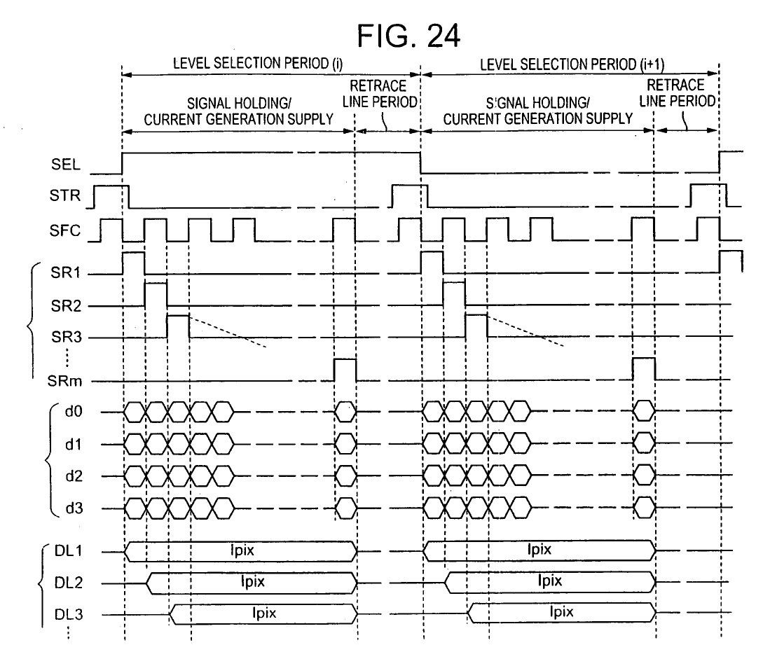

FIG. 24 is a timing chart showing an example of the control operations in the first embodiment of the data driver related to this embodiment.

Here, in addition to the configuration of the data driver shown in FIG. 22 and FIG. 23, the explanation will also suitably refer to the current generation supply circuit configuration shown in FIG. 1 and FIG. 2.

First, in the control operations of the data driver 130A, while performing sequential execution, a signal holding operation takes in and holds the display data d0˜d3 during constant periods which is supplied from the display signal generation circuit 150A to the signal holding circuits DLA established in each of the gradation current generation supply circuit sections PXA or PXB that constitute the gradation current generation supply circuit clusters 133A and 133B mentioned above; and a current generation supply operation generates the gradation currents Ipix corresponding to the above-mentioned display data d0˜d3 based on the inverted output signals d10*˜d13* from the signal holding circuits DLA by the gradation current generation circuits PLA established in each of the gradation current generation supply circuit sections PXA or PXB and supplies each of the display pixels via each data lines DL1, DL2, . . . . In this series of operations, the selection setting circuit 134 among the set of gradation current generation supply circuit clusters 133A and 133B implements repetitive alternating operations for performing simultaneously in parallel the above-mentioned signal holding operation in one of the gradation current circuit generation clusters while performing the above-mentioned current generation supply operation in the other of the gradation current generation circuit clusters.

(Signal Holding Operation)

The signal holding operation, as shown in FIG. 24, first after one of the gradation current generation supply circuit clusters 133A (or 133B) is set to the selection state by the selection setting circuit 134, with the signal holding circuits DLA established in each of the current generation supply circuit sections PXA (or PXB) of that gradation current generation supply circuit cluster 133A (or 133B) and based on the shift signals SR1, SR2, . . . sequentially outputted from the shift register circuit 132, an operation which sequentially takes in the display data d0˜d3 that changes corresponding to the display pixels (That is, each of the data lines DL1, DL2, . . . ) of each line is executed continuously in one line periods. Sequentially from the signal holding circuits DLA of the gradation current generation supply circuit sections PXA (or PXB) where the display data d0˜d3 is taken in during the non-selection state, the inverted output signals d10*˜d13* from the signal holding circuits DLA are outputted to the gradation current generation circuits PLA until the constant period (based on the subsequent switching control signal SEL from the selection setting circuit 134 to one of the gradation current generation supply circuit clusters 133B (or 133A)) is set as the non-selection state and the gradation current generation supply circuit clusters 133A of the other is set as the selection state.

(Current Generation Supply Operation)

Furthermore, in the current generation supply operation, as shown in FIG. 24, the “ON/OFF” state of a plurality of selection transistors (selection transistors Tp16˜Tp19, Tp26˜Tp29 shown in FIG. 2) established in each of the gradation current generation circuits PLA are controlled based on the above inverted output signals d10*˜d13*. The composite current of the module currents which flow into the module transistors (module current transistors Tp12˜Tp15, Tp22˜Tp25 shown in FIG. 2) connected to the selection transistors that perform an “ON” operation is sequentially supplied via each of the data lines DL1, DL2, . . . as the gradation currents Ipix.

Here, the gradation currents Ipix, for example, are set to be supplied simultaneously in parallel at least in the constant period to all the data lines DL1, DL2, . . . .

Additionally, in this embodiment, a plurality of the module currents having current values of predetermined ratio (for example, a×2^{k}; k=0, 1, 2, 3, . . . ) specified by the transistor size in advance are generated relative to the reference current Iref which flows into the voltage generation circuit 10A as mentioned above. By controlling the “ON/OFF” operations of the selection transistors based on the inverted output signals d10*˜d13* from the above-mentioned signal holding circuits DLA, predetermined module currents are selected and integrated; the gradation currents Ipix of positive polarity are generated; and gradation currents Ipix are flowed so that the currents move in the direction of the data lines DL1, DL2, . . . from the data driver 130A.

Moreover, in the black display operation, as shown in FIG. 24, by setting the display data d0˜d3 as the black display state (all inverted output signals d10*˜d13* from the signal holding circuits DLA are set as “0 (zero)), as some of the selection transistors in the gradation current generation circuits PLA perform an “OFF” operation, module currents are electrically blocked out and the supply of the gradation currents Ipix is suspended. At this time simultaneously, the black display state of the display data is distinguished from the OR circuit 41 set in the specified state setting section BKA, the specified voltage application transistor Tp42 performs an “ON” operation, and the voltage Vbk corresponding to the black display (light generation operation at the lowest luminosity gradation) is applied to the each of the data lines DL1, DL2, . . . .

The drive control operations of the pixel driver circuits DCx of the display pixels in the display panel 110A, as shown in the above-mentioned FIG. 21, in the write-in operation period Tse the gradation currents Ipix are written in the pixel driver circuits DCx. In the light generation operation period Tnse, the light generation drive current corresponding to the gradation currents Ipix flows into the light emitting devices OEL (organic EL devices) based on the electrical charge held in condenser Cx and is controlled so that the organic EL devices OEL perform the light generation operation by predetermined luminosity gradation. Here, in this embodiment, synchronizing with the write-in operation to the display pixel clusters of each line, the set (pair) of gradation current generation supply circuit clusters 133A and 133B established in the data driver 130A are alternately set as the selection state. For example, relative to the display pixels of the oddth lines (odd numbered lines), the gradation currents Ipix are supplied from one gradation current generation supply circuit cluster 133A; and relative to the display pixel clusters of the eventh lines (even numbered lines) controlled so that the gradation currents Ipix are supplied from the other gradation current generation supply circuit cluster 133B.

Therefore, in the data driver 130A and the display device 200A according to this embodiment, at the time of normal gradation display operation, the module currents corresponding to the display data d0˜d3 are generated and integrated by each of the gradation current generation supply circuit sections PXA-1, PXA-2, . . . and PXB-1, PXB-2, . . . corresponding to each of the data lines DL1, DL2, . . . and each of the display pixels is supplied by way of the gradation currents Ipix which have the appropriate current value.

In addition, at the time of the black display operation as supply of the gradation currents Ipix are electrically blocked out by each of the gradation current generation supply circuit sections PXA, PXB, the predetermined black display voltage Vbk corresponding to the light generation operation by the lowest luminosity gradation in the display pixels is applied to each of the data lines DL1, DL2, . . . . While achieving satisfactory gradation display and also in the time of the black display operation, the specified voltage can be made to stabilize the signal levels of each of the data lines DL1, DL2, . . . as well as shift to the black display state rapidly. Thus, improvement in the display response characteristics in the display device and display image quality can be promoted.

Additionally, in the data driver 130A (gradation current generation supply circuit sections PXA, PXB) that applies a current mirror circuit configuration in which the channel widths of a plurality of the module current transistors established in each of the gradation current generation supply circuit sections PXA and PXB that constitute the current mirror circuits relative to the reference current transistor established in the reference voltage generation circuit 10A, a plurality of the module currents (a plurality of digital signal bits) having current values specified with the above-mentioned ratios can be flowed by setting so that each other has a predetermined ratio (for example, a×2ⁿ) relative to the reference current Iref supplied by the constant current generation source. As the gradation currents Ipix having current values of 2ⁿ step are generable by appropriately integrating them with the display data d0˜d3, a relatively simplified circuit configuration can generate and supply the gradation currents Ipix consisting of analog currents having the appropriate current values corresponding to the display data d0˜d3, and the light generation operation of the display pixels can be performed by proper luminosity gradation.

Also, in this embodiment, although the case where the data driver comprises a set of gradation current generation circuit clusters is applied to each of the data lines arranged in the display panel is explained, this invention is not limited to this. For example, a configuration comprising only a single gradation current generation circuit cluster to each of the data lines in which the data driver executes taking in of the display data serially, holding, generation of the gradation currents and the supply operation can be applied.

Moreover, in the embodiments, even though the case where 4-bit digital signals are inputted and made to operate at different drive states of 16 steps as the display data (control signals) for executing the light generation operation of each of the display pixels by the desired luminosity gradation is explained, the present invention is not restricted to this. It is emphasized that the alteration setting of the number of bits can be suitably applied corresponding to the number of luminosity gradations according to the specifications of the display panel and the like.

<The Second Embodiment of the Display Device>

In the first embodiment of the display device mentioned above, although comprising a circuit configuration corresponding to the current application method and designed so that supplied gradation currents flow into the display pixels from the data driver side, the present invention is not restricted to this. The circuit configuration can correspond to the current sink method which draws the gradation currents in the direction of the data driver from each of the display pixels side.

Hereinafter, the second embodiment of the display device comprising the configuration corresponding to the current sink method will be explained.

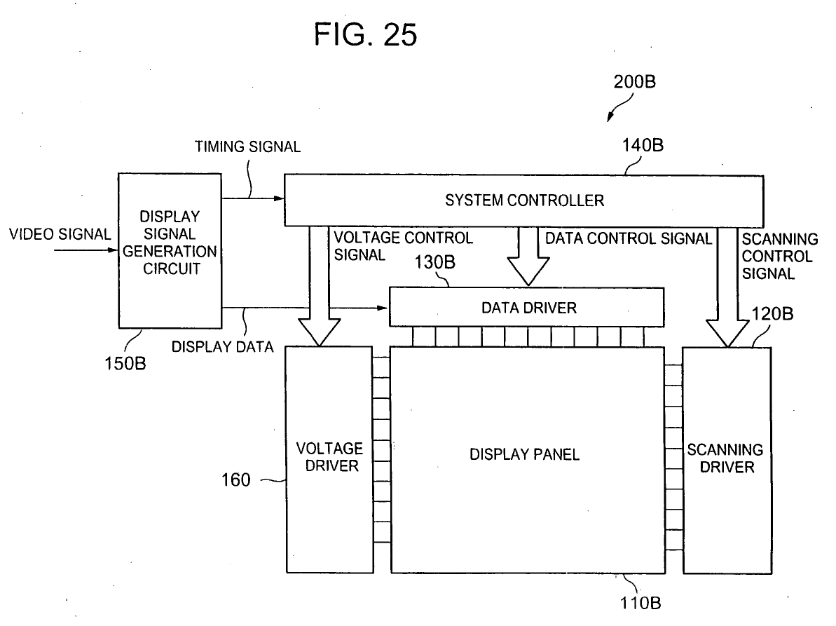

FIG. 25 is an outline block diagram showing the second embodiment of the display device which can apply the current generation supply circuit related to this embodiment.

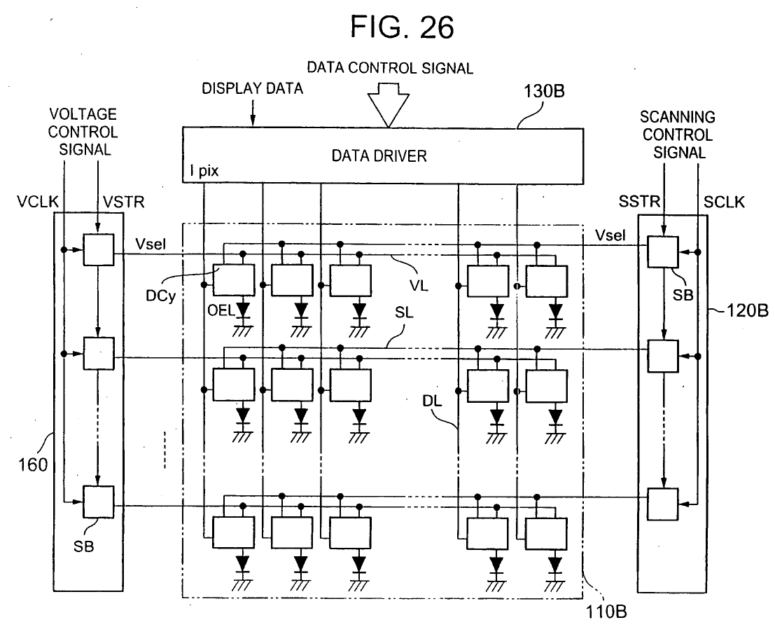

FIG. 26 is an outline configuration diagram showing an example of the configuration of the display panel applicable to the display device related to the embodiments.

Here, since this configuration is equivalent as that of the first embodiment (FIG. 18, FIG. 19) of the display device mentioned above, the same or equivalent nomenclature is appended and the explanation is simplified or omitted from the description.

The display device 200B according to this embodiment, as shown in FIG. 25 and FIG. 26, briefly has a configuration comprising a display panel 110B, a scanning driver 120B, a data driver 130B, a system controller 140B, a display signal generation circuit 150B and a voltage driver 160. In addition, the voltage driver 160 is connected to the voltage lines VL connected in common to the display pixel clusters disposed in each line and arranged in parallel to each line of the scanning lines SL.

Hereinafter, the configuration distinctive to this embodiment will be explained.

The display panel 110B, for example as shown in FIG. 26, comprises a structure arranged with display pixels which have a configuration described later in formation with a plurality of the scanning lines SL and the voltage lines VL arranged parallel with each other and arranged so that the scanning lines SL and the voltage lines VL intersect perpendicularly near each of the intersecting points of a plurality of the data lines DL.

The display pixels, specifically, have a configuration comprising the pixel driver circuits DCy and the organic EL devices OEL (light emitting devices). The pixel driver circuits DCy control the write-in operation of the gradation currents Ipix and the light generation operation in each of the display pixels based on the power supply voltage Vsc applied via the voltage lines VL from the voltage driver 160, the scanning signals Vsel applied via the scanning lines SL and the gradation currents Ipix supplied via the data lines DL; and the organic EL devices OEL (light emitting devices) by which light generation luminosity is controlled corresponding to the current values of the light generation drive currents supplied from the pixel driver circuits DCy. In addition, an example of the circuit configuration applicable to the pixel driver circuits DCy will be described later.

The scanning driver 120B, equivalent to the first embodiment (FIG. 19) mentioned above, based on scanning control signals from the system controller 140B and by sequentially applying the scanning signals Vsel of the selection level to each of the scanning lines at predetermined timing, the display pixel clusters for every line are set to the selection state and control the write-in of the gradation currents Ipix supplied via each of the data lines DL in each of the display pixels.

The data driver 130B has the configuration which applies the composition (Refer to FIG. 3 and FIG. 4) in the second embodiment of the current generation supply circuit corresponding to the current sink method mentioned above as the basic configuration. Based on data control signals from the system controller 140B, the display data composed of a plurality of digital signal bits is taken in and held; the specified module currents which flow corresponding to the appropriate display data are integrated; the gradation currents Ipix which have predetermined current values are generated; and the supply is controlled simultaneously in parallel to each of the data lines DL. In this embodiment, the gradation currents Ipix are flowed so that the currents are drawn in the direction of the data driver from the display pixels side.

The voltage driver 160 synchronizes with timing for setting the selection state of every display pixel cluster for each line by the scanning driver 120B based on voltage control signals supplied from the system controller 140A. By applying the power supply voltage Vsc (for example, low-level set below ground potential) of the selection level to the voltage lines VL, the predetermined gradation currents Ipix based on the display data are drawn in the direction of the data driver 130B via the display pixels (pixel driver circuits DCy) from the voltage lines VL. Conversely, the voltage driver 160 synchronizes with timing for setting the non-selection state of every display pixel cluster for each line by the scanning driver 120B. By applying the power supply voltage Vsc of the non-selection level (for example, high-level) to the voltage lines VL, the voltage driver 160 controls the flow of the light generation drive currents equivalent to the above-mentioned gradation currents Ipix in the direction of the organic EL devices OEL via the display pixels (pixel driver circuits DCy) from the voltage lines VL.

The voltage driver 160, specifically, as shown in FIG. 26 equivalent to the scanning driver 120A (Refer to FIG. 19), the shift block SB is composed of a shift register and a buffer comprising a plurality of steps made to correspond to the voltage lines VL of every line. The shift signals are outputted while sequentially shifting from the upper part to the lower part of the display panel 110A with the shift register and applied by each of the voltage lines VL as the power supply voltage Vsc which has predetermined voltage levels (for example, the low-level in the selection state and high-level in the non-selection state from the scanning driver 120B) via the buffer, based on voltage control signals (voltage start signals VSTR, voltage clock signals VCLK, and the like) which synchronize with the above-mentioned scanning control signals and are supplied from the system controller 140B.

The system controller 140B at least interacts with each other of the scanning driver 120B, the data driver 130B and the voltage driver 160. By generating and outputting scanning control signals, data control signals and voltage control signals (voltage start signal VSTR, voltage clock signal VCLK, and the like), each driver is operated to predetermined timing; the scanning signals Vsel, gradation currents Ipix, and the power supply voltage Vsc are made to output to the display panel 110B; predetermined control operations in the pixel driver circuits DCy are executed continuously; and control of the predetermined image information displayed on the display panel 110B based on the video signals is performed.

In addition, in this embodiment as the driver attached to the periphery of the display panel 110B, as shown in FIG. 25 and FIG. 26 relating to the display panel 110B, although the configuration has the scanning driver 120B and the voltage driver 160 arranged separately is explained, the present invention is not limited to this. For example, as mentioned above, as the scanning driver 120b and the voltage driver 160 operate based on the equivalent control signals (scanning control signals and voltage control signals) with which timing synchronizes; and for example, has the feature for supplying the power supply voltage Vsc and synchronizing with timing while generating and outputting the scanning signals Vsel to the scanning driver 120B, they may be constituted into one unit on the same substrate. According to such a configuration, the structure of the periphery circuit can be simplified and miniaturized.

(Display Pixels)

Next, one embodiment of the pixel driver circuits applicable to each of the display pixels in the display device mentioned above will be explained.

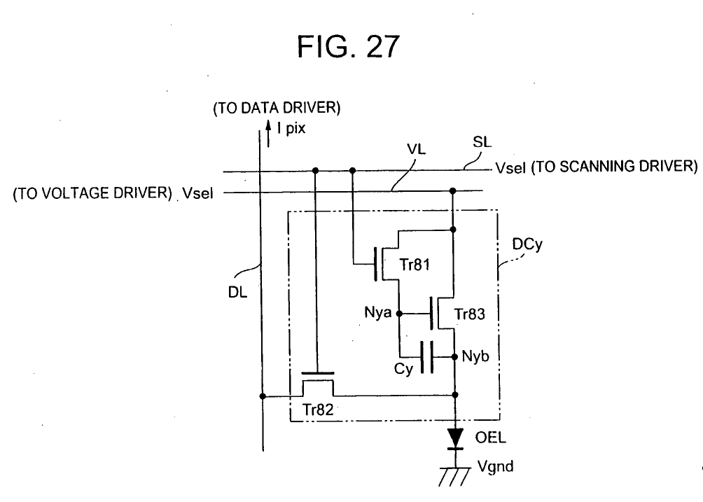

FIG. 27 is a circuit configuration diagram showing one embodiment applicable to the pixel driver circuits of the display pixels in the display device related to the embodiments.

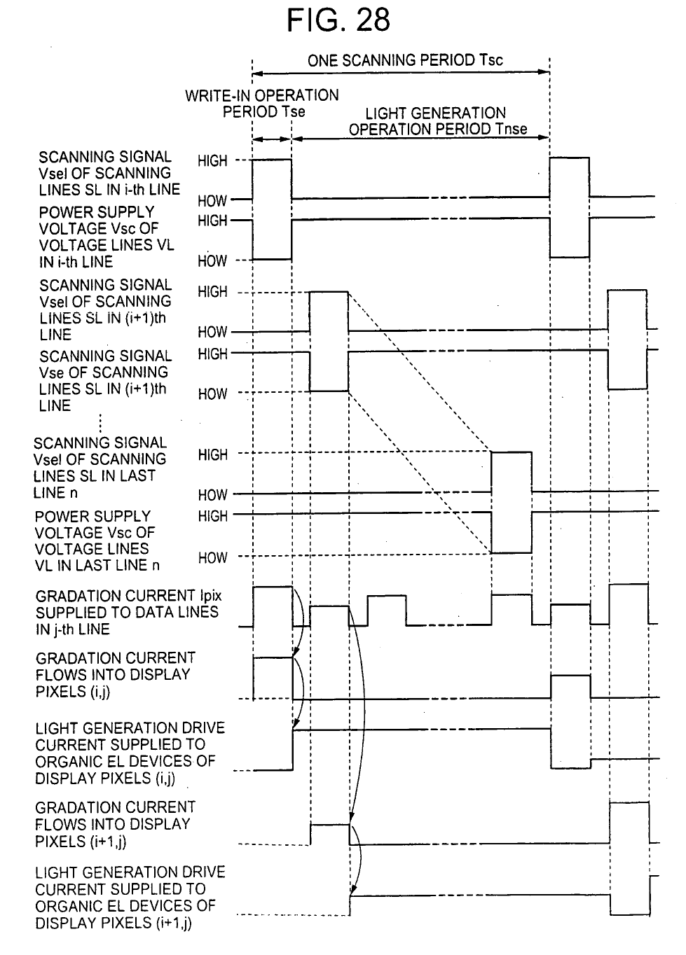

FIG. 28 is a timing chart showing an example of the control operations in the pixel driver circuit related to the embodiments.

In addition, the pixel driver circuit shown here only represents an example applicable to the display device related to this invention. Needless to say, there can be other circuit arrangements having an equivalent operational function.

The pixel driver circuits DCy according to this embodiment, as shown in FIG. 27, for example, has a configuration comprising an n-channel type transistor Tr81, an n-channel type transistor Tr82, an n-channel type transistor Tr83 and a condenser Cy. The n-channel transistor Tr81 by which each other is connected with source terminal to the contact Nya, the drain terminal to the voltage lines VL arranged in parallel with the scanning lines VL and the gate terminal to the scanning lines SL near the intersecting points of the scanning lines SL and the data lines DL. The n-channel transistor Tr82 by which the source-drain terminals are connected each other to the contact Nyb and the data lines DL along with the gate terminal to the scanning lines SL. The n-channel type transistor Tr83 by which the source-drain terminals are connected each other to contact Nyb and the voltage lines VL along with the gate terminal to the contact Nya. The condenser Cy is connected between the contact Nya and the contact Nyb.

Additionally, the organic EL devices OEL by which light generation luminosity is controlled by the light generation drive currents supplied from such pixel driver circuits DCy have the configuration in which the anode terminal is connected to the contact Nyb of the above-mentioned pixel driver circuits DCy and the cathode terminal is connected to the ground potential Vgnd. Also, the condenser Cy is a parasitic capacitor arranged between the gate-source of the transistor Tr83 and a second capacitative element can be added separately further between the gate-source in addition to the parasitic capacitor.

The drive control operations of the pixel driver circuits DCy which have such a configuration as shown in FIG. 28, first, in a write-in operation period Tse, while applying the high-level (selection level) scanning signals Vsel to the scanning lines SL, the low-level of the power supply voltage Vsc is applied to the voltage lines VL. Also, while synchronizing with this timing, predetermined gradation currents Ipix required in order to perform the light generation operation of the organic EL devices by predetermined luminosity gradation is supplied to the data lines DL from the data driver 130B. Here, as the gradation currents Ipix, the current of negative polarity is supplied and set so that the proper currents may be drawn in the direction of the data driver 130B via the data lines DL from the display pixels (pixel driver circuits DCy) side as described later.

Accordingly, the n-channel type transistors Tr81 and Tr82 which constitute the pixel driver circuits DCy perform an “ON” operation. As the low-level of the power supply voltage Vsc is applied to the contact Nya (accordingly, the gate terminal side of the n-channel type transistor Tr83 and the one end side of the condenser Cy, the voltage level of low electric potential is applied to the contact Nyb (accordingly, the source terminal of the n-channel type transistor Tr83 and the other end side of the condenser Cy) rather than the low-level of the power supply voltage Vsc via the n-channel type transistor Tr82 by the drawing-in operation of the gradation currents Ipix.

Thus, when an electric potential difference occurs between the contacts Nya and Nyb (between the gate-source of the n-channel type transistor Tr83), the n-channel type transistor Tr83 performs an “ON” operation and the current corresponding to the gradation currents Ipix flows in the direction of the data lines DL via the n-channel type transistor Tr83, contact Nyb and the n-channel type transistor Tr82 from the voltage lines VL.

At this time, the electrical charge corresponding to this electric potential difference generated between the contacts Nya and Nyb is stored in the condenser Cy) and held (charge) as the voltage component. Also, since the potential applied to the anode terminal (contact Nyb) of the organic EL devices becomes lower than the potential (ground potential) of the cathode terminal, reverse-bias is applied to the organic EL devices OEL. Thus, the light generation drive currents do not flow into the organic EL devices OEL, and the light generation operation is not performed.

Next, in the light generation operation period, as the low-level (non-selection level) scanning signals Vsel are applied to the scanning lines SL, the high-level power supply voltage Vsc is applied to the voltage lines VL. Synchronizing with this timing, the drawing-in operation of the gradation currents Ipix is suspended.

Accordingly, since application of the voltage level resulting from the drawing in operation of the gradation currents Ipix causes the contact Nyb to be blocked out (shut down), the n-channel type transistors Tr81 and Tr82 perform an “OFF” operation and application of the power supply voltage Vsc to the contact Nya is blocked out. The condenser Cy) holds the electrical charge stored in the write-in operation mentioned above.

Thus, when the condenser Cy) holds the charge voltage at the time of the write-in operation, the electrical potential difference between the contacts Nya and Nyb (between gate-source of the n-channel type transistor Tr83) will be held, and the n-channel type transistor Tr83 maintains an “ON” state. Also, since the power supply voltage Vsc which has a voltage level higher than ground potential is applied to the voltage lines VL, the light generation drive currents flow into the organic EL devices OEL in the forward-bias direction via the n-channel type transistor Tr83 and contact Nxb from the voltage lines VL.

Here, since the electric potential difference (charge voltage) held at the condenser Cy), is equivalent to the electric potential difference at the time of flowing in the currents corresponding to the gradation currents Ipix to the n-channel type transistor Tr83 at the time of the above-mentioned write-in operation, the light generation drive currents which flow into the organic EL devices OEL will have the equivalent current values to the above-mentioned currents. Consequently, in the light generation operation period, the organic EL devices OEL continue the operation which emits light by the desired luminosity gradation based on the voltage component corresponding to the gradation currents written in the write-in operation period.

Therefore, by executing such a series of drive control operations, as shown in FIG. 28, sequentially in repetition using the scanning driver 120B, the voltage driver 160 and the data driver 130B described later, the display data for one screen is written in, each of the display pixels emit light by predetermined luminosity gradation and the desired image information is displayed.

<The Second Embodiment of the Data Driver>

Next, the second embodiment of the data driver applicable to the display device in the embodiments mentioned above will be explained with reference to the drawings.

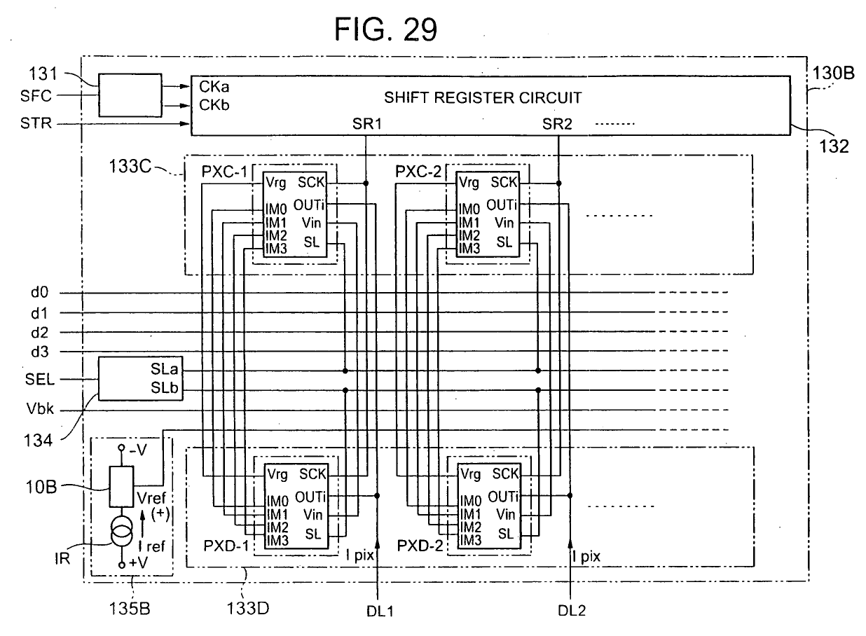

FIG. 29 is an outline configuration diagram showing the second embodiment of the data driver applicable to the display device related to the embodiments.

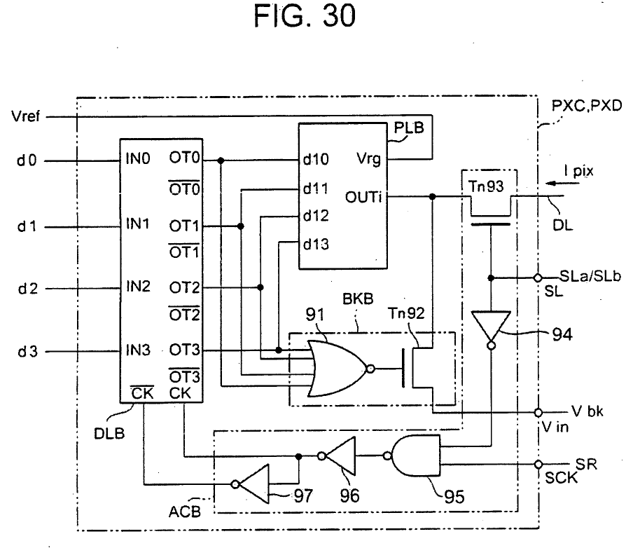

FIG. 30 is an outline configuration diagram showing the second embodiment of the data driver applicable to the display device related to this embodiment;

The data driver in this embodiment comprises the configuration corresponding to the current sink method and applies the configuration in the second embodiment of the current generation supply circuit mentioned above.

Here, concerning explanation matching the configuration in the second embodiment of the current generation supply circuit mentioned above, the same or equivalent nomenclature is appended and the explanation is simplified or omitted from the description.

Accordingly, the data driver 130B in this embodiment, for example as shown in FIG. 29, has the configuration comprising the equivalent composition of the first embodiment of the data driver mentioned above, in addition comprises the inverted latch circuit 131, the shift register circuit 132, the gradation current generation supply circuit clusters 133C, 133D and the reference voltage generation circuit section 135B which has the circuit configuration equivalent to the reference voltage generation circuit 10B (FIG. 4) in the second embodiment of the current generation supply circuit mentioned above.

Accordingly, the reference voltage generation circuit section 135B, for example, has a configuration with the reference voltage generation circuit 10B in a series connection which comprises the constant current generation source IR and the reference current transistor Tn11 between the high electric potential and the low electric potential. Based on the reference current Iref which flows into the reference voltage generation circuit 10B, the potential generated in the gate terminal (contact Nrg) is generated as the reference voltage Vref and regularly applied to a set (pair) of the gradation current generation circuit clusters 133C and 133D.

The gradation current generation supply circuit clusters 133C and 133D have a configuration with each other comprising a plurality of the gradation current generation supply circuit sections PXC-1, PXC2, . . . and PXD-1, PXD-2 (hereinafter denoted as the “gradation current generation supply circuit sections PXC and PXD). Each of the gradation current generation supply circuit sections PXC, PXD), as shown in FIG. 30, has a configuration comprising at least the latch circuits DLB, the gradation current generation circuits PLB (equivalent to the current generation circuits ILB, the operation setting section ACB and the specified state setting section BKB. The operation setting section ACB which selectively sets the operating state of each of the gradation current generation supply circuit sections PXC, PXD) based on selection setting signals (non-inverted signals of the scanning lines SLa and inverted signals of the scanning lines SLb of the switching control signal SEL). The specified state setting section BKB applies specified voltage to the display pixels (data lines DL) when operating the display pixels in a specified drive state, such as a black display operation and the like, based on the non-inverted output signals d10˜d13 from the signal holding circuits DLB.

Here, since the configuration comprises the data latch sections DLB and the gradation current generation circuits PLB corresponding to the signal holding circuits DLB and the current generation circuits ILB in the current generation circuit section 20B shown in FIG. 3 and comprises the equivalent functions and configurations, the detailed description is omitted.

The operation setting section ACB, as shown in FIG. 30, has a configuration comprising an n-channel type transistor Tn93, an inverter 94, a NAND circuit 95 (commonly defined as a Not-AND logic gate for producing inverse output of an AND gate), an inverter 96 and an inverter 97. The n-channel type transistor Tn93 with which selection setting signals (non-inverted signals of the scanning lines SLa and inverted signals of the scanning lines SLb) outputted from the selection setting circuit 134 are inputted. The current path is established in the data lines DL and the above-mentioned selection setting signals are applied to the gate terminal. The inverter 94 performs reversal processing of selection setting signals (non-inverted signals of the scanning lines SLa and inverted signals of the scanning lines SLb). The NAND circuit 95 inputs the inverted signals of the selection setting signals and the shift signals SR from the shift register circuit 132. The inverter 96 performs reversal processing of the fanout of the NAND circuit 95. The inverter 97 performs further reversal processing of the inverted output of the inverter 96.

The specified state setting section BKA, as shown in FIG. 30, has a configuration comprising an NOR operation circuit 91 (NOT/OR circuit; hereinafter denoted as the “NOR circuit”) and a specified voltage application transistor Tn92. The NOR circuit processes the input signals of the non-inverted output signals d10˜d13 outputted from the signal holding circuits DLB. The specified voltage application transistor Tn92 (n-channel type Field-Effect Transistor) applies the specified voltage Vbk to the current output terminal OUTi of the gradation current generation circuits PLB based on the output level of the NOR circuit 91. Accordingly, the specified state setting section BKA distinguishes the specified state where all of the signal levels of the non-inverted output signals d10˜d13 outputted from the signal holding circuits are set as “0 (zero) and applies the specified voltage Vbk to the display pixels via the data lines DL.

The control operations of the data driver 130A which has such as configuration is the equivalent configuration shown in the above-mentioned FIG. 22. In the signal holding operation of one of the gradation current generation circuit clusters (for example, gradation current generation circuit cluster 133C) while set as the selection state based on the selection setting signals (non-inverted signals of the scanning lines SLa and inverted signals of the scanning lines SLb), the signal holding circuits DLB established in each of the gradation current generation supply circuit sections PXC-1, PXC-1, . . . sequentially take in and hold the display data d0˜d3 for every line. The non-inverted display data d0˜d3 are outputted to the gradation current generation circuits PLB as the non-inverted output signals d10˜d13 via the non-inverted output terminals OT0˜OT3 (each of the latch circuits LC0˜LC3). In the current generation supply operation, the gradation current generation circuits PLB generate the gradation currents Ipix of negative polarity based on the non-inverted output signals d10˜d13 from the data latch circuits DLB and supplies so that the flow of the gradation currents Ipix can be drawn in the direction of the data driver 130B via each of the data lines DL1, DL2, . . . from the side of each of the display pixels. While performing the above-mentioned supply operation between the set (pair) of the gradation current generation supply circuit clusters 133C, 133D by means of the selection setting circuit 134, an operation performs the above-mentioned signal holding operation simultaneously in parallel from the gradation current generation circuit cluster of the other and is controlled to execute repetitive alternating operations.

Therefore, also in the display device which applies the data driver 130B according to this embodiment, by generating and integrating the module currents corresponding to the display data d0˜d3 by each of the gradation current generation circuits PLB set corresponding to each of the data lines DL1, DL2, . . . , the gradation currents Ipix having the appropriate current values will be supplied to each of the display pixels (pixel driver circuits DCy). As a result a rapid and favorable gradation display operation can be achieved.

<The Third Embodiment of the Data Driver>

Next, the third embodiment of the data driver applicable to the display device in the embodiments mentioned above will be explained with reference to the drawings.

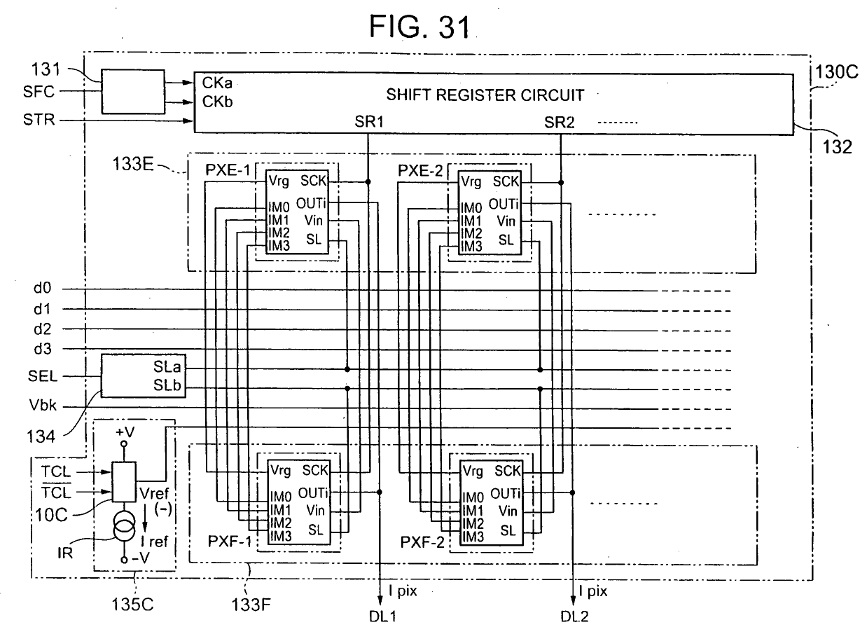

FIG. 31 is an outline configuration diagram showing the third embodiment of the data driver applicable to the display device related to the embodiments.

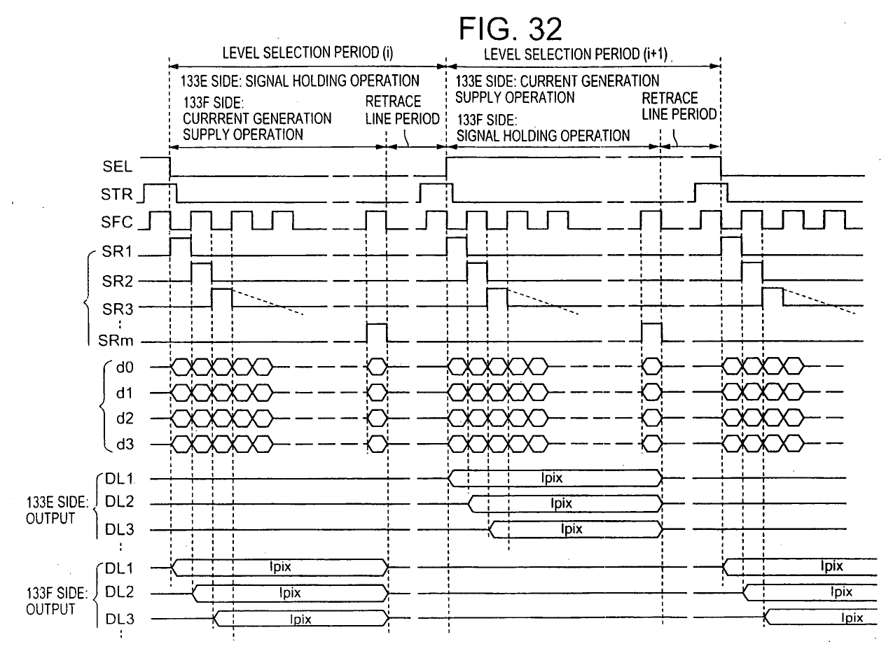

FIG. 32 is a timing chart showing an example of the control operations in the third embodiment of the data driver related to the embodiments.

The data driver in this embodiment applies the configuration of the third embodiment (FIG. 5) of the reference voltage generation circuit of the above-mentioned current generation supply circuit and the current generation circuits.

Here, concerning any configuration equivalent in the embodiments mentioned above, the same or equivalent nomenclature is appended and the explanation is simplified or omitted from the description.

Although this embodiment has the circuit configuration corresponding to the current application method, the circuit configuration can also be made to correspond with the current sink method.

The data driver 130C which applies the current generation supply circuit having such a configuration, as shown in FIG. 31 for example, has the configuration equivalent composition of the first embodiment of the data driver mentioned above (FIG. 22, FIG. 23), in addition comprises the inverted latch circuit 131, the shift register circuit 132, the gradation current generation circuit clusters 133E and 133F and the reference voltage generation circuit section 135C which has the circuit configuration equivalent to the reference voltage generation circuit 10C (FIG. 5) in the third embodiment of the reference voltage generation circuit and the current generation circuits mentioned above. Based on the control signals TCL, TCL* which synchronize with the shift signals SR1, SR2, . . . inputted as timing control signals to the each of the gradation current generation supply circuit sections PXE-1, PXE-2, . . . and PXF-1, PXF-2, . . . , the reference voltage Vref having constant voltage is regularly applied to each of the gradation current generation supply circuit sections PXE-1, PXE-2, . . . and PXF-1, PXF-2, . . . and performs repetitive refresh operations of the reference voltage Vref at predetermined timing.

Also, the control operations in the data driver 130C which has such a configuration, as shown in FIG. 32, in the signal holding operation of the gradation current generation supply circuit cluster (for example, gradation current generation supply circuit cluster 133E) set as the selection state based on selection setting signals (non-inverted signals of the scanning lines SLa and inverted signals of the scanning lines SLb) of the selection level (high-level), the display data d0˜d3 for every line is sequentially taken in and held in the signal holding circuits DLA established in the each of the gradation current generation supply circuit sections PXE-1, PXE-2, . . . and PXF-1, PXF-2, . . . based on the shift signals SR1, SR2, SR3, . . . sequentially outputted from the shift register circuit 132.

Here, referring to FIG. 23, in the operation setting section ACA of each of the gradation current generation supply circuit sections PXE-1, PXE-2, . . . , the p-channel type transistor Tp43 which controls supply of the gradation currents Ipix to the data lines DL performs an “OFF” operation by the input of the low-level selection setting signal (non-inverted signal of the scanning lines SLa). As supply of the gradation currents Ipix from the gradation current generation supply circuit cluster 133E (gradation current generation supply circuit sections PXE-1, PXE-2) is blocked out, the display data d0˜d3 is taken in by the signal holding circuits DLA based on the output timing of the shift signals SR1, SR2, . . . from the shift register circuit 132.

At this time, in the reference voltage generation circuit section 135C, synchronizing with the output timing of the shift signals SR1, SR2, . . . (non-inverted control signals TCL and the inverted control signals TCL*), the electrical charge supplied to the contact Nrg from the constant current generation source IR is recharged (refreshed) to the proper potential (reference voltage Vref) and the reference voltage Vref is regularly applied to the gate terminal of each of the module current transistors applied by the gradation current generation circuits PLA. Referring to FIG. 5, this reference voltage is held as the voltage component at the condenser Cc) established between the gate-source of the reference current transistor Tp101 which constitutes the reference voltage generation circuit section 135C.

Next, in the current generation supply operation of the gradation current generation circuit cluster (for example, gradation current generation supply circuit cluster 133E) set as the non-selection state based on selection setting signals (non-inverted signals of the scanning lines SLa and inverted signals of the scanning lines SLb) of the non-selection level (low-level), when the selection transistors Tp16˜Tp19, Tp26˜Tp29 connected corresponding to each of the module current transistors Tp-12˜Tp15, Tp22˜Tp25, . . . selectively perform an “ON” operation, the module currents which flow into the specified module current transistors are integrated and the gradation currents Ipix of positive polarity are generated based on the inverted output signals d10*˜d13* outputted from the gradation current generation circuits PLA from the signal holding circuits DLA.

At this time, in the operation setting section ACA of each of gradation current generation supply circuit sections PXE-1, PXE-2, since the p-channel type transistor Tp43 performs an “OFF” operation by the input of the high-level selection setting signal (non-inverted signals of the scanning lines SLa), the above mentioned gradation currents Ipix are sequentially supplied to each of the display pixels via each of the data lines DL1, DL2, . . . .

Furthermore, the selection setting signals (non-inverted signals of the scanning lines SLa and inverted signals of the scanning lines SLb) which have inverted relationship in regard to the signal polarity with each other synchronize and supply a set of the gradation current generation supply circuit clusters 133E and 133F as shown in FIG. 31. While executing the signal holding operation in one of the gradation current generation supply circuit clusters (for example, gradation current generation supply circuit cluster 133E), the current generation supply operation is simultaneously executed in parallel in the other of the gradation current generation supply circuit clusters (for example, gradation current supply circuit cluster 133F), as shown in FIG. 32.

Here, the gradation currents Ipix generated in each of the gradation current generation circuit sections, as mentioned above in the signal holding operation, because the reference voltage Vref is held in the voltage component charged to the condenser Cc) of the reference voltage generation circuit section 135C and applied to the gate terminal of each of the module transistors, the current values of the module currents generated in each module transistor can be set to the rated value. The gradation currents Ipix which are selected, integrated and generated can be set as the uniform current value to control variations. Therefore, decline of the gate voltage (reference voltage) by means of a current leak and the like in each of the module current transistors is controlled. As the gradation current Ipix having the appropriate current values corresponding to the display data d0˜d3 can be supplied to each of the display pixels, a satisfactory gradation display operation is achievable.

<The Fourth Embodiment of the Data Driver>

Next, the fifth embodiment of the data driver applicable to the display device in the embodiment mentioned above will be explained with reference to the drawings.

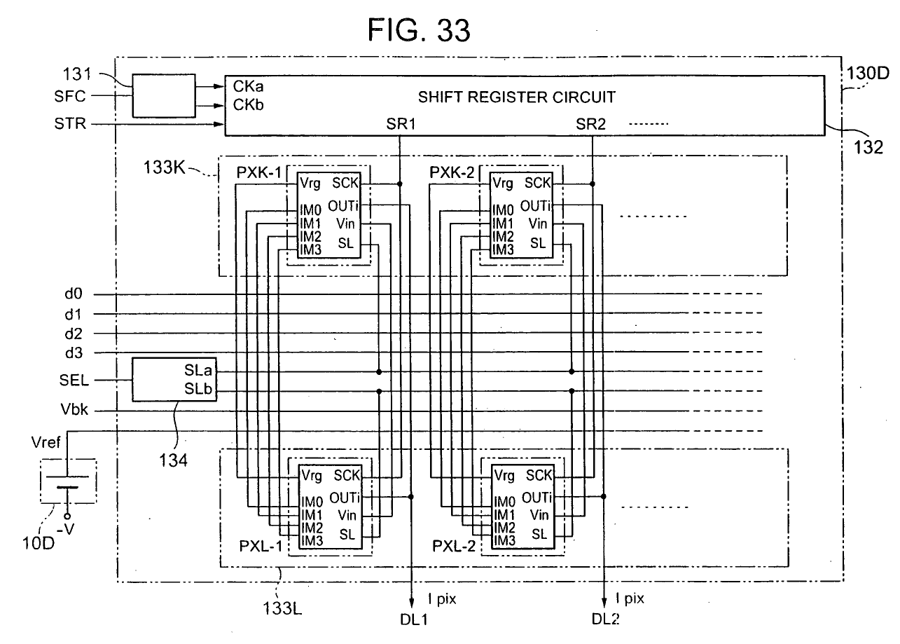

FIG. 33 is an outline configuration diagram showing the fifth embodiment of the data driver applicable to the display device related to the embodiments.

The data driver in this embodiment applies the configuration of the fourth embodiment (FIG. 6 refers) of the reference voltage generation circuit of the above-mentioned current generation supply circuit and the current generation circuits.

Here, concerning any configuration equivalent in the embodiments mentioned above, the same or equivalent nomenclature is appended and the explanation is simplified or omitted from the description.

Although this embodiment has the circuit configuration corresponding to the current application method, the circuit configuration can also be made to correspond with the current sink method.

The data driver 130D which applies the current generation supply circuit having such a configuration, as shown in FIG. 33 for example, has the configuration equivalent composition of the first embodiment (FIG. 22, FIG. 23 refer), in addition comprises the inverted latch circuit 131, the shift register 132, the gradation current generation supply clusters 133K and 133L and the reference voltage generation section 10D which is composed of the constant voltage source VR mentioned above.

The control operations in the data driver 130D which has such a configuration, the signal holding operation which sequentially takes in and holds the display data d0˜d3 for every line in the gradation current generation cluster set as the selection state among a set (pair) of gradation current generation circuit clusters like the control operations (FIG. 24 refers) in the first embodiment of the data driver mentioned above is performed. As sequential execution of the current generation supply operation integrates the module currents based on the display data d0˜d3 (inverted output signals d10*˜d13*), generates the gradation currents Ipix and supplies them to each of the display pixels, a series of operations is alternately executed by a set of gradation current generation supply circuit clusters 133K and 133L repeatedly.

Additionally, also in this embodiment, the individual gradation current generation circuit sections are set like the configuration in the first embodiment of the data driver mentioned above corresponding to each of the display pixels. Also, since the module currents corresponding to the display data can be selected and integrated by the gradation current generation circuit sections, the gradation currents can be generated and direct display of the pixels can be supplied. Even if it is the case where the display pixels are made to emit light by low gradation (when the current values of the gradation currents are low) or the case where the number of pixels in the display panel increases and high-resolution is performed (when the supply period of the gradation currents to the display pixels is set briefly) and the like, the influence of parasitic capacitance, such as the data lines, can be suppressed. Thus, the light generation operation of the display pixels can be performed by the appropriate luminosity gradation.

Furthermore, because the configuration regularly supplies the reference voltage generated from a shared (in common) single constant voltage source is applicable to the module current generation circuits relevant to the gradation current generation circuit sections and in comparison when applying the current mirror circuit configuration composed of the reference voltage generation circuit and the module current generation circuits for each of the display pixels (data lines), the number of functional devices, such as transistors can be reduced, the circuit configuration can be simplified, the circuit size of the data driver can be reduced, and abatement of the product cost can be promoted.

Since the gradation currents are generated in each of the gradation current generation supply circuit sections based on the reference voltage supplied from the constant voltage source, the reference voltage can be equalized and the variations in the gradation currents generated in each of the gradation current generation supply circuit sections can be controlled and migrate throughout the display panel. Also, the gradation currents having the appropriate current values corresponding to the display data can be supplied to the display pixels. As mentioned above, although the configuration in which the gradation current generation circuit sections are individually set corresponding to the data lines arranged by the display panel and set a single constant voltage source relative to all of the gradation current generation circuit sections is explained, the present invention is not restricted to this. For example, the display panel may be divided into a plurality of subsections and for each of a plurality of gradation current generation circuit sections be set corresponding to the data lines for each subsection and may be constituted so that a separate constant voltage source may be set.

<The Fifth Embodiment of the Data Driver>

Next, the fifth embodiment of the data driver applicable to the display device in the embodiments mentioned above will be explained with reference to the drawings.

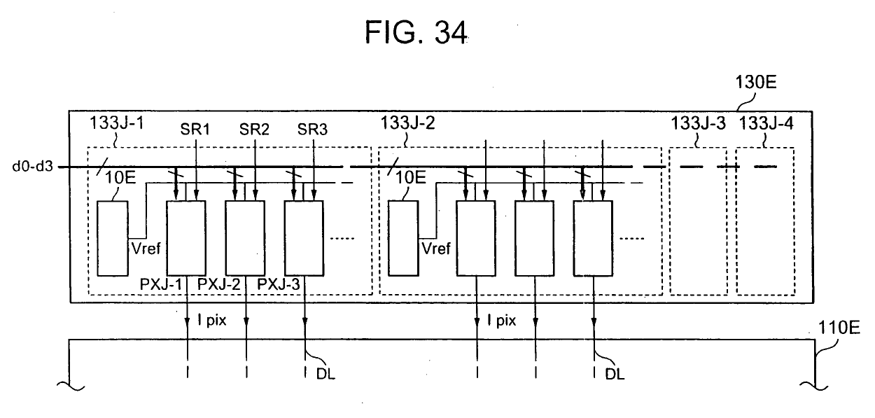

FIG. 34 is an outline configuration diagram showing the fifth embodiment of the data driver applicable to the display device related to the embodiments.

Here, concerning any configuration equivalent in the embodiments mentioned above, the same or equivalent nomenclature is appended and the explanation is simplified or omitted from the description.

The data driver 130E applicable to the current generation supply circuit according to this embodiment has a configuration designed with a plurality of sets comprising at least a combination composed of a plurality of the gradation current generation circuit sections comprising one reference voltage generation circuit and the gradation current generation supply circuit sections each shown in the above-mentioned embodiments for each of the data lines of a predetermined number.

In particular, for example, in the display panel 110E in which the display pixels are aligned in n rows×m columns and the m lines of the data lines DL are arranged to these display pixels, the display panel 110E is divided into a plurality of subsections for every data line of a predetermined number and has a configuration established with a plurality of gradation current generation circuit sections and one reference voltage generation circuit which are set corresponding to each of the data lines relative to each subsection.

For example, in the data driver 130E configuration as shown in FIG. 14, the display panel 110E is divided into four subsections for each of the data lines DL of a predetermined number (m/4) which are set to the gradation current generation supply circuit clusters 133J-1, 133J-2, 133J-3, 133J-4 (hereinafter denoted as the “gradation current generation supply circuit clusters 133J”) comprising a plurality of the gradation current generation supply circuit sections PXJ-1, PXJ-2, . . . (hereinafter denoted as the “gradation current generation supply circuit sections PXJ”) which are set for each subsection corresponds to each of the data lines DL; and the reference voltage generation circuit 10E which generates and applies the reference voltage Vref.

Here, a plurality of gradation current generation supply circuit sections PXJ established in each of the gradation current generation supply circuit clusters 133J, for example, comprise a set (pair) of the gradation current circuit sections identical to the configurations of the data driver shown in each of the above-embodiments and can be controlled in each of the gradation current generation circuit sections based on selection control signals to execute alternately the signal holding operation and current generation supply operation.

In this case, the shift register circuit, the selection setting circuit and the like which control the selection and operating state of each of the gradation current generation supply sections PXJ in each of the gradation current generation supply circuit clusters 133J, may be set so that they are exclusively shared (common architecture) to all of the gradation current generation supply circuit clusters 133J or may be set to each of the gradation current generation supply circuit clusters 133J.

Additionally, the reference voltage generation circuit 10E established in each of the gradation current generation supply circuit clusters 133J may have a configuration connected in common to one constant current generation source IR. Also, a configuration whereby each of the gradation current generation supply circuit clusters 133J are all connected to separate constant current generation sources is possible. According to the initial configuration, it is only necessary to set one constant current source IR to a plurality of the reference voltage generation circuits 10E (i.e., one each in 133J), miniaturization of the circuit size and reduction of the product cost can be promoted. Moreover, according to the latter situation in each of the gradation current generation supply circuit clusters 133J, because the wire length of the current supply source line between the constant current generation source IR and the reference voltage generation circuit 10E can be equalized, the gradation currents that equalize the reference current having more appropriate current values can be generated.

In addition, the configuration in which the reference voltage generation circuit 10E in each of the gradation current generation supply circuit clusters 133J is connected in common to a single constant current generation source IR, the switching circuit which controls the connection state of each constant current generation source IR and the reference voltage generation circuit 10E is established in each of the gradation current generation supply circuit clusters 133J. By selectively setting each of the gradation current supply generation circuit clusters 133J (reference voltage generation circuit) to which the reference current is supplied, it is possible to control the configuration so that the reference current does not flow into a plurality of the reference current generation circuits simultaneously. Accordingly, because the reference current can be controlled so that the current flows only into the reference voltage generation circuits of the gradation current generation circuit clusters 133J which execute the current generation supply operation, even if it is the case where the data driver comprises a plurality of the gradation current generation supply circuit sections, a power-saving architecture in the display device can be attained.

The control operations in the data driver 130E which has such as configuration, in the signal holding operation equivalent to the control operations (FIG. 24 refers) in the first embodiment of the data driver mentioned above, in the signal holding circuits DLA established in the gradation current generation sections PXJ of the gradation current generation supply circuit clusters 133J, an operation which sequentially takes in the display data d0˜d3 based on the shift signals SR1, SR1, SR2, SR3, . . . sequentially outputted from the shift register circuit 132 is continuously executed in one line periods corresponding to the column collating sequence (the order of the array of the data lines) in the display panel 110E.

For that reason, the inverted output signals d10*˜d13* from the signal holding circuits DLA are outputted to the gradation current generation sections PLA sequentially from the gradation current generation circuits PXJ where the display data d0˜d3 is originally taken in based on the inverted output signals d10*˜d13* from the above-mentioned signal holding circuits DLA.

Besides in the current generation supply operation when the selection transistor selectively performs an “ON” operation, the gradation currents Ipix are integrated and generated as the module currents which flow into the specified module current transistors and each of the display pixels are sequentially supplied via each of the data lines DL1, DL2, from each of the gradation current generation supply circuit sections PXJ.

Accordingly for example, the data driver comprises one reference voltage generation circuit to a plurality of the gradation current generation supply circuit sections. In considering the fact that wiring resistance may cause a decline in the reference voltage (that is, if the above-mentioned signal lines become too long) for each of the data lines of a predetermined number as described in the embodiment mentioned above, the design of the present invention suppresses the wiring resistance and prevents this electrical flow from becoming so large and problematic. Specifically, excessive wiring resistance in the signal lines which supply in common the reference voltage to each of the gradation current generation supply circuit sections by the reference voltage generation circuit cannot be ignored. Nevertheless, by applying the data driver which sets the gradation current generation supply circuit cluster comprising at least a plurality of gradation current generation supply circuit sections and one reference voltage generation circuit, the resistance equalizes as the wire length between the reference voltage generation circuit and each of the gradation current generation supply circuit sections in each of the gradation current generation supply circuit clusters is essentially shortened. Thus, the influence on the reference voltage from the wiring resistance is suppressed, the gradation currents having the appropriate current values corresponding to the display data can be supplied to each of the display pixels, variations in the light luminosity can be controlled and improvement in the display image quality can be promoted.

Particularly the detailed configuration of the gradation current generation supply circuits in the reference voltage generation circuit and the in the gradation current generation supply circuit sections in the embodiments is not restricted. For example, the configuration in each of the embodiments of the reference voltage generation circuit and current generation supply circuits in each embodiment of the above-mentioned current generation supply circuit are suitably applicable.

<The Sixth Embodiment of the Data Driver>

Next, the sixth embodiment of the data driver applicable to the display device in the embodiments mentioned above will be explained with reference to the drawings.

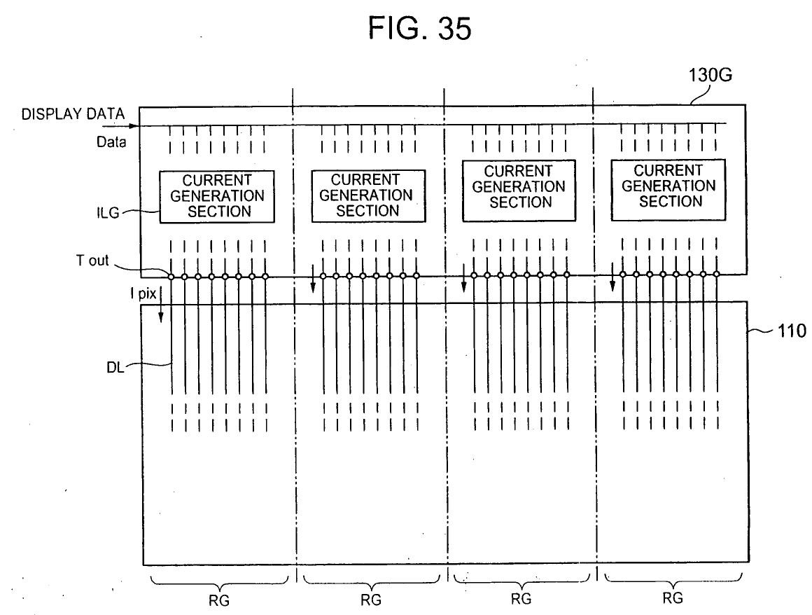

FIG. 35 is a configuration concept diagram showing the relationship of the data driver and the display panel in the sixth embodiment of the data driver applicable to the display device related to the embodiments.

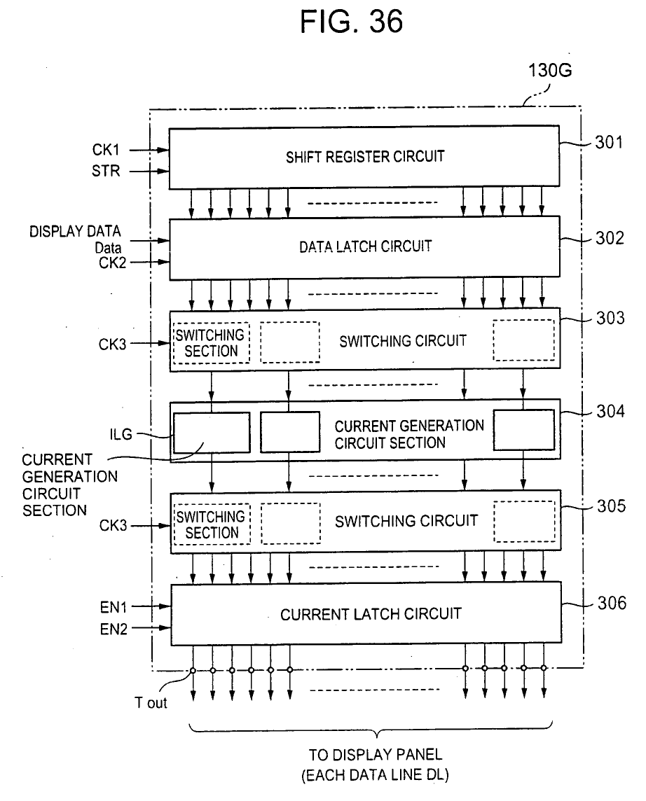

FIG. 36 is a block diagram showing the relevant sectional configuration in the sixth embodiment of the data driver related to the embodiments.

Accordingly, in the data driver 130G in this embodiment, as shown in FIG. 35, the display pixel clusters are aligned in the line writing direction (the drawing direction of the scanning lines of the display panel 110 which is divided into a plurality of subsections RG (for example, four subsections) having a plurality of the data lines DL (data line groups). By making into one group (block) a plurality of the output terminals Tout which are connected to the data line DL groups (Here, each subsection contains eight data lines) and arranged in each of the subsections RG, the data driver is constituted with one current generation circuit ILG for each group.

Specifically, the data driver 130G as shown in FIG. 36 has a configuration comprising a shift register 301, a data latch circuit 302, a switching circuit 303, a gradation current generation circuit 304, a switching circuit 305 and a current latch circuit 306. The shift register 301 sequentially outputs the shift signals SR1, SR2, . . . based on data control signals (shift clock signals CK1, sampling start signals STR, and the like) supplied from the system controller 140A and the like. The data latch circuit 302 (signal holding circuit) sequentially takes in the display data Data for one line periods supplied from the display signal generation circuit 150A based on the input timing of the shift signals SR and holds in parallel the display data Data for one line periods taken in as a plurality of digital signal bits based on data control signals (data latch signals CK2). The switching circuit 303 (input side switching circuit) selectively extracts the digital signals based on the display data Data held in the data latch circuit 132 for each of the display pixels based on data control signals (timing control signals CK3 and the like). The gradation current generation circuit 304 comprises a plurality of the current generation circuit sections ILG for generating the currents Ipxa having predetermined analog current values corresponding to the above-mentioned display data Data. The switching circuit 305 (output side switching circuit) sequentially switches the output destination of the current Ipxa generated by the gradation current generation circuit 304 for each of the display pixels based on data control signals (timing control signals CK3). The current latch circuit 306 holds in parallel the current Ipxa outputted to each other different output destination via the switching circuit 305 for each of the display pixels and simultaneously supplies each of the data lines DL via each of the output terminals Tout as gradation current Ipix at predetermined timing based on data control signals (output enable signals EN1, EN2 and the like). Here, each of the timing control signals are supplied from the system controller 140A and the like which are all of CK1˜CK3 and EN1, EN2 and have a signal period (signal frequency) based on the signal component (basic clock signals) extracted from the video signals by the display signal generation circuit 150A and the like.

Hereinafter, each configuration of the data driver will be explained in detail. Here, unless explained otherwise, a one block (equivalent to eight data lines) setting corresponding to the specified subsection of the above-mentioned display panel will be explained.

(The Shift Register Circuit/the Data Latch Circuit)

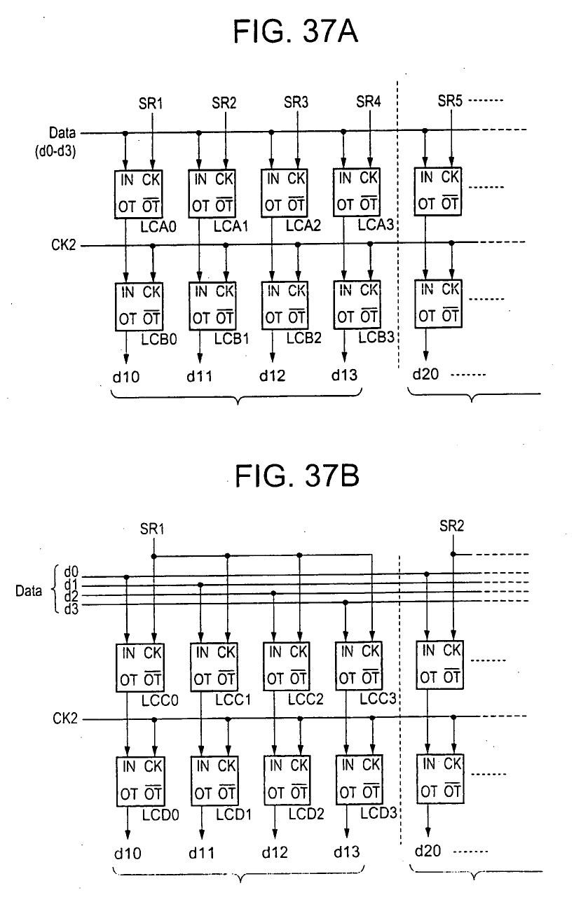

FIGS. 37A and 37B are outline configuration diagrams showing an example configuration of a data latch circuit applicable to the sixth embodiment of the data driver related to the embodiments.

The data latch circuit 302 in this embodiment which can be applied to the data driver, at timing based on the shift signals SR sequentially outputted from the shift register 301, the display data Data (digital signals d0˜d3 plurality of bits) supplied from the display signal generation circuit 150A mentioned above is taken in and held in parallel for each of the display pixels. Here, the display data Data supplied from the display signal generation circuit 150A, for example, creates one unit of a plurality of digital signal bits corresponding to each of the display pixels. One-bit (1-bit of serial data) of these digital signals is sequentially supplied in series and a digital signal packet (2-bits or more of parallel data) of the above-mentioned plurality of bits (n-bit packet) is supplied in parallel.

When the display data Data is supplied corresponding to each of the display pixels is 2-bits or more, the data latch circuit 302 as shown in FIG. 37A for example, this applicable configuration comprises a first stage of the latch circuit clusters LCA0, LCA1, LCA2, LCA3 (signal holding circuits) and a second stage of the latch circuit clusters LCB0, LCB1, LCB2, LCB3. The first stage of the latch circuit clusters LCA0, LCA1, LCA2, LCA3 (hereinafter denoted as “LCA0˜LCA3) individually take in one by one each of the digital signal bits d0, d1, d2, d3 (d0˜d3) supplied serially at predetermined timing based on the shift signals SR1, SR2, . . . and sequentially outputs from the shift register circuit 301; and the second stage of the latch circuit clusters LCB0, LCB1, LCB2, LCB3 (hereinafter denoted as “LCB0˜LCB3) separately take in and hold in parallel a plurality of digital signal bits d0˜d3 taken in by the first stage latch circuit clusters LCA0˜LCA3 and outputs simultaneously at predetermined timing, and is configured in parallel to each of the data lines DL (display pixels).

Also, when the display data Data consists of parallel data of a plurality of bits, the data latch circuit 302, for example as shown in FIG. 37B, this configuration comprises a first stage of the latch circuit clusters LCC0, LCC1, LCC2, LCC3 and a second stage of the latch circuit clusters LCD0, LCD1, LCD2, LCD3. the first stage latch circuit clusters LCC0, LCC1, LCC2, LCC3 (LCC0˜LCC3) individually take in a plurality of the digital signals d0˜d3 bits (4-bits) corresponding to the display data Data supplied in parallel at predetermined timing based on the shift signals SR1, SR2, . . . and sequentially outputs from the shift register circuit 301 like the latch circuit clusters LCB0˜LCB3 mentioned above, and the second stage of the latch circuit clusters LCD0, LCD1, LCD2, LCD3 (LCD0˜LCD3) separately take in and hold in parallel a plurality of digital signal bits d0˜d3 taken in by the first stage latch circuit clusters LCC0˜LCD3 and outputs simultaneously at predetermined timing, and is configured in parallel to each of the data lines DL (display pixels), and this applicable.

Here, in each of the latch circuits LCA0˜LCA3, LCB0˜LCB3, LCC0˜LCC3, LCD0˜LCD3 which constitute the data latch circuit 301 mentioned above, each of the digital signals d0˜d3 are input to the input terminals IN based on the display data Data. The shift signals SR1, SR2, . . . (timing control signals) are input to the clock terminals CK. The signals (non-inverted signals) having non-inverted polarity relative to the digital signals d0˜d3 are output via the non-inverted output terminal OT. The signals (inverted output signals) having inverted polarity relative to the digital signals d0˜d3 are output via the inverted output terminal OT*.

According to the data latch circuit 302 which has such a configuration, an operation sequentially takes in the display data Data (digital signals d0˜d3) corresponding to each of the display pixels with the first stage latch circuit clusters. The digital signals d0˜d3 (non-inverted output signals d10˜d13, d20˜d23, . . . ) of each display pixel block taken in and held at predetermined previous timing by the first stage latch clusters is transferred to the second state latch circuit clusters. Also, an operation which individually outputs in parallel to the gradation current generation circuit 304 via the switching circuit 303 described later is executed simultaneously in parallel (or set as the state in which output is possible).

(Switching Circuit)

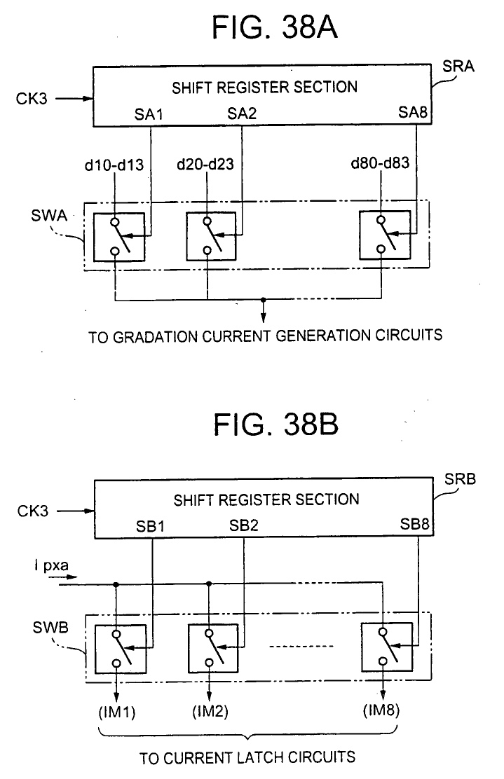

FIGS. 38A and 38B are outline configuration diagrams showing an example configuration of a switching circuit applicable to the data driver related to the embodiment.

The switching circuit 303 (input side switching circuit) applicable to this embodiment, for example as shown in FIG. 38A, has a configuration comprising a shift register section SRA and a switching section SWA. The shift register section SRA sets the timing when selectively taking the display data Data (non-inverted output signals d10˜d13, d20˜d23, . . . of a plurality of the digital signals d0˜d3 bits) individually taken in and held in display pixel blocks by the above-mention data latch circuit 302 to the gradation current generation circuit 304 which is set exclusively for every block. The switching section SWA controls the selection and the supply state of the digital signals d0˜d3 (non-inverted output signals) to the gradation current generation circuit 304 from the data latch circuit 302 based on the shift signals SA1, SA2, . . . sequentially outputted from the shift register section SRA.

Additionally, the switching circuit 305 (output side switching circuit), for example as shown in FIG. 38B, has a configuration comprising a shift register section SRB and a switching section SWB. The shift register section SRB sets the timing when selectively supplying the current storage circuit sections IM (IM1, IM2, . . . ) set to each of the data lines DL with the current Ipxa individually generated for every display pixel corresponding to the display data Data (non-inverted output signals d10˜d13, d20˜d23) in the gradation current generation circuit 304 described later. The switching section SWB controls the supply state of the current Ipxa from the gradation current generation circuit 304 to the current latch circuit 306 (each of the current storage circuit sections IM) based on the shift signals SB1, SB2, . . . sequentially outputted from the shift register section SRB.

Here, in this embodiment, the shift register sections SRA, SRB are established in each block of the data driver 130G corresponding to the specified subsections RG of the display panel. Although in the configuration which selectively performs an “ON” operation of the switching sections SWA, SWB by the shift signals SA1, SA2, . . . and SB1, SB2, . . . from the shift register sections SRA, SRB is described, the present invention is not limited to this. Corresponding to all the subsections RG, a single shift register section may be set in each other of the switching circuits 303 and 305 or may also be constituted so that the shift signals outputted from the shift register section can be supplied in common to each block.

According to the switching circuits 303 and 305 which have such a configuration, based on data control signals supplied from the system controller 140A and the like, the shift signals are sequentially outputted from each of the shift register sections SRA, SRB. As the switching section SWA switches and controls so that the display data Data (non-inverted output signals d10˜d13 of a plurality of the digital signals d0˜d3 bits) which was taken and held in the data latch circuit 302 corresponding to the specified display pixels is selectively outputted to the gradation current generation circuit 304, the switching section SWB switches and controls so that the current Ipxa is generated corresponding to the display data Data in the gradation current generation circuit 304 which is set corresponding to the specified display pixels.

Further, even though the configuration sets both sides of the switching circuits 303, 305 with individual shift register sections SRA, SRB is explained in the embodiment, the present invention is not restricted to this. Namely, in the switching circuits 303, 305, because of the supply operation to the gradation current generation circuit 304 of the specified display data Data and output operation to the current latch circuit 306 (current storage circuits IM) of the currents Ipxa generated in the gradation current operation circuit 304 can also be executed to the same timing, the shift signals outputted from a single shift register may be applied as switching changeover signals to both sides of the switching circuits 303, 305.

(Gradation Current Generation Circuit)

The gradation current generation circuit 304 applicable to this embodiment has the configuration corresponding to each subsection of the display panel 110 comprising a single current generation circuit ILG for each block, as shown in FIG. 35.

Each of the current generation circuits ILG takes in the display data Data (non-inverted output signals d10˜d13 outputted from the non-inverted output terminal of each latch circuit which constitutes the data latch circuit mentioned above) for every display pixel selectively extracted from the above-mentioned latch circuit 302 via the switching circuit 303, generates the current Ipxa (equivalent to the gradation current Ipix described later) having current values corresponding to the above-mentioned display data Data (accordingly, non-inverted output signals d10˜d13) based on the predetermined reference current Iref and constituted to output to the current latch circuit 306 (the current storage circuits IM individually set for every data line DL) described later via the switching circuit 305.

Furthermore, this embodiment is constituted so that the reference current Iref can be supplied to each of the current generation circuits ILG from the constant current generation source IR. Here, the constant current generation source IR may also be set exclusively to the current generation circuits ILG of all blocks which constitute the gradation current generation circuit 304 and may be set separately for each of the current generation circuits ILG of each block. Further, the constant current generation source IR may be set exclusively for each of a plurality of blocks.

In view of that, at timing based on shift signals SR1, SR2, outputted from the shift register circuit 301, the display data Data (plurality bits of the digital signals d0˜d3) for every display pixel supplied to the data latch circuit 302 is individually taken in and held in parallel from the display signal generation circuit 150 and the like. Based on the switch timing of the switching circuit 303, each display pixel block of the non-inverted output signals d10˜d13 are sequentially selected and input into the gradation current generation circuit 304. Based on the bit values of the non-inverted output signals d10˜d13, the currents Ipxa composed of analog currents having predetermined current values will be generated by the current generation circuits ILG and outputted to the final stage current latch circuit 306.

Also, the configuration of the current generation circuit ILG in the gradation current generation circuit 304 is not particularly limited. The composition in each embodiment of the current generation circuit in each embodiment of the above-mentioned current generation supply circuit can be suitably applied and can be employed as any current application or current sink type.

(Current Latch Circuit)

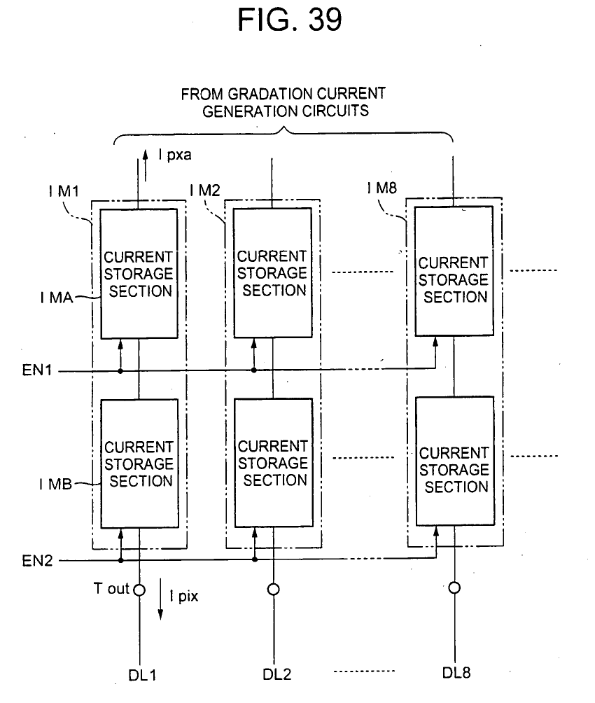

FIG. 39 is an outline configuration diagram showing the first embodiment of a current latch circuit applicable to the data driver related to the embodiments.

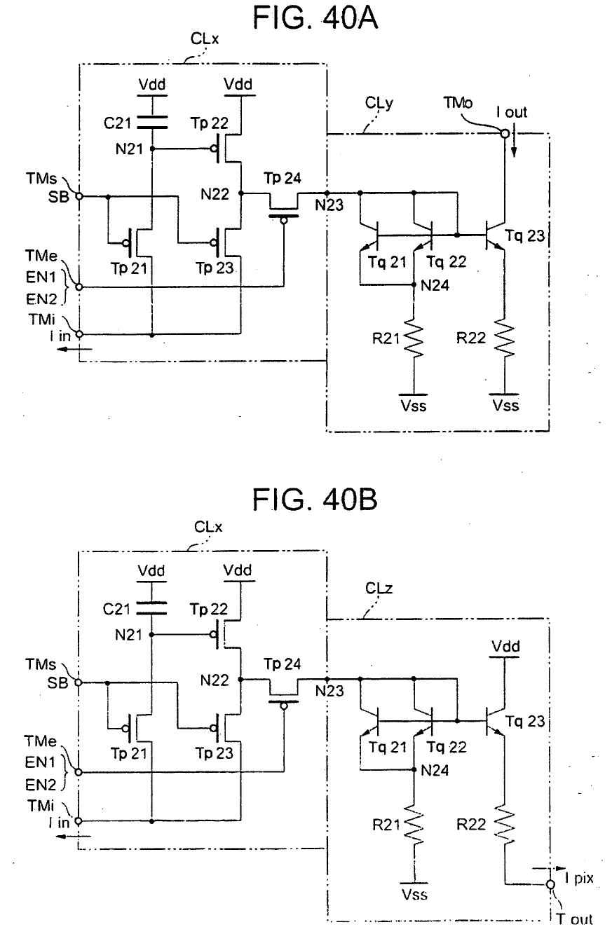

FIGS. 40A and 40B are circuit configuration diagrams showing an example of the current storage sections applicable to the current latch circuits related to the embodiments.

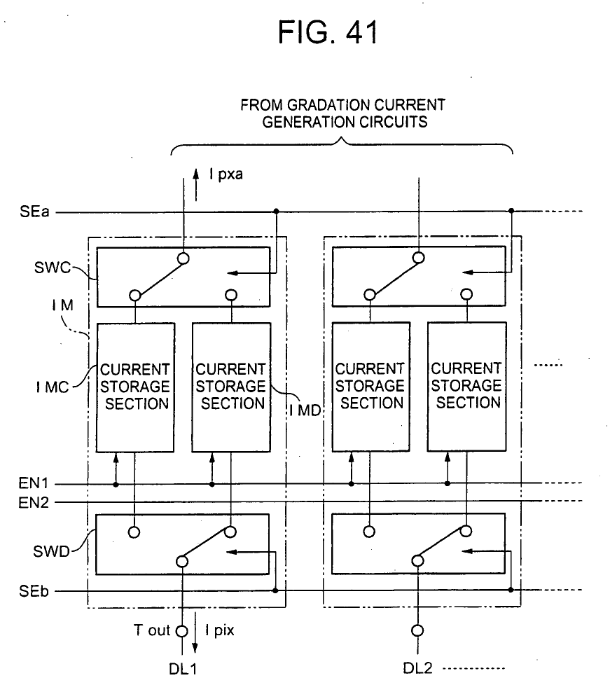

FIG. 41 is an outline configuration diagram showing the second embodiment of the current latch circuits applicable to the data driver related to the embodiments.

Even though the case where the configuration of the current latch circuit is used as the current application type is illustrated here, it is emphasized that the present invention is not limited to this and can be used as the current sink type.

The first embodiment of the current latch circuit 306 according to this embodiment, as shown in FIG. 39, the current storage sections IMA, IMB (first current storage section, second current storage section) are set up in two stages and connected in series for every output terminal Tout to which each of the data lines DL (display pixels) is connected. Additionally, this configuration comprises an operation for sequentially holding the current Ipxa (current storage operation) for every display pixel generated and outputted by the above-mentioned gradation current generation circuit 304 to each of the current storage sections IMA in the first stage corresponding to the switch timing of the switching circuit 305; and an operation (current output operation) for simultaneously outputting the current Ipxa transferred to each of the current storage sections IMB of the second stage from each of the above-mentioned first stage current storage sections IMA to each of the data lines DL as the gradation currents Ipix via the output terminals at predetermined timing, and are constituted so that these operations can be executed in parallel.

The current latch circuit 306 according to this embodiment, specifically as shown in FIG. 39, has a configuration comprising the first current storage sections IMA and the second current storage sections IMB. The first current storage sections IMA (current latch circuit) output to transfer the held currents based on the output enable signals EN1 supplied from the system controller 140A and the like, for example, signals which take in and hold the currents Ipxa selectively supplied at predetermined timing via the switching circuit 305 from the current generation circuits ILA set exclusively for every block and are set to two stages in series for every output terminal Tout connected each of the data lines DL1, DL2, . . . . The second current storage sections IMB (current latch circuit) output as the gradation currents Ipix to each of the data lines DL DL1, DL2, . . . via each output terminal Tout based on the output enable signals EN2 supplied from the system controller 140A and the like which take in and hold the currents transferred from the current storage sections IMA. Thus, these constitute plurality of the current storage circuit sections IM1, IM2, . . . .

Specifically, the current storage sections IMA, IMB, as shown in FIG. 40A and FIG. 40B for example, the circuit configuration comprises the current component holding sections CLx and the current mirror circuit sections CLy and CLz. The current component holding sections CLx (switching section SWB is included) generates the predetermined control current based on the current Ipxa. The current mirror circuit sections CLy or CLz generates the gradation currents Ipix outputted to the output currents or each of the data lines DL to the current storage sections IMB of the following (second) stage based on the above-mentioned control currents.

The current component holding sections CLx, as shown in FIG. 40A for example, has a configuration comprising a p-channel type transistor Tp21, a p-channel transistor Tp22, p-channel type transistor Tp23, a storage capacitor C21 and a p-channel type transistor Tp24. The p-channel type transistor Tp21 by which the current path (source-drain) is connected each other between the input terminal TMi where the input signals Iin (The currents Ipxa supplied from the gradation current generation circuit 304 when being applied to the first stage current storage sections IMA; and in being applied to the second stage current storage sections IMB then becomes the output currents Iout supplied from the first stage current storage sections IMA) are supplied and the contact N21. The gate terminal is connected to the shift terminal TMs where the shift signals SB1, SB2, . . . (SB) from the shift register SRB of the switching circuit 305 mentioned above are inputted. The p-channel type transistor Tp22 by which the current path is connected each other between the high electric potential Vdd and the contact N22 along with the gate terminal connected to the contact N21. The p-channel type transistor Tp23 by which the current path is connected each other between the contact N22 and the above-mentioned input terminal TMi along with the gate terminal connected to the above-mentioned shift terminal TMs. The storage capacitor C21, is connected each other between the high electric potential Vdd and the contact N21. The p-channel type transistor Tp24 by which the current path is connected each other between the contact N22 and the output contact N23 to the current mirror circuit sections CLy of the latter (second) stage. The gate terminal is connected to the gate terminal TMe where the output enable signals EN1 and EN2 for controlling the output state of the control currents to the current mirror circuit sections CLy of the latter stage are inputted.

Here, the p-channel type transistors Tp21 and Tp23 perform “ON/OFF” operations as well as constitute the switching section SWB of the switching circuit 305 (output side switching circuit) mentioned above based on the shift signals SB1, SB2, . . . from the shift register SRB.

Also, the storage capacitor C21 established between the high electric potential Vdd and the contact N21 is a parasitic capacitor installed between the gate-source of the p-channel type transistor Tp22.

The current mirror circuit sections CLy established in the first stage of current storage sections IMA, for example as shown in FIG. 40A, have the configuration comprising the NPN type bipolar transistors Tq21 and Tq22, a resistance R21, an NPN transistor Tq23 and a resistance R22. The NPN type bipolar transistor Tq21, Tq22 by which the collector and base are connected in common to the output contact N23 of the above-mentioned current component holding sections CLx along with the emitter connected to the contact N24. The resistance R21 (resistor) is connected between the contact N24 and the low electric potential Vss. The NPN transistor Tq23 by which the collector is connected to the output terminal TMo where the output currents Iout to the current storage sections IMB of the second stage are outputted along with the output contact N23 of the above-mentioned current component holding section CLx is connected to the base. The resistance R22 is connected between the emitter of the NPN transistor Tq23 and the low electric potential Vss.

Furthermore, the current mirror circuit sections CLz, for example as shown in FIG. 40B, established in the current storage sections IMB of the second stage have a contrasting configuration whereby the emitter is connected to the output terminal Tout where the gradation currents Ipix are outputted via the resistance R22 along with the collector of the NPN transistor Tq23 connected to the high electric potential Vdd.

Moreover, when using the configuration of the current latch circuit as the current sink type, the equivalent configuration as the structure of the current mirror section established in the second state current storage sections IMB as the current mirror circuit sections CLy shown in FIG. 40A can be applied.

Here, the output terminals TMo, Tout of the current storage sections IMA, IMB and the output currents Iout, Ipix having current values corresponding to predetermined current ratios specified by the current mirror circuit configuration relative to the current values of the control currents inputted via the output contact N23 from the above-mentioned current component holding sections CLx. In the current storage sections IMB according to the embodiments, by supplying positive polarity to the output terminal Tout, the current component is set so that the gradation currents Ipix will flow in the direction of each of the data lines DL (display pixels) from the current storage circuits section IM side.

Referring to FIGS. 40A and 40B, the current storage sections shown as examples applicable to the current latch circuit 306 in their embodiment, the present invention is not limited to these circuit configurations.

In the embodiments, although the configuration comprises the current component holding sections CLx and the current mirror circuit sections CLy and the current mirror circuit sections CLy, CLz are shown as the current storage sections IMA, IMB, the present invention is not restricted to this. The circuit configuration comprising only the current component holding sections CLx can be applied and the above-mentioned control currents can be outputted as the output currents Iout or directly as the gradation currents Ipix.

In the current storage sections IMA, IMB which have such a configuration, in the current storage operation, the high-level output enable signals EN1, EN2 are applied via the output control terminal TMe from the system controller 140A and the like. As the currents Ipxa having analog current values corresponding to the display data Data (digital signals d0˜d3) are supplied via the input terminal TMi from the gradation current generation circuit 304, the low-level shift signals SB1, SB2, . . . (switch changeover signals) are applied at predetermined timing via the shift terminals TMs from the shift register section SRB of the switching circuit 305.

Accordingly, in order for the p-channel type transistor Tp24 as the output control means to perform an “OFF” operation and the p-channel type transistors Tp21, Tp23 as the switching sections SWB to perform an “ON” operation, the voltage level of a low potential level corresponding to the currents Ipxa having negative polarity at the contact N21 (Namely, the gate terminal of the p-channel type transistor Tp22 and one end side of the storage capacitor C21) is applied. An electrical potential difference occurs between the high electric potential Vdd and the contact N21 (between the gate-source of the p-channel type transistor Tp22) and the p-channel type transistor Tp22 performs an “ON” operation. The write-in currents equivalent to the currents Ipxa flow in the direction of the input terminal TMi via the p-channel type transistors Tp22, Tp23 from the high electric potential Vdd.

At this time, in storage capacitor C21, the electrical charge corresponding to the electrical potential difference generated between the high electric potential Vdd and the contact N21 (between the gate-source of the p-channel type transistor Tp22) is stored and held as the voltage component. Here, the electrical charge (voltage component) stored in the storage capacitor C21 upon completion of the current storage operation, the p-channel type transistors Tp21, Tp23 perform an “OFF” operation and after the above-mentioned write-in currents are suspended is held.

Furthermore, in the current output operation, the p-channel type transistor Tp24 performs an “ON” operation by applying the low-level output enable signals EN1, EN2 via the output control terminal TMe from the system controller 140A and the like. At that time, due to an electrical potential difference equivalent to occurring in the above-mentioned current storage operation time between the gate-source of the p-channel type transistor Tp22 from the voltage component held in the storage capacitor C21, the control currents having current values equivalent to the above-mentioned write-in currents (same as currents Ipxa) flow in the direction of the output contact N23 (current mirror circuit sections CLy) via p-channel type transistors Tp22, Tp24 from the high electric potential Vdd.

Thus, the control currents supplied to the current mirror circuit sections CLy is converted into the output currents or gradation currents corresponding to the predetermined current ratios specified by the current mirror circuit configuration, and is supplied to the second stage current storage sections IMB or the data lines DL via the output terminal TMo. Here, the supply of the gradation currents outputted from the current storage circuits IMB is suspended when the p-channel type transistor Tp24 performs an “OFF” operation and applied with the high-level output enable signals EN2 via the output control terminal TMe from the system controller 140A and the like.

Therefore, by sequentially outputting the shift signals SB1, SB2, . . . from the shift register section SRB to the switching section SWB (Referring to FIG. 38B) individually set to each of the current storage circuits IM, each of the switching sections SWB selectively performs an “ON” operation only for the predetermined period, and the currents Ipxa supplied from the gradation current generation circuit 304 are sequentially written in the first stage current storage sections IMA set corresponding to each of the data lines DL. The currents Ipxa written and held in each of the first state current storage sections IMA at predetermined timing from the system controller 140A and the like is simultaneously outputted to the second stage current storage sections IMB by supplying in common the output enable signals EN1.

The currents Ipxa already (at previous timing) transferred and held are simultaneously outputted to each of the current storage sections IMB as the gradation currents Ipix via each output terminal Tout by supplying in common the output enable signals EN2 to all of the second stage current storage sections IMB at predetermined timing from the system controller 140A and the like which synchronizes with the operation that writes-in the currents Ipxa to the above-mentioned first stage current storage sections IMA.

Consequently, the current storage operation in the first stage current storage sections IMA and the current output operation in the second stage current storage sections IMB are continuously executed by repeating and executing a series of the above-mentioned operations for every predetermined operational period.

Although the current storage sections IMA, IMB which constitute the current storage circuits IM described the configuration connected with two stages in series in the embodiment mentioned above, the present invention is not restricted to this structure and other configurations can be applied. For example, as shown in FIG. 41, while executing the operation which writes the currents Ipxa generated by the gradation current generation circuit 304 in one of the current storage sections (Referring to the current storage sections IMC in FIG. 41) by switching and controlling the changeover switches SWC and SWD based on the control signals SEa and SEb supplied from the system controller 140A and the like, and arranged in parallel with a pair of the current storage sections IMC, IMD, the configuration is designed to execute the operation which outputs the currents Ipxa held at previous timing via the output terminal Tout as the gradation current Ipix to the other current storage section (Referring to the current storage sections IMD in FIG. 41). In this case, the configuration composed of the current component holding sections CLx and the current mirror circuit sections CLz as shown in FIGS. 40A and 40B as the circuit configuration of the current storage sections IMC, IMD is applicable.

Also in this case, when using the configuration of the current latch circuits as the current sink type, the same configuration as the structure of the current mirror circuit section as the current mirror section CLy in FIG. 40A is appropriate.

(The Drive Control Method of the Display Device)

Next, the drive control method of the display device which has the data driver configuration mentioned above will be explained with reference to the drawings.

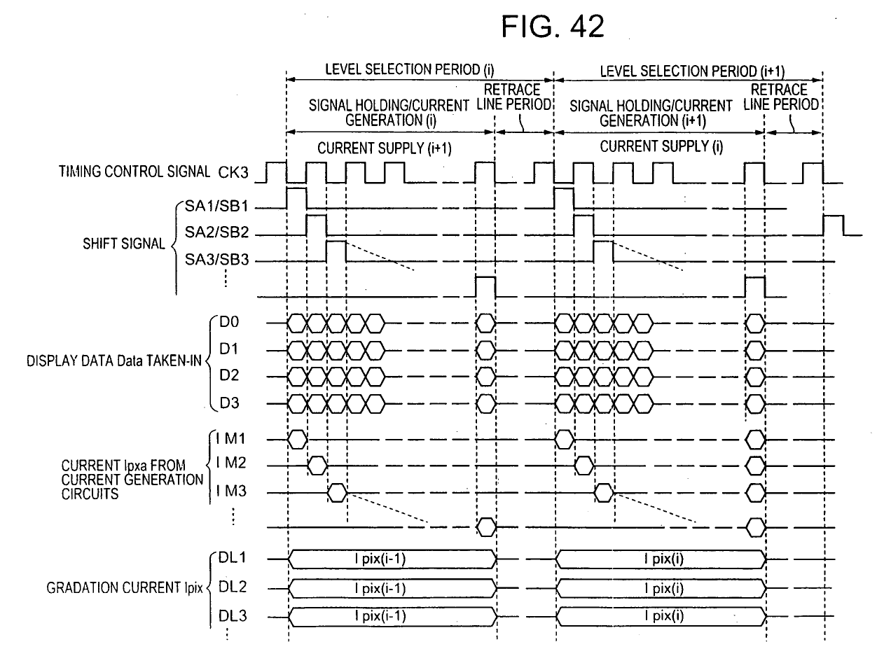

FIG. 42 is a timing chart showing an example of the control operations in the sixth embodiment of the data driver related to this embodiment.

Here, explanation will refer suitably to the configuration of the data driver as shown in FIG. 36 through FIG. 41.

First, the control operations in the data driver 130D are executed by setting while the display data Data (plurality of digital signals d0˜d3 bits) is supplied to each latch circuit 302 mentioned above from the display signal generation circuit 150A and the like that is taken in and held, the signal holding operation which sets the non-inverted output signals d10˜d13, d20˜d23, . . . as the state in which constant period output is available based on the display data Data (digital signals d0˜d3) the current generation operation sequentially generates the currents Ipxa corresponding to the above-mentioned display data Data (digital signals d0˜d3) with the current generation circuits ILA set for every block (each partitioned subsection RG of the display panel 110) in the gradation current generation circuit 304 based on the non-inverted output signals d10˜d13, d20˜d23 of the display pixel blocks outputted from the data latch circuit 302; and the current supply source operation after sequentially holding in the current storage circuits IM1, IM2, . . . sets every one of each of the data lines DL1, DL2, . . . in the current latch circuit 306 and simultaneously supplies each of the display pixels with the gradation currents Ipix via each of the data lines DL1, DL2, . . . . Also, as the signal holding operation, the current generation operation and the current supply source operation are executed in parallel in the period except the retrace period within one horizontal selection period, a series of operations are executed for each block unit. Hereinafter, operation in each block will be explained.

In the signal holding operation, as shown in FIG. 42, with the above-mentioned data latch circuit 302 (each latch circuit) and based on the shift signals SR1, SR2, SR3, . . . sequentially outputted from the shift register circuit 301, the operation sequentially takes in the display data Data (digital signals d0˜d3) which changes corresponding to the display pixels of each line and is continuously executed in one line periods. As packet holding of the display data Data (digital signals d0˜d3) is being taken in individually in parallel as mentioned above based on the timing signals CK2 supplied to the data latch circuit 302, the operation is set as the output available state.

Here, when the display data Data is a 1-bit serial digital signal, the digital signal is taken in for each bit and held in parallel as display pixel units, and when the display data Data is 2-bits or more (plurality) parallel digital signal, the digital signal is held in parallel as unchanged display pixel units. Therefore, when the display data Data of a 1-bit serial digital signal is taken in, as compared with the case of a 2-bit or more parallel digital signal is taken in, it is necessary to set briefly (Namely, the signal frequency of the shift clock signals CK1 which specifies operation of the shift register circuit 301 as high) the output period of the shift signals SR1, SR2, . . . from the shift register circuit 301.

Furthermore, the current generation operation as shown in FIG. 42, by timing (the shift signals SA1, SA2, . . . which are sequentially outputted from the shift register section SRA) based on the timing control signals CK3 supplied from the switching circuit 303, the non-inverted output signals d10˜d13, d20˜d23, . . . of the display data Data held in each display pixel unit in the data latch circuit 302 are selectively extracted. Then, the predetermined module currents are selectively integrated by the current generation circuits ILA set exclusively for every block of the gradation current generation circuit 304 based on these non-inverted output signals. These composite currents (currents Ipxa) are sequentially held and supplied to the current storage circuits IM1, IM2, . . . (the first stage current storage sections IMA) and set corresponding to each of the display pixels of the current latch circuit 306 by the timing (the shift signals SB1, SB2, . . . which are sequentially outputted from the shift register section SRB) based on the timing control signals CK3 supplied to the switching circuit 305.

In the current supply source operation, as shown in FIG. 42, based on the output enable signals EN1 supplied to the current latch circuit 306, the currents Ipxa held for every display pixel mentioned above in the first stage of the current storage sections IMA are transferred to the second stage of the current storage sections IMB at least by block units. Then, based on the output enable signals EN2, the currents Ipxa held for every display pixel mentioned above are supplied as each of the display pixel packets in parallel via each of the data lines DL as the gradation currents Ipix.

Here, the current supply source operation which supplies simultaneously the gradation currents Ipix relative to each of the display pixels of the i-th line, as shown in FIG. 42, is executed by synchronizing with the signal holding operation which takes in the display data Data corresponding to each of the display pixels in the i-th line (i+1) and the current generation operation which generates the currents Ipxa (composite currents) corresponding to the display data Data.

<The Pattern Layout Method>

Next, the layout (arrangement) method of the circuit pattern of the current mirror circuit configuration in making the reference voltage generation circuit and the current generation circuit in the current generation supply circuit according to the embodiments will be explained with reference to the drawings.

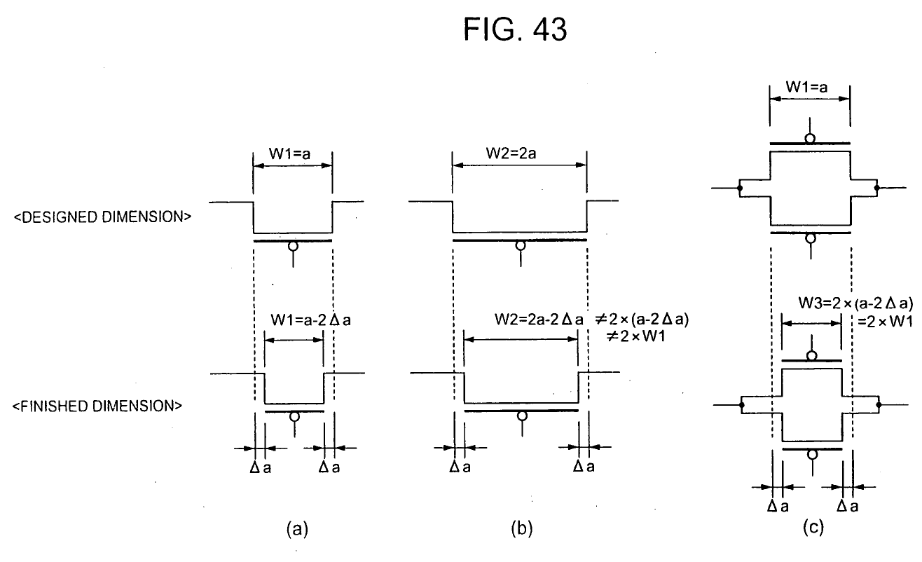

FIG. 43 is a conceptual diagram showing the effects of dimensional variation differences in the manufacturing process of Field-Effect Transistors.

As mentioned above, the reference voltage generation circuit and the current generation circuit in the current generation supply circuit according to the embodiments constitute the current mirror circuit. Furthermore, they are configured so that the module currents Isa˜Isd have current values of different current ratios with each other which can be selectively integrated relative to the reference current Iref based on a plurality of digital signal bits, and the drive currents can be generated.

Also, the current ratio (current values) of the module currents are specified by the channel width of Field-Effect Transistors which constitute the reference current transistor and the module current transistors as mentioned above.

Here, when examining the relationship (dimensional variation differences) of the design dimension and the finished dimension in the manufacturing process of a Field-Effect Transistor (Thin-Film Transistor), in the manufacturing process of an integrated circuit it is well-known the finished dimension will deviate to some extent relative to the layout dimensions by dimension shifts based on the amount of side etching, alignment differences, mask alignment slippage and the like in the etching production process. For example, as shown in FIG. 43, when the layout dimension of the channel width of the Field-Effect Transistor (Here, a p-channel type transistor is shown.) is set to W1=a, the gap of only −Δ occurs from the dimensional shift in each other of both sides in the channel width direction of a Field-Effect Transistor, the dimensional variation difference of 2×Δa is produced in general and the finished dimension is set to W1=a−2Δa. This dimensional variation difference has a characteristic that is very difficult to rectify with the layout method since it is very small as compared with the transistor size.

Also, this dimensional variation difference does not pertain to the transistor size (channel width) but serves as a constancy value. When the same process is used for this dimensional variation difference, for example as shown in FIG. 43, even if it is the case where the layout dimension of the channel width is set to W2=2a, the dimensional variation difference of −2Δa occurs which is equal to the case mentioned above and the finished dimension is set to W2=2a−2Δa. Therefore, when the channel width of the Field-Effect Transistor differs the degree of influence on the dimensional variation differs, and it will be greatly influenced by the dimensional variation difference to the extent that the channel width is reduced. In the current generation supply circuit (current mirror circuit) mentioned above concerning the very small current values of the drive currents, their characteristics will deviate from the proper drive state and the linearity of the display luminosity will be impaired as the display gradation becomes low gradation when applied to the data driver of the display device mentioned above.

Further, in the manufacturing process of an integrated circuit, even if it is within the same wafer or the substrate generally it is known that due to processing variations non-uniformity in the conditions will occur, such as film thickness, film characteristics, alignment accuracy, temperature in the manufacturing process, fluid density and the like. Therefore, even if it is a Field-Effect Transistor type of the same transistor size, according to the arrangement position on the substrate, variation occurs in the device characteristics. When applied to the current generation supply circuit (current mirror circuit sections) in the case mentioned above, such a Field-Effect Transistor impairs the linearity in the drive state of the loads. For example, the data driver of the display device comprises a plurality of such current generation supply circuits and the circuit characteristics between the current generation supply circuits may also become uneven.

Therefore, in order to suppress the influence of the dimensional variation differences mentioned above or the processing variations in the present invention, the Field-Effect Transistors (the reference current transistor and the module transistors) which constitute the current mirror circuits in the current generation supply circuit, the present invention by using Field-Effect Transistors having the minimum standard transistor size (channel width) by means of a plurality of parallel connections of these standard transistors thereby has a configuration arrangement so as to have a pattern layout comprising Field-Effect Transistors having the desired channel widths and applied to a plurality of the above-mentioned standard transistors in what is termed a common centroid shape (form) or corresponding type.

Accordingly, for example as shown as (a) in FIG. 43, the Field-Effect Transistor which has a channel width of W1=a is set as the transistor (standard transistor) of the standard having minimum size. As shown as (b) in FIG. 43, the channel widths constitutes a plurality of folds (W2=2a) of the Field-Effect Transistors. As shown as (c) in FIG. 43 illustrates connecting a plurality (2 components) of these standard transistors in parallel. Consequently, the channel width of each standard transistor is constant at W1=a even in the case where a plurality are connected in parallel. The dimensional variation difference occurring in each standard transistor always functions at 2Δa.

Therefore, as (a) shown in FIG. 43, the channel widths in this invention are set to two or more folds (2×). Namely, W3=2×(a−2Δa)=2×W. Even if it is the case where the channel widths of the Field-Effect Transistors differ, the influence of the dimensional variation difference becomes constant. Accordingly, satisfactory linearity can be given to the relationship of the current values of the drive currents relative to the designated gradations when it applies to the data driver of the display device.

Here, as shown as (c) in FIG. 43, although the case where the channel widths are set 2 fold (2×) of the basic standard transistor is illustrated, as mentioned above, when setting 2k (k=2, 4, 8, . . . ) fold of two or more channel widths, each other is connected in parallel to the above-mentioned standard transistors 2, 4, 8, . . . .

Additionally, processing variations having a specified inclination (one-dimensional skewed distribution) are generally known and the common centroid shape is known as the method of suppressing the influence on the device characteristics by such processing variations. That is, the device elements (the layout size of the device and the device arrangement orientation are the same) arranged in positions which are symmetrical (axial symmetry, point symmetry) to the specified reference point, similar to one-dimensional skewed distribution of the above-mentioned processing variations, various kinds of parameters and characteristics can be considered as changes to the symmetry relative to the above-mentioned reference point. In view of that for example, because the characteristic P+Δ P is obtained with one device and the characteristic P−Δ P is obtained with the device of the other when these characteristics are acquired in the reference point, like one-dimensional distribution variations are cancelable by connecting these devices in parallel (offset). Such a pattern layout method is called the common centroid shape, for example, it is applicable to form of a differential pair of a differential amplifier circuit or a capacitor.

<The First Embodiment of the Pattern Layout Method>

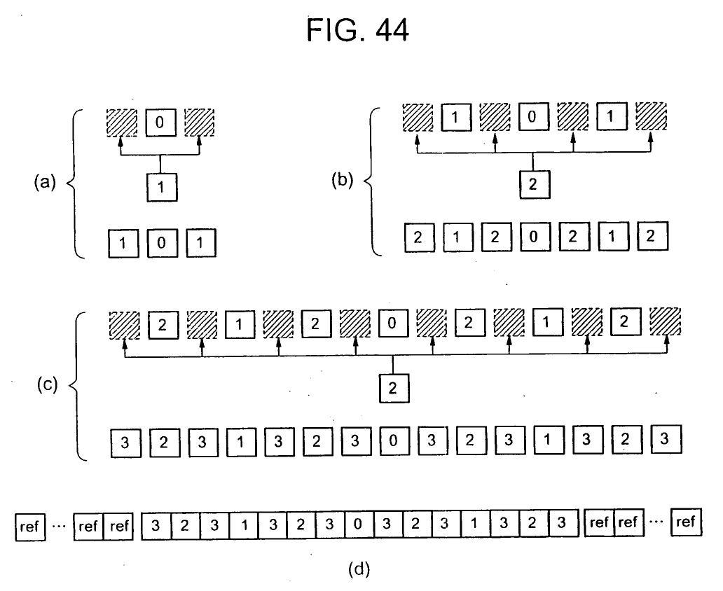

FIG. 44 are conceptual diagrams showing the first embodiment layout method of a standard transistor which constitutes the current mirror circuit in the current generation supply circuit related to the embodiments.

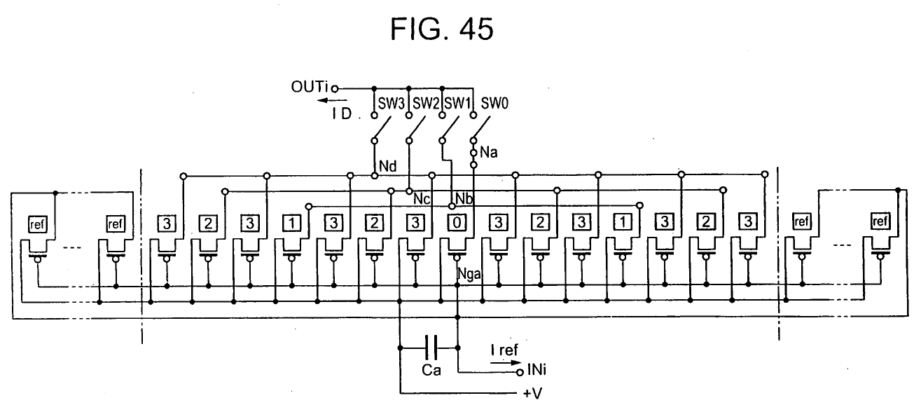

FIG. 45 is a circuit configuration diagram showing the first embodiment arrangement and connection pattern of the standard transistors which constitute the current mirror circuits in the current generation supply circuit related to the embodiments.

As for the following, as shown in FIG. 2 for example, although the layout method of the circuit pattern in the case of constructing the module current generation circuits 21A comprising the module current transistors Tp12˜Tp15 and the reference voltage generation circuit 10A comprising the reference current transistor Tp11 is explained, the present invention is applicable to the current generation supply circuit of not only this but each embodiment mentioned above.

Also, the module current transistors Tp12 which generate the module currents Is a by which selection control is performed with the digital signals d0 (or the inverted output signals d10*) that are taken in to the signal holding circuits DLA and held is set as the transistor (standard transistor) of the standard which has the lowest measurements. This is the case so that respectively the current values of the other module currents Isb, Isc and Isd can be 2 (=2¹) fold, 4 (=2²) fold, 8 (=2³) fold.

The layout method of the current mirror circuit component placement according to the embodiments and as shown as (a) in FIG. 44, firstly, the standard transistor which constitutes the module current transistor Tp12 (referred as “0 in the drawing; hereinafter denoted as “transistor “0) and corresponds to the bit (1^{st} bit) of the digital signal d0 (referring to the diagram) arranged to the predetermined reference position. The two standard transistor which constitutes the module current transistor Tp13 (referred as “1 in the drawing; hereinafter denoted as the “transistor “1) and corresponds to the bit (2^{nd} bit) of the digital signal d1 on both sides (left and right sides in the drawing) of the transistor “0 is each arranged.

Secondly, as shown as (b) in FIG. 44, the four standard transistor which constitutes the module current transistor Tp14 (referred as “2 in the drawing; hereinafter denoted as “transistor “2) and corresponds to the bit (3^{rd} bit) of the digital signal d2 with the transistors “0 and “1 respectively placed in position (transistors “0 and each on both sides “1) is each arranged. Thirdly, as shown (c) in FIG. 44, the eight standard transistor which constitutes the module current transistor Tp15 (referred as “3 in the drawing; hereinafter denoted as “transistor “3) and corresponds to the bit (4^{th} bit) of the digital signal d3 respectively placed in position with the transistors “0, “1 and “2 (each on both sides of transistors “0, 1 and “2) is each arranged.

In addition, although becoming the transistor arrangement as shown in FIG. 44 when the 4-bit digital signals d0-d3 are prepared as the input signals, if there are more digital signal bits the above-mentioned pattern layout method is followed and responds so that the operation further arranges the standard transistor corresponding to the high-order bits to be repeated.

Next, as shown as (d) in FIG. 44, the predetermined number of standard transistors (referred as “ref” in the drawing; hereinafter denoted as “transistor “ref”) which constitute the reference current transistor Tp11 are positioned with half on both outer sides of the standard transistor clusters (standard transistor clusters which constitutes the module current transistors) and sequentially arranged.

Here, the transistor “ref” arrangement is set as shown in FIG. 44D. Although the configuration has arranged some standard transistors consecutively is shown, the present invention is not limited to this. As long as the transistors are in positions which compose the axial symmetry relative to the transistor “0 arranged in the reference position mentioned above, you may arrange random positions.

With such a pattern layout, the one-dimensional layout of each of the standard transistors (transistor “0˜“3 and “ref”) which constitute the current mirror circuits of the reference voltage generation circuits 10A and the module current generation circuits 21A as shown in FIG. 2 can be accomplished based on the common centroid shape.

Additionally, in this manner the connection pattern of placed transistors “0˜“3 and “ref”, as shown in FIG. 2 when made to correspond to the configuration of the current generation circuits ILA and the reference voltage generation circuit 10A, as shown in FIG. 45 whereby the drain terminal of each transistor “0˜“3 and “ref” (equivalent to the module current transistors Tp12˜Tp15 mentioned above) is connected in common to the high electric potential +V and the gate terminal is connected in common to contact Nga.

Also, the source terminal of the transistor “0 is connected with the current output contact OUTi via the contact Na and the switch SW0 (equivalent to the selection transistor Tp16 mentioned above. Each of the two source terminals of the transistor “1 is connected in common to the current output contact OUTi via the switch SW1 (equivalent to the selection transistor Tp17 mentioned above) and the contact Nb. Each of the four source terminals of the transistor “2 is connected in common to the current output contact OUTi via the contact Nc and the switch SW2 (equivalent to the selection transistor Tp18 mentioned above).

Each of the eight source terminals of the transistor “3 is connected in common to the current output contact OUTi via the contact Nd and the switch SW3 (equivalent to the selection transistor Tp19 mentioned above).

That is, each of the transistor “0˜“3 which constitutes each of the module transistors Tp12˜Tp15 each other has a configuration in which the current path is connected in parallel between the contact Na˜Nd and the high electric potential +V. Referring to FIG. 45, the small black spots shown in the middle denote wiring junction points with each other. The larger black circles denote contact holes for connecting other wiring layers which serve as junction points for wiring to each other.

The drain terminal of each of the “ref” transistors which constitute the reference current transistor Tp11 is connected in common to the high electric potential +V and the gate terminal is connected in common to the drain terminal along with the current input contact INi via the contact Nga. The capacitor Ca is connected between the contact Nga and the high electric potential +V. That is, a plurality of the transistors “ref” which constitute the reference current transistor Tp11 has a configuration with each other in the current path is connected in parallel between the current input contact INi and the high electric potential +V.

Accordingly, the essential channel width of the Field-Effect Transistor which constitutes each of the module current transistors Tp12˜Tp15 and equivalent to the case shown in FIG. 43C is based on the module current transistor Tp12. Specifically, the present invention is designed so that the current value of each of the module currents Isa˜Is a relative to the reference currents Iref becomes specified as defined by a 2 (=2¹) fold, 4 (=2²) fold, 8 (=2³) fold dimension with each other, and made so that the channel width of the reference current transistor Tp11 also becomes the predetermined ratio based on the module current transistor Tp12.

In addition, in the connection pattern of the standard transistor in the current generation sections according to the embodiments, the characteristic wiring method as illustrated below is applied.

Thus, the first special feature of the connection pattern, as shown in FIG. 45, separates the subsections (Referring to the drawing, separated into the upper part subsection and the lower part subsection so there is no overlap) where the drain wiring of each transistor “0˜“3 and the source-gate wiring are wired and so that the output wiring (drain wiring) does not intersect with the gate wiring. In this manner, the output currents (That is, equivalent to the module currents and further relates also to the drive currents which are composite currents) from each transistor “0˜“3 are not influenced by the effects of high gate voltage potential fluctuation.

Furthermore, since the output wiring (drain wiring) of transistors “0˜“3 inevitably intersect as the second special feature shown in FIG. 25, each of the transistors “1˜“3 each other connected to the output wiring is made in a different wiring layer (for example, the wiring layer in which the gate wiring is formed via the contact holes) from the layer (output wiring layer) in which the above-mentioned output wiring is established and the connections between the contacts Na˜Nd and each of the switches SW0˜SW3 are repeated in the output wiring layer via the contact holes.

Here, in order to equalize the number of contact holes between each of the transistors “0˜“3 and the switches SW0˜SW3 (accordingly, contact resistance equivalent to the resistance added by making the intervening contact holes) and also between the transistor “0 and the switch SW0 which do not otherwise require transference (migration) to the other wiring layer, the connection pattern (wiring path) is established so that these can transition to the wiring layer which makes the connections of each other (between) the output wiring of the transistors “1˜“3 mentioned above and exit twice by way of the contact holes. In this manner, the variation in the output currents resulting from the non-uniformity of the contact resistance can be controlled.

Thus, set to the current generation supply circuit according to the embodiment, each of the Field-Effect type transistors which constitute the current mirror circuits are connected in parallel to a plurality of standard transistors having standard transistor sizes, comprise Field-Effect Transistors having desired channel widths and arranged to a plurality of the above-mentioned standard transistors in what is termed a common centroid shape. Thus, because processing variations can be offset and the aforesaid influence suppressed, equalizing the dimensional variation differences produced in the manufacturing process of Field-Effect Transistors is achievable as the drive currents having appropriate current values corresponding to designated gradations can be generated and supplied. The drive state of the loads also can be controlled with sufficient linearity from low gradation to high gradation. Furthermore, when the configuration has a plurality of current generation supply circuits, for example, they are applied to the data driver of the display device and the variation in the circuit current output characteristic between the current generation supply circuits can be controlled, as well as plurality of loads (display pixels) can be operated in a uniform drive state.

<The Second Embodiment of the Pattern Layout Method>

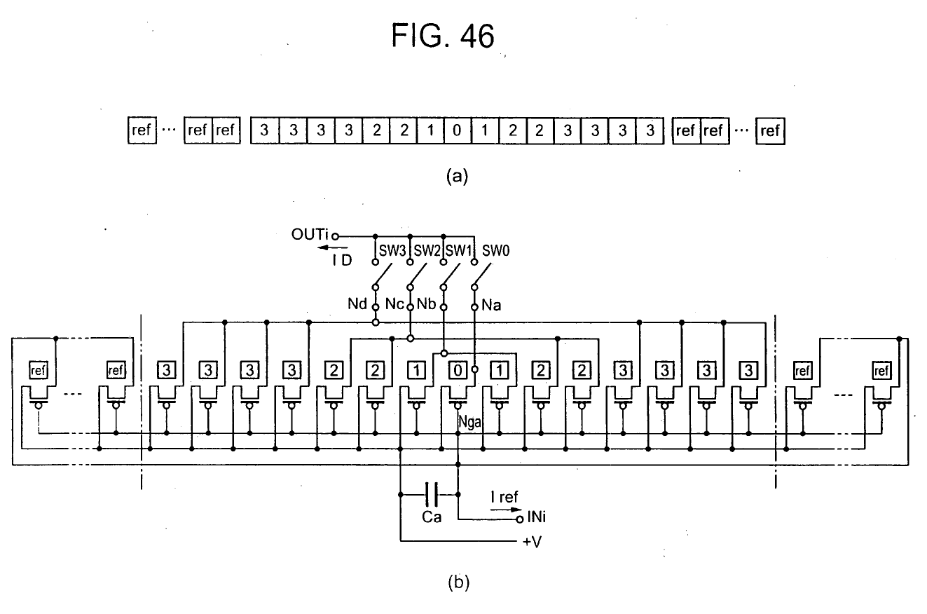

FIG. 46 is a circuit configuration diagram showing the second embodiment arrangement and connection pattern of the standard transistors which constitute the current mirror circuit in the current generation supply circuit related to the embodiments.

Here, concerning any configuration equivalent in the embodiments mentioned above, the same or equivalent nomenclature is appended and the explanation is simplified or omitted from the description.

The arrangement of the standard transistors which constitute the current generation sections according to the embodiment is equivalent to the first embodiment mentioned as shown as (a) in FIG. 46. The transistor “0 corresponding to the bit (1^{st} bit) of the digital signal d0 is arranged to the reference position. The one transistor “1 corresponding to the bit (2^{nd} bit) of the digital signal d1 on both sides of the transistor “0 is arranged. Further, the two transistor “2 corresponding to the bit (3^{rd} bit) of the digital signal d2 on both sides is each arranged. Also, the four transistor “3 corresponding to the bit (4^{th} bit) of the digital signal d3 on both sides is each arranged.

Additionally, the transistor “ref” of a predetermined number which constitute the reference current transistors with half on both other sides of the standard transistor cluster sequentially arranged as mentioned above.

Therefore, each of the standard transistors (transitors “0˜“3 and “ref”) which constitute the current mirror circuits of the reference voltage generation circuits 10A and the module current generation circuits 21A as shown in FIG. 2 which are arranged in positions symmetrical to at least the reference position and can be made into one-dimensional pattern layout corresponding to the common centroid shape.

Thus, this embodiment is also set to the connection pattern of the arranged transistors “0˜“3 and “ref” as shown as (b) in FIG. 46. Each of the transistors “0˜“3 constitute each of the module current transistors Tp12˜Tp15 equivalent to the first embodiment mentioned above between the contacts Na˜Nd and the high electric potential +V. Because the current path has a configuration connected in parallel like first embodiment, equalizing the dimensional variation differences, processing variations can be offset and the current values of the drive currents corresponding to the designated gradations can be controlled with sufficient linearity.

Additionally, in the connection pattern shown as (b) in FIG. 46, because the crossovers in the output wiring (drain wiring) of the transistors “0˜“3 are substantially reducible as compared with the connection pattern shown in FIG. 45. Thus, the number of contact holes for connecting the output wiring of each other in a different output wiring layer can also be reduced (In the connection pattern shown as (b) in FIG. 46, there are 8 points as compared to 19 points in the connection pattern shown in FIG. 45), and the manufacturing yield rate (yield rate in the processing process) can be elevated.

<The Third Embodiment of the Pattern Layout Method>

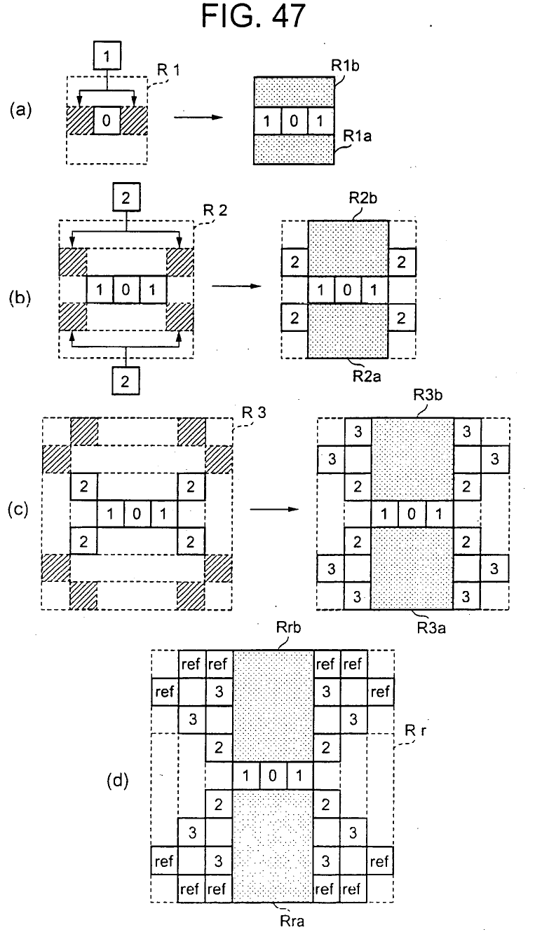

FIG. 47 is a conceptual diagram showing the third embodiment layout method of the standard transistors which constitute the current mirror circuits in the current generation supply circuit related to the embodiments.

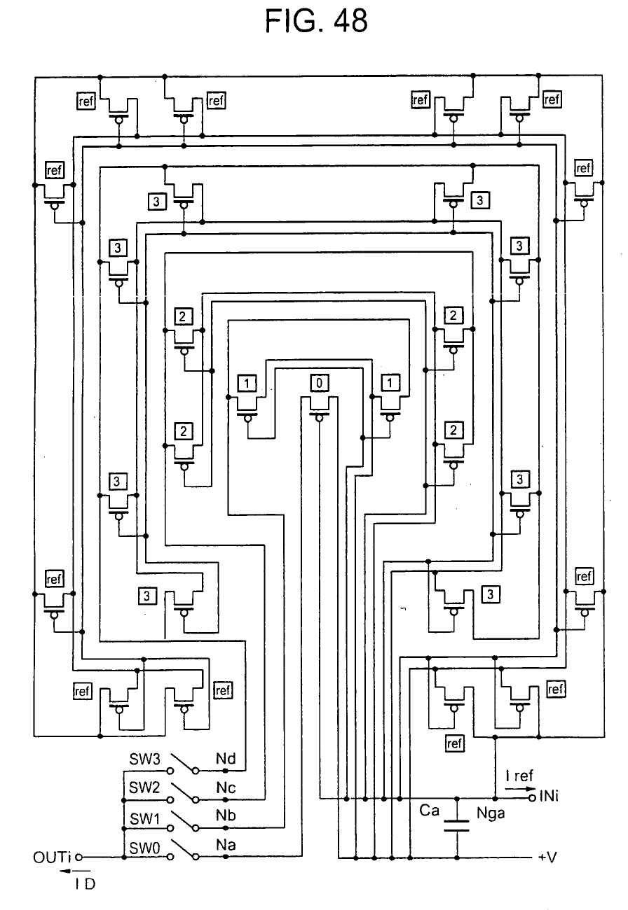

FIG. 48 is a circuit configuration diagram showing the third embodiment arrangement and connection pattern of the standard transistors which constitute the current mirror circuits in the current generation supply circuit related to the embodiments.

Here, concerning any configuration equivalent in the embodiments mentioned above, the same or equivalent nomenclature is appended and the explanation is simplified or omitted from the description.

Although the configuration using Field-Effect Transistors (standard transistors comprising the reference current transistor and the module current transistors) which constitute the current mirror circuits of the current generation supply circuit in the first and second embodiments mentioned above, as well as placed in one-dimensional positions which compose the axial symmetry centered on the reference position is explained, this third embodiment has arranged the above-mentioned standard transistors in two-dimensional positions which compose the point symmetry centered on the reference position.

The layout method of the current mirror circuit sections according to this embodiment as shown as (a) in FIG. 47, firstly, the transistor “0 which constitutes the module current transistor Tp12 is arranged to the predetermined reference position. The two transistor “1 which constitutes module current transistor Tp13 is arranged in the periphery subsections R1 (hereinafter denoted as “layout subsections”) which adjoins the transistor “0 so as to be in a point symmetry relationship with each other relative to the above-mentioned reference position.

Next, as shown as (b) in FIG. 47, the subsections R2 (layout subsection) adjoining the above-mentioned adjacent areas R1 where transistor “1 is arranged. The four transistor “2 which constitutes the module current transistor Tp14 is arranged so as to be in a point symmetry relationship with each other to the above-mentioned reference position. Further, as shown as (c) in FIG. 47, the eight transistor “3 which constitutes the module current transistor Tp15 in the subsections R3 (layout subsection) adjoining the above-mentioned adjacent areas of R2 is arranged so as to be in a point symmetry relationship with each other to the above-mentioned reference position.

Next, when the 4-bit digital signals d0˜d3 are made into the input signals as shown as (c) in FIG. 47, each of the transistors “1, “2 and “3 are arranged in shape of a concentric circle centered on the reference position. Therefore, where there are more digital signal bits, the operation which arranges the standard transistors corresponding to the high-order bits of the layout subsections further sets to the periphery side so that the operation can be repeated based on the above-mentioned layout.

Next, as shown as (d) in FIG. 47, the transistor “ref” of a predetermined number which constitute the reference current transistor Tp11 of the layout subsections Rr of the standard transistor cluster (standard transistor cluster which constitutes the module current transistors) sequentially arranged to compose the periphery and further arranged so as to be in a point symmetry relationship with each other relative to the above-mentioned reference position.

Therefore, based on the common centroid shape, the two-dimensional layout of each of the standard transistors (transistors “0˜“3 and “ref”) which constitute the current mirror circuits of the reference voltage generation circuits 10A and the module current generation circuits 21A as shown in FIG. 2 can be created by such a patter layout method. Here, although “1, “2, “3, “ref” are formed when arranging each of the above-mentioned transistors “1, “2, “3, “ref” to the layout subsections R1, R2, R3 and Rr, the subsections R1a and R1b, R2a and R2b, R3a and R3b, Rra and Rrb are not established in the wiring subsections.

Also, this placement of the transistors “0˜“3 and “ref” set to the connection pattern, as shown in FIG. 48, because each transistor which constitutes each of the module current transistors Tp12˜Tp15 has a configuration with each other in which the current path is connected in parallel between contacts Na˜Nd and the high electric potential +V and equivalent to the embodiment mentioned above, equalizing the dimensional variation differences, processing variations can be offset and the current values of the drive currents corresponding to the designated gradations can be controlled with sufficient linearity.

Moreover, because each standard transistor which constitutes the current generation sections (current mirror circuit sections) is arranged in two-dimensional based on the layout method and connection pattern shown in FIG. 47 and FIG. 48, even if it is the case where the number of digital signal bits which specifies gradation increases, as compared with the layout method shown in the first and second embodiments mentioned above, the phenomenon in which the dimension of the specified direction (one-dimensional) increases significantly can be controlled, and the amount of freedom in the layout design can be improved.

Further, because each other of the crossovers in the output wiring (drain wiring) as shown in each embodiment mentioned above can be avoided, there is no need to transition to other wiring layers via the contact holes and the manufacturing yield can be raised, the drive currents (output currents) in which the output currents will not be influenced and have the appropriate current values which are generable relative to the designated gradations.

In addition, in the case where the subsections having hollow square shapes (square donut shapes) are applied in the layout subsections where the standard transistors are arranged as explained, this invention is not limited to this. The present invention can have subsections shaped in which the standard transistors are arranged to point symmetry centered on the reference position, for example, a hollow polygon shape, hollow circular shape and the like.

Moreover, although only the method of arranging a plurality of standard transistors which constitute the specified module current transistors within specified layout (identical) subsections centered on the above-mentioned reference position is illustrated, the present invention in this state is not restricted to this. As long as the configuration is in the state which maintains the connection relationship with each other of the standard transistors and maintains the layout arrangement relationship of the above-mention point symmetry, the configuration can have only a portion of the standard transistors arranged in the layout subsections by the side of the inner periphery. Based on this, as shown in FIG. 47, the standard transistors can be arranged to the subsections in which there are no standard transistors arranged and utilization efficiency of the substrate can be improved.

Finally, in each embodiment mentioned above, although the current generation supply circuit (current generation sections) constituted by means of applying p-channel type transistors as explained in detail, it is emphasized that the same concept applies also in the configuration. For example, referring to FIG. 4, the configuration applies n-channel type transistors as shown in the second embodiment of the current generation supply circuit.

While the present invention has been described with reference to the preferred embodiments, it is intended that the invention be not limited by any of the details of the description thereof.

As this invention can be embodied in several forms without departing from the spirit of the essential characteristics thereof, the present embodiments are therefore illustrative and not restrictive, since the scope of the invention is defined by the appended claims rather than by the description preceding them, and all changes that fall within meets and bounds of the claims, or equivalence of such meets and bounds thereof are intended to be embraced by the claims.

What is claimed is:

1. A current generation supply circuit which supplies currents corresponding to digital signals for a plurality of loads comprising:
a plurality of current generation circuit sections comprising at least;
a module current generation circuit which generates a plurality of module currents corresponding to each digital signal bit and corresponding to each of a plurality of loads based on predetermined reference voltage, and
a drive current generation circuit which integrates selectively each of the module currents, generates drive currents and supplies a plurality of loads corresponding to the digital signal bit value; and
a reference voltage generation circuit which applies in common the predetermined reference voltage to a plurality of current generation circuit sections.

2. The current generation supply circuit according to claim 1, wherein each of a plurality of the current generation circuit sections sets the signal polarity of the drive currents so that the drive currents flow in the direction drawn from the load side.

3. The current generation supply circuit according to claim 1, wherein each of a plurality of the current generation circuit sections sets the signal polarity of the drive currents so that the drive currents flow in the direction flowed into the load side.

4. The current generation supply circuit according to claim 1, wherein each of a plurality of the current generation circuit sections comprise a signal holding circuit having a plurality of latch circuits which hold individually each digital signal bit.

5. The current generation supply circuit according to claim 4, wherein the drive current generation circuits generate the drive currents corresponding to the digital signal bit value of the digital signals in the signal holding circuit.

6. The current generation supply circuit according to claim 4, wherein the drive current generation circuits comprise selection switching circuits which select a plurality of the module currents generated by the module current generation circuits corresponding to each digital signal bit value held in the signal holding circuit.

7. The current generation supply circuit according to claim 6, wherein each current value of a plurality of the module currents has a different ratio with each other defined by 2ⁿ (n=0, 1, 2 and 3, . . . ).

8. The current generation supply circuit according to claim 4, wherein the latch circuits comprise:
a signal input control circuit which takes in the digital signals;
a charge storage circuit which stores electrical charges based on the signal levels of the digital signals; and
an output level setting circuit which sets the signal levels of the output signals outputted from the latch circuits based on the amount of electrical charge stored in the charge storage circuit.

9. The current generation supply circuit according to claim 8, wherein the output level setting circuit comprises an amplification circuit in which the signal levels are inputted and one level as the high-level or the low-level is outputted as the output signals based on the amount of electrical charge stored in the charge storage circuit;
wherein the amplification circuit comprises a means for setting the output signal levels corresponding to whether or not the signal levels exceed the threshold value voltage of the amplification circuit.

10. The current generation supply circuit according to claim 1, wherein a plurality of the current generation circuit sections are set to correspond to each of a plurality of the loads; and each of the current generation circuits simultaneously generate in parallel the drive currents for a plurality of the loads.

11. The current generation supply circuit according to claim 1, wherein a plurality of the current generation circuit sections are set to correspond to every load for some predetermined number of a plurality of the loads; and each of the current generation circuits sequentially generates the drive currents corresponding to each of the predetermined number of loads.

12. The current generation supply circuit according to claim 11, comprises signal holding circuit having a plurality of latch circuits which individually hold each digital signal bit set to correspond to each of a plurality of the loads.

13. The current generation supply circuit according to claim 12, wherein the drive current generation circuit in a plurality of the current generation circuits generates the drive currents corresponding to the digital signal bit value held in the signal holding circuit.

14. The current generation supply circuit according to claim 12, comprises a plurality of current latch circuits which sequentially take in and hold in parallel the drive currents generated by the current generation circuits set to correspond to a plurality of the loads and output the held drive currents simultaneously to a plurality of the loads.

15. The current generation supply circuit according to claim 14, comprises:
an input side switching circuit which sequentially selects a plurality of the latch circuits in the signal holding circuit and supplies the digital signals held in the latch circuits to each of a plurality of the current generation circuits; and
an output side switching circuit which sequentially selects a plurality of the current latch circuits and sequentially supplies to the current latch circuits the selected drive currents generated by a plurality of the current generation circuits; and
an operation for selecting a plurality of the latch circuits of the signal holding circuit in the input side switching circuit and an operation for selecting a plurality of the current latch circuits in the output side switching circuit are synchronously performed.

16. The current generation supply circuit according to claim 1, wherein the reference voltage generation circuit comprises a means for generating the reference voltage based on reference currents having constant current value.

17. The current generation supply circuit according to claim 16, wherein the reference voltage generation circuit comprises a charge storage circuit which stores electrical charges corresponding to the current component of the reference current.

18. The current generation supply circuit according to claim 17, wherein the reference voltage generation circuit comprises a refresh circuit which accumulates the electrical charges at predetermined timing intervals corresponding to the current component of the reference current in the charge storage circuit.

19. The current generation supply circuit according to claim 16, wherein the reference voltage generation circuit comprises a reference current transistor which outputs the voltage generated for the control terminals as the reference voltage when the reference current flows.

20. The current generation supply circuit according to claim 19, wherein the module current generation circuit comprises a plurality of the module current transistors in which the transistor size of each other differs and each control terminal is connected in common to the reference current transistor control terminal of the reference voltage generation circuit.

21. The current generation supply circuit according to claim 20, wherein a plurality of module current transistors the channel width is set at a different ratio with each other defined by 2ⁿ (n=0, 1, 2 and 3, . . . ).

22. The current generation supply circuit according to claim 20, wherein the reference current transistor and a plurality of the module current transistors constitute a current mirror circuit.

23. The current generation supply circuit according to claim 20, wherein at least either the reference current transistor or a plurality of the module current transistors has a body terminal structure.

24. The current generation supply circuit according to claim 20, wherein at least any one of the transistors of the reference current transistor and a plurality of the module current transistors are constituted with the current path of a plurality of Field-Effect Transistors connected in series.

25. The current generation supply circuit according to claim 24, wherein a plurality of Field-Effect Transistors, which constitute either the reference current transistor or a plurality of the module current transistors, the control terminals are connected in common with each other.

26. The current generation supply circuit according to claim 24, wherein the reference current transistor and each of a plurality of the module current transistors are constituted by the same number of a plurality of Field-Effect Transistors;
each control terminal of a plurality of Field-Effect Transistors which constitute the reference current transistor and each control terminal of a plurality of Field-Effect Transistors which constitute each of a plurality of the module current transistors are connected in common; and
the reference current transistor and a plurality of the module current transistors have a configuration of a plurality of the current mirror circuits connected in multiple stages.

27. The current generation supply circuit according to claim 19, wherein the module current generation circuit comprises a plurality of the module current transistors in which each of the module currents flow; and
at least some of the transistors of the reference current transistor and a plurality of module current transistors are constituted by standard transistors having standard transistor sizes with a plurality connected in parallel.

28. The current generation supply circuit according to claim 27, wherein each of a plurality of the standard transistors arranged in a particular one-dimensional orientation and the current path of each of the standard transistors is connected in parallel.

29. The current generation supply circuit according to claim 27, wherein each of a plurality of the standard transistors are arranged in a two-dimensional orientation and the current path of each of the standard transistors is connected in parallel.

30. The current generation supply circuit according to claim 27, wherein each of a plurality of the standard transistors are arranged in symmetrical positions with each other centered on a predetermined reference position.

31. The current generation supply circuit according to claim 27, wherein a plurality of the standard transistors the placement of the output wiring for each current path of a plurality of the standard transistors is arranged in a first area of a particular orientation; and the wiring connected to the input wiring for each current path and each control terminal is arranged in a second area which does not overlap with the first area.

32. The current generation supply circuit according to claim 27, wherein the reference current transistor and the module current transistors constitute a plurality of the standard transistors connected in parallel, a plurality of the standard transistors are arranged centered on a predetermined reference position; and
a plurality of the standard transistors which constitute the reference current transistor are arranged to be symmetrical with each other centered on the reference position at the outer side of a plurality of the standard transistors which constitute the module current transistors.

33. The current generation supply circuit according to claim 27, wherein each of a plurality of the module current transistors constitute a plurality of the standard transistors connected in parallel is constructed so that the number of standard transistors which constitute each of the module current transistors are different with each other.

34. The current generation supply circuit according to claim 33, wherein each of a plurality of the module current transistors the sum total of the channel width of the standard transistors connected in parallel is set at a different ratio with each other defined by 2ⁿ (n=0, 1, 2 and 3, . . . ).

35. The current generation supply circuit according to claim 16, comprises a constant current generation source which generates the reference current.

36. The current generation supply circuit according to claim 35, wherein at least the current generation circuit and the constant current generation source are built on the same substrate.

37. The current generation supply circuit according to claim 35, wherein the constant current generation source comprises a means for randomly adjusting the setting for the current value of the reference current corresponding to control voltage.

38. The current generation supply circuit according to claim 1, wherein the reference voltage generation circuit comprises a constant voltage source which regularly outputs voltage having constant voltage value as the reference voltage.

39. The current generation supply circuit according to claim 1, wherein each of a plurality of the loads comprise current control type light emitting devices which perform luminescent operation by predetermined luminosity gradation corresponding to the current values of the drive currents supplied from the current generation circuits.

40. The current generation supply circuit according to claim 39, wherein the light emitting devices are organic electroluminescent devices.

41. A display device which displays image information corresponding to display signals consisting of digital signals comprising:
a display panel comprising a plurality of scanning lines and a plurality of signal lines which intersect at perpendicularly with each other, and a plurality of display pixels arranged in matrix form near the intersecting points of the scanning lines and the signal lines;
a scanning driver circuit which sequentially applies scanning signals for setting the selective state of each line of a plurality of the scanning lines;
a signal driver circuit comprising a plurality of gradation current generation supply circuit sections comprising at least:
a module current generation circuit which generates a plurality of module currents corresponding to each digital signal bit of the display signals based on predetermined reference voltage; and
a gradation current generation circuit which integrates selectively each of the module currents, generates gradation currents, and supplies each of a plurality of the signal lines corresponding to the digital signal bit value of the display signals; and
a reference voltage generation circuit which applies in common the predetermined reference voltage to a plurality of the gradation current generation circuits sections.

42. The display device according to claim 41, wherein each of a plurality of the gradation current generation supply circuit sections sets the signal polarity of the gradation currents so that the gradation currents flow in the direction drawn from the display pixel side via the signal lines.

43. The display device according to claim 41, wherein each of a plurality of gradation current generation supply circuit sections sets the signal polarity of the gradation currents so that the gradation currents flow in the direction of the display pixel side via the signal lines.

44. The display device according to claim 41, wherein each of a plurality of the gradation current generation supply circuit sections comprises a signal holding circuit having a plurality of latch circuits which individually hold each digital signal bit of the display signals.

45. The display device according to claim 44, wherein the gradation current generation circuit in each of a plurality of the gradation current generation supply circuit sections generate gradation currents corresponding to the digital signal bit value of the display signals held in the signal holding circuit.

46. The display device according to claim 44, wherein the gradation current generation circuit comprises a selection switching circuit which selects a plurality module currents generated by the module current generation circuit corresponding to each digital signal bit value of the display signals held in the signal holding circuit.

47. The display device according to claim 44, wherein a plurality of the module currents each has a different current value ratio with each other defined by 2ⁿ (n=0, 1, 2 and 3, . . . ).

48. The display device according to claim 44, wherein the latch circuits in the signal holding circuit comprise:
a signal input control circuit which takes in the digital signals of the display signals;
a charge storage circuit which stores electrical charges based on the signal levels of the digital signals of the display signals; and
an output level setting circuit which sets the signal levels outputted from the latch circuits stored in the charge storage circuit.

49. The display device according to claim 48, wherein the output level setting circuit comprises an amplification circuit in which the signal levels are inputted and one level as the high-level or the low-level is outputted as the output signals based on the amount of electrical charge stored in the charge storage circuit;
wherein the amplification circuit comprises a means for setting the output signal levels corresponding to whether or not the signal levels exceed the threshold value voltage of the amplification circuit.

50. The display device according to claim 41, wherein a plurality of the gradation current generation supply circuit sections are set corresponding to each of a plurality of signal lines and generate simultaneously in parallel the gradation currents for a plurality of the signal lines.

51. The display device according to claim 41, wherein a plurality of the gradation current generation supply circuit sections are set to correspond to every signal line for some predetermined number of a plurality of the signal lines; and the gradation current generation supply circuit sections sequentially generate the gradation currents corresponding to the number of signal lines.

52. The display device according to claim 51, wherein each of a plurality of the gradation current generation supply circuit sections comprises a signal holding circuit having a plurality of latch circuits which individually hold each digital signal bit of the display signals.

53. The display device according to claim 52, wherein the gradation current generation circuit in each of a plurality of the gradation current generation supply circuit sections generates the gradation currents corresponding to the digital signal bit value of the display signals held in the signal holding circuit.

54. The display device according to claim 52, wherein the signal driver circuit comprises a plurality of current latch circuits which sequentially take in and hold in parallel the gradation currents generated by the gradation current generation supply circuit sections set to correspond to each of a plurality of the signal lines and output the held gradation currents simultaneously to a plurality of the signal lines.

55. The display device according to claim 54, wherein the signal driver circuit comprises:
an input side switching circuit which sequentially selects a plurality of the latch circuits in the signal holding circuit and supplies the digital signals of the display signals held in the latch circuits to each of a plurality of the gradation current generation supply circuit sections; and
an output side switching circuit which sequentially selects a plurality of the current latch circuits and sequentially supplies to the latch circuits the selected gradation currents generated by a plurality of the gradation current generation circuits; and
an operation for selecting a plurality of the latch circuits of the signal holding circuit in the input side switching circuit and an operation for selecting a plurality of the current latch circuits in the output side switching circuit are synchronously performed.

56. The display device according to claim 44, wherein a plurality of the gradation current generation supply circuit sections in the signal driver circuit comprises a pair of two gradation current circuit sections set to correspond to each of a plurality of the signal lines in which each other comprises at least a module current generation circuit, a gradation current generation circuit and a signal holding circuit; and
the reference voltage generation circuit applies in common the reference voltage to each pair of the gradation current generation supply circuit sections.

57. The display device according to claim 56, wherein each of a plurality of the gradation current generation supply circuit sections simultaneously perform in parallel an operation for supplying a plurality of the signal lines with gradation currents based on the digital signals of the display signals held in the signal holding circuit in one of a pair of the gradation current generation supply circuit sections; and an operation for holding the successive digital signals of the display signals in the signal holding circuit in the current generation circuit of the current generation circuit sections of the other side.

58. The display device according to claim 41, wherein the reference voltage generation circuit in the signal driver circuit comprises a means for generating the reference voltage based on the reference current having constant current value.

59. The display device according to claim 58, wherein the reference voltage generation circuit comprises a charge storage circuit which stores electrical charges corresponding to the current component of the reference current.

60. The display device according to claim 59, wherein the reference voltage generation circuit comprises a refresh circuit which accumulates the electrical charges corresponding to the current component of the reference current in the charge storage circuit at predetermined timing intervals.

61. The display device according to claim 58, wherein the reference voltage generation circuit comprises a reference current transistor which outputs the voltage generated for the control terminals as the reference voltage when the reference current flows.

62. The display device according to claim 61, wherein the module current generation circuit comprises a plurality of module current transistors in which the transistor size of each other differs and each control terminal is connected in common to the reference current transistor control terminal of the reference voltage generation circuit.

63. The display device according to claim 62, wherein a plurality of the module current transistors the channel width is set at a different ratio with each other defined by 2ⁿ (n=0, 1, 2 and 3, . . . ).

64. The display device according to claim 62, wherein the reference current transistor and a plurality of the module current transistors constitute a current mirror circuit.

65. The display device according to claim 62, wherein at least any the reference current transistor or a plurality of the module current transistors has a body terminal structure.

66. The display device according to claim 62, wherein at least some of the transistors of the reference current transistor and a plurality of the module current transistors are constituted by a plurality of Field-Effect Transistors with the current path of connected in series.

67. The display device according to claim 66, wherein a plurality of Field-Effect Transistors, which constitute either the reference current transistor or a plurality of the module current transistors, the control terminals are connected in common with each other.

68. The display device according to claim 66, wherein the reference current transistor and each of a plurality of the module current transistors are constituted by the same number of a plurality of Field-Effect Transistors;
each control terminal of a plurality of Field-Effect Transistors which constitute the reference current transistor and each control terminal of a plurality of Field-Effect Transistors which constitute each of a plurality of the module current transistors are connected in common; and
the reference current transistor and a plurality of the module current transistors have a configuration of a plurality of current mirror circuits connected in multiple stages.

69. The display device according to claim 61, wherein the module current generation circuit in the signal driver circuit comprises a plurality of module current transistors in which each of the module currents flow; and
at least some of the transistors of the reference current transistor and a the plurality of module current transistors are constituted by standard transistors having standard transistor sizes with a plurality connected in parallel.

70. The display device according to claim 69, wherein each of a plurality of the standard transistors are arranged in a particular one-dimensional orientation and the current path of each of the standard transistors is connected in parallel.

71. The display device according to claim 69, wherein each of a plurality of the standard transistors are arranged in a two-dimensional orientation and the current path of each of the standard transistors is connected in parallel.

72. The display device according to claim 69, wherein each of a plurality of the standard transistors is arranged in symmetrical positions with each other centered on a predetermined reference position.

73. The display device according to claim 69, wherein a plurality of the standard transistors the placement of the output wiring for each current path of a plurality of the standard transistors is arranged in a first area of a particular orientation; and the wiring connected to the input wiring for each current path and each control terminal is arranged in a second area which does not overlap with the first area.

74. The display device according to claim 69, wherein the reference current transistor and the module current transistors constitute a plurality of standard transistors connected in parallel and a plurality of the standard transistors are arranged centered on a predetermined reference position; and
a plurality of the standard transistors which constitute the reference current transistor are arranged to be symmetrical with each other centered on the reference position at the outer side of a plurality of the standard transistors which constitute the module current transistors.

75. The display device according to claim 69, wherein each of a plurality of the module current transistors constitute a plurality of the standard transistors connected in parallel are constructed so that the number of standard transistors which constitute each of the module current transistors are different with each other.

76. The display device according to claim 75, wherein each of a plurality of the module current transistors the sum total of the channel width of the standard transistors connected in parallel is set at a different ratio with each other defined by 2ⁿ (n=0, 1, 2 and 3, . . . ).

77. The display device according to claim 58, wherein the signal driver circuit comprises a constant current generation source which generates the reference current.

78. The display device according to claim 77, wherein the signal driver circuit at least the current generation circuit and the constant current generation source are built on the same substrate.

79. The display device according to claim 77, wherein the constant current generation source comprises a means for randomly adjusting the setting for the current value of the reference current corresponding to control voltage.

80. The display device according to claim 41, wherein the reference voltage generation circuit comprises a constant voltage source which regularly outputs voltage having constant voltage value as the reference voltage.

81. The display device according to claim 41, wherein each of a plurality of the display pixels comprise current control type light emitting devices which perform luminescent operation by predetermined luminosity gradation corresponding to the current values of the drive currents supplied from the current generation circuits.

82. The display device according to claim 81, wherein the display pixels comprise:
a current write-in holding circuit which holds the gradation currents; and
a light generation driver circuit which generates light generation drive currents and supplies the light emitting devices based on the held gradation currents.

83. The display device according to claim 81, wherein the light emitting devices are organic electroluminescent devices.

84. A method for driving the display device which displays image information corresponding to display signals consisting of digital signals in a display panel comprising a plurality of display pixels, the method comprising at least:
taking in and holding each digital signal bit of the display signals corresponding to each of a plurality of the display pixels;
integrating selectively corresponding to each digital signal bit value of the held display signals and generating gradation currents which drive each of a plurality of the display pixels from a plurality of module currents generated corresponding to each digital signal bit of the display signals based on common reference voltage; and
supplying simultaneously in parallel a plurality of the gradation currents to each of a plurality of the display pixels.

85. The method for driving the display device according to claim 84, wherein each current value of a plurality of the module currents has a different ratio with each other defined by 2ⁿ (n=0, 1, 2 and 3, . . . ).

86. The method for driving the display device according to claim 84, wherein the reference voltage is generated based on the stored electrical charge corresponding to the current component of the reference current having constant current value; and
the method for driving the display device comprises a refresh operation for performing a storage operation of the electrical charges at predetermined timing intervals.

87. The method for driving the display device according to claim 84, wherein the holding operation of the display signals comprises an operation for storing the electrical charge corresponding to the signal levels of the digital signals of the display signals and outputs the output signals based on the amount of electrical charge stored.

88. The method for driving the display device according to claim 84, wherein the taking in and holding operation of the display signals and a supply operation to a plurality of the display pixels of a plurality of the gradation currents is executed simultaneously in parallel.

89. The method for driving the display device according to claim 84, wherein the signal polarity of each of the gradation currents is set to flow in the direction drawn from the display pixel side.

90. The method for driving the display device according to claim 84, wherein the signal polarity of the gradation currents is set to flow in the direction flowed into the display pixel side.
